(19) United States
(12) Patent Application Publication
(10) Pub. No.: US 2026/0175208 A1
(43) Pub. Date: Jun. 25, 2026

(54) METHOD FOR THE PRODUCTION OF SUPPORTED CATALYSTS

(71) Applicant: Blücher GmbH, Erkrath (DE)

(72) Inventors: Dennis RICHTER, Erkrath (DE); Anastasia STEPHAN, Erkrath (DE); Jens BERGMANN, Erkrath (DE)

(21) Appl. No.: 19/539,175

(22) Filed: Feb. 13, 2026

Related U.S. Application Data
(63) Continuation of application No. 18/246,386.

(30) Foreign Application Priority Data
Sep. 25, 2020 (DE) 102020125137.8
Jan. 29, 2021 (DE) 102021102078.6

(51) Int. Cl. B01J 35/61; B01J 21/18; B01J 35/45; B01J 35/51; B01J 35/59; B01J 35/63; B01J 35/77

(52) U.S. Cl. CPC B01J 35/618; B01J 21/18; B01J 35/59; B01J 35/635; B01J 35/638; B01J 35/77; B01J 35/45; B01J 35/51; B01J 2235/00

(57) ABSTRACT

The invention relates to a method for the production of a catalyst system comprising a catalytically active component, in particular a supported catalyst, and to a catalyst system as such. The present invention also relates to uses of the catalyst system according to the invention and further to protective materials as well as filters and filter materials which are produced using the catalyst system according to the invention or which comprise such a catalyst system.

### CROSS-REFERENCES TO RELATED APPLICATIONS

This patent application is a continuation of U.S. application Ser. No. 18/246,386, entitled “METHOD FOR PRODUCING SUPPORTED METAL CATALYSTS WITH A GRANULAR ACTIVATED CARBON USED AS A CATALYST SUPPORT” filed on Mar. 23, 2023, which claims priority to and the benefit of PCT/EP 2021/064599 filed Jun. 1, 2021, and to German Applications DE 10 2020 125 137.8 filed Sep. 25, 2020, and DE 10 2021 102 078.6 filed Jan. 29, 2021 and incorporates all by reference herein, as if each one were independently incorporated in its entirety.

The present invention relates to the technical field of catalytically active systems or the technical field of catalysts or catalytically active components applied to support materials, and thus in particular to the technical field of supported catalysts, such as can be used in particular for heterogeneous catalysis.

In particular, the present invention relates to a method for the production of a catalyst system comprising at least one catalytically active component, in particular a supported catalyst.

Furthermore, the present invention relates to a catalyst system obtainable on the basis of the method according to the invention and further to a catalyst system as such, which comprises at least one catalytically active component applied to a catalyst support, in particular at least one catalytically active component fixed to a catalyst support.

The present invention also relates to the use of the catalyst system according to the invention as a catalyst or as a catalyst support. Furthermore, the present invention relates to the use of the catalyst system according to the invention for chemical catalysis. Furthermore, the present invention equally also relates to the use of the catalyst system according to the invention for catalysis of chemical methods and reactions, such as hydrogenation reactions or the like.

Furthermore, the present invention also relates to the use of the catalyst system according to the invention for the production of filters and filter materials and as sorption storage for gases or liquids as well as the use in or as gas sensors or in fuel cells. Furthermore, the present invention also relates to the use of the catalyst system according to the invention for sorptive applications as well as for gas purification or gas treatment and further for the removal of pollutants or of substances or gases that are harmful to the environment, health or toxicity. The present invention also relates to the use of the catalyst system according to the invention for the preparation or provision of clean room atmospheres or the like.

The present invention also relates to protective materials which are produced using the catalyst system according to the invention or which comprise the catalyst system according to the invention. The present invention further relates to filters and filter materials which are produced using the catalyst system according to the invention or which comprise the catalyst system according to the invention.

A catalyst is generally understood to be a material or substance that is capable of increasing the reaction rate of a chemical reaction by lowering the activation energy without itself being consumed.

In the state of the art, catalysts are of great technical and commercial importance, for example in important catalytic methods such as the so-called contact method for the production of sulfuric acid, the catalytic method for the production of methanol as well as the so-called Haber-Bosch method for the industrial production of ammonia and the so-called Ostwald method for the large-scale production of nitric acid by oxidation of ammonia. Catalysts are also used in the synthesis of fine and specialty chemicals, in the synthesis of natural substances and in the production of active pharmaceutical ingredients. In particular, catalysts are also used in catalytic hydrogenation methods.

Also against this background, there is a high demand in the state of the art for specific and efficient catalysts for use in chemical catalysis, in particular because the targeted use of catalysts enables chemical reactions to be carried out more quickly or with lower energy input. In this respect, the use of catalysts in chemical reactions is also of great commercial importance: for example, it is assumed that around 80% of all chemical products have a catalytic stage in the underlying manufacturing or value chain. In addition, catalysts also play a prominent role in the field of environmental protection, particularly with regard to exhaust gas aftertreatment in industry, such as in the context of industrial electricity production, as well as in the treatment of exhaust gases from the field of (passenger) motor transport.

In principle, catalysts can be used in the form of homogeneous or heterogeneous catalysts, whereby, in the case of homogeneous catalysts or catalysts used in homogeneous catalysis, the reactants or reactants on which the reaction to be catalyzed is based, on the one hand, and the catalyst, on the other hand, are present in the same phase, whereas, in the case of heterogeneous catalysts or of catalysts used in heterogeneous catalysis, the reactants to be reacted on the one hand and the catalyst on the other hand are present in different phases, for example as a solid with respect to the catalyst and as a liquid or gas with respect to the reactants.

In principle, the advantages associated with the use of heterogeneous catalysts lie in particular in the fact that it is sometimes possible to improve the separation or isolation of the catalyst from the reaction mixture, together with the basic possibility of recycling the catalyst used or processing deactivated or inactive catalysts. In industrial processing in particular, a heterogeneous catalyst is often present as a solid or as a so-called contact(-catalyst), while the reaction partners or reactants are used in the form of gases or liquids. For example, the above-mentioned industrially established methods are those in which the catalyst is used as a solid.

With regard to heterogeneous catalysts or catalysts in solid form, metals or metal-containing compounds, such as metal salts or metal oxides, are often used as catalysts. Such catalysts can be used, for example, in bulk or in such a form that the catalyst or the underlying catalytically active component is present on a support system or is bound or fixed thereto. Such catalyst systems in which the catalytically active component is on a support are generally referred to as supported catalysts.

The use of supported catalysts is associated with the fundamental advantage that larger surfaces or larger contact areas can be realized with the reactants to be reacted, which generally leads to an increase in the efficiency or to the use of reduced amounts of catalyst with an associated cost advantage.

In addition, the use of supported systems or supported catalysts is generally associated with the advantage that the underlying catalysts can be better removed or separated from the reaction medium and are generally easier to recycle. Particularly in the case of catalysts used in bulk or in the same phase as the reactants, separation after reaction or conversion of the reactants is difficult or involves high losses of catalyst mass, which generally worsens the economic efficiency and makes recycling of the catalysts used fundamentally more difficult.

For supported catalyst systems or supported catalysts, the use of compact or porous support structures is generally considered in the state of the art. The use of so-called compact catalysts is associated in particular with the disadvantage that an efficient surface enlargement cannot be realized and thus catalytic activity can only be provided on the relatively small geometric surface. In contrast, porous solids used as catalyst carriers have enlarged (inner) surfaces, which, as mentioned above, is associated with increased efficiency and higher catalytic activity even with lower loading of active components (i.e. catalytically active metals such as noble metals).

For example, crystalline porous solids from the zeolite family are used as catalyst supports, particularly in the field of petrochemicals or refining technology for processing or upgrading crude oil or petroleum. Zeolites generally have uniform pore sizes or diameters, which allows some selective reaction control by size matching with the substances to be reacted. In addition, the use of silica, molecular sieves, metal oxides such as aluminum oxides, or ceramics as well as activated carbons as support systems for catalysts is generally known in the prior art.

In principle, such carrier systems are also used against the background of enabling a permanent or elution-stable fixation of, in particular, cost-intensive catalysts, in order to reduce the relevant loss during application or to enable corresponding recyclability, as previously mentioned, or recovery of the catalyst system as a whole.

With regard to the use of activated carbon as a support material for catalysts, in particular for obtaining so-called activated carbon-supported catalysts, especially activated carbon-supported noble metal catalysts, in the prior art corresponding activated carbons are generally used in finely divided or powdered form (powdered carbons) or in the form of a finely ground powder, the corresponding particle sizes being in the lower μm range. The use of finely divided activated carbon as a carrier system generally attempts to reduce limitations in the underlying mass transport with regard to the catalyzed target reaction, in particular by shortening diffusion or penetration distances into the pore structure of the activated carbon-based carrier material. However, the use of finely divided or powdered activated carbon with small particle sizes as a catalyst support is associated with the central disadvantage that overall optimum application properties cannot be achieved. For example, the use of finely divided activated carbon, particularly in discontinuous applications, leads to deteriorated properties, for example, in the separation of the catalyst or catalyst system after use, due to the low bulk porosity of the filter cake or due to the high density of the bulk from the underlying material. In this context, it should also be emphasized that the separation or filtering of the catalyst or catalyst system is an indispensable or absolutely necessary method step in the context of discontinuous catalytic methods.

In addition, such activated carbons often have a pore system that is not optimally formed with regard to the binding of the catalyst and the transport methods of reactants and products, which can impair the overall catalytic performance.

Under operating conditions, especially in continuous catalytic methods (i.e. catalyzed reaction methods) using powdered or finely divided activated carbon or powdered carbon in the reaction chamber, there is a high pressure loss due to the sometimes excessive compression of the catalyst system. This is often accompanied by a reduced flow rate for the reaction mixture with the corresponding reactants to be fed past the catalyst system. Excessive compression can also result if the abrasion hardness of the catalysts used or the corresponding support materials is too low.

In addition, the application properties of catalyst systems supported by activated carbon are often not optimal in that the finely divided catalyst system, especially in a liquid medium containing the reactants, tends to form sludge or excessive compaction, accompanied by the risk of clogging of the reaction device or an excessive reduction in the flow rate or filtration speed, which is detrimental to the overall catalytic conversion. Excessive compression of the catalyst system can also result in “dead zones” in the underlying device or apparatus, in which there is a significantly reduced conversion of reactants.

In this context, the formation of sludgy areas is particularly relevant in discontinuous use. In continuous catalytic applications, in which the catalyst systems are filled, for example, into corresponding reaction chambers, such as those based on cartridge systems, followed by a particularly continuous flow of a medium containing the reactants or reactants, equally high pressure losses result with correspondingly lower flow rates of the catalyst system. In addition, complex filtration or retention devices with a tendency to clogging are often required to prevent the catalyst from being discharged or washed out of the continuously flowing reaction system.

As a result, it can be stated that catalyst systems based on powdered or finely divided activated carbon as a carrier material do not always have sufficient or satisfactory properties overall with regard to their application.

In order to reduce the disadvantages associated with a small particle size, attempts have been made in the prior art to use catalyst carriers based on particulate activated carbon, whereby in this respect starting materials for the activated carbon based on coconut shells, charcoal, wood (e.g. wood waste, peat, hard coal or the like) are basically considered. These activated carbons used as catalyst carriers, which can generally be in splinter or grain form, lead in principle to a certain improvement in the application properties, especially with regard to the separation time in discontinuous application, but such activated carbons used as catalyst carriers often have too low mechanical stability, which is accompanied by high abrasion of the carrier material under application conditions, for example due to sometimes intensive stirring methods during catalytic conversion. The low abrasion resistance of such activated carbons then in turn leads to finely divided particles via the corresponding comminution or grinding methods, accompanied by a high loss of catalytically active substance and with the aforementioned disadvantages with regard to system silting or compaction or the like. In addition, such activated carbons often do not have optimally formed pore systems.

In addition, the known concepts of the prior art for providing catalyst systems based on activated carbon as a carrier material are also disadvantageous in that it is often not possible to optimally load or fix the catalyst on the carrier material, which on the one hand results in the catalyst quantities applied to the carrier being small and on the other hand often leads to a release or elution of the catalyst from the carrier material under application conditions. On the other hand, under application conditions, release or elution of the catalyst from the support material can often be observed, with the amounts of catalyst washed out being lost, which is disadvantageous from a method engineering point of view and not least for cost reasons.

In particular, the activated carbons used in the prior art, e.g. based on coconut shells, often have only a low affinity for the catalyst to be applied or fixed, which—without wishing to be restricted to this theory—is also due to the fact that the underlying activated carbons are often hydrophobic in terms of their pore surface or often do not have a sufficient amount of, in particular, polar functional groups to bind the catalyst (which is also the case, in particular, with polymer-based activated carbons, especially PBSACs). However, this is detrimental to the loading or equipping with a catalyst overall, and also with regard to a permanent fixation of the catalyst on the support system. The high loss of catalyst for the underlying catalyst system is equally accompanied by a reduction in reactant conversion in the underlying catalytic reactions, which also worsens the economic efficiency of the catalyst systems used.

Since conventional activated carbon is nonpolar or hydrophobic on its surface and therefore has no significant affinity for catalysts or catalytically active components to be applied or fixed, which are used for the reactive or catalytic equipment of the activated carbon, it is necessary to use a large excess of catalyst substance during the production or equipment of the activated carbon with the catalyst in order to ensure a certain loading of the activated carbon. In order to ensure a certain loading of the activated carbon at all, it is necessary to use a large excess of catalyst substance in the course of the production or equipping of the activated carbon with the catalyst, or it is necessary to create surface centers (i.e. centers for the attachment of the catalytically active components) in advance. In particular, the catalysts generally only adhere via purely physical interactions and can therefore also be at least partially removed or washed out again (e.g. by elution methods or the like), especially when they come into contact with liquids.

In principle, with regard to heterogeneous catalysts with the use of activated carbon as a support material according to the known concepts of the prior art, there is also the disadvantage that, in particular as a result of a non-optimally formed pore system of the support material, in particular with regard to the underlying pore sizes and their distribution, or rather their proportions in the total pore volume, the transport or diffusion methods for reactants or products are not optimal, the transport or diffusion methods for reactants or products are not optimal, which is associated with reduced conversions and a non-optimal space/time yield, for example because reactants are not optimally transported to the underlying catalytic center or the resulting products are not optimally removed from the catalyst system.

In this context, heterogeneous catalysis in a porous structure as catalyst support, such as activated carbon, can basically be divided into seven substeps, including corresponding transport steps for reactants or products, each of which can be speed-determining. In this connection, reference can also be made to FIG. 4 and the following explanations relating thereto.

A non-optimal formation of the pore system of the carrier material thus worsens the conversion or the space/time yield in the long term, since transport methods within the system are insufficient and overall limiting with regard to the catalytic activity.

Furthermore, the conversion or the space/time yield can also be reduced by the fact that the catalytically active centers as such are not optimally formed or that the support material is only insufficiently equipped with a catalytically active component, which can also be caused by a pore system of the catalyst support that is not optimally formed in this respect.

In addition, the catalyst systems known in the prior art sometimes have the disadvantage during application, in particular in a fixed-bed bed or the like, that high pressure losses result, and there is often also a high level of dust formation with associated material loss, in particular as a result of the hardness or abrasion resistance of the underlying catalyst systems not always being sufficient.

DE 29 36 362 C2 relates to a method for the production of a palladium-carbon catalyst, wherein the palladium is deposited by reduction on carbon suspended in an organic solvent as a catalyst support. In this context, the palladium is to be deposited as a metal on the suspended support. Powdered activated carbon, carbon black or graphite is used as the carbon support. However, the catalysts described are sometimes associated with the disadvantages described above, in particular with regard to the separation or recovery of the catalyst, especially in discontinuous catalytic methods, as well as its application properties in continuous catalytic methods, especially with regard to pressure loss or flow velocity.

In summary, it can be stated that the catalyst systems known in the prior art based on conventional activated carbons or powdered activated carbons as the carrier material used have both production-specific and application-specific disadvantages, particularly with regard to loading with a catalytically active component and its fixation on the material, on the one hand, and with regard to the use of the underlying systems in continuous and discontinuous catalysis applications, on the other.

### BRIEF SUMMARY OF THE INVENTION

Against this background, it is therefore an object of the present invention to provide catalyst systems or supported catalysts which have at least one catalytically active component, as well as a corresponding manufacturing method, whereby the disadvantages of the prior art described above are to be at least largely avoided or at least mitigated.

In particular, the present invention is intended to provide a catalyst system having at least one catalytically active component or a supported catalyst which has at least one catalytically active component, which catalyst system or catalyst has both production-specific and application-specific advantages. In this regard, a corresponding method for producing the catalyst system is also to be provided.

An object underlying the present invention is also to be seen in particular in the fact that, within the scope of the present invention, an overall high-performance catalyst system is to be provided which, with high durability or stability, enables high conversions and associated high space/time yields, while at the same time a high recyclability and stability of the system provided is to be given.

In particular, according to the invention, such a catalyst system is to be provided which enables a high or efficient loading with the catalyst component or a catalytically active component, while at the same time a permanent and consistent loading or equipping with the catalyst component is to be ensured.

Furthermore, according to the invention, such a catalyst system is also to be provided which, within the scope of its application, in particular in chemical catalysis, preferably on an industrial scale, has improved properties both in discontinuous and continuous catalytic applications, in particular with regard to its catalytic performance as well as the separation or recovery or recycling of the system (in particular in discontinuous methods) and, moreover, also improved properties with regard to ensuring a low or adjustable pressure loss and high or adjustable flow rates (in particular in discontinuous methods). The chemical catalyst, preferably on an industrial scale, has improved properties, in particular with regard to its catalytic performance and the separation or recovery or recycling of the system (in particular in discontinuous methods), and also has improved properties with regard to ensuring a low or adjustable pressure loss and high or adjustable flow rates (in particular in continuous catalytic methods), whereby overall optimized method times or increased catalytic activity are also to be provided.

In particular, the present invention also seeks to provide such a catalyst system which, in addition to its high catalytic activity, also has excellent mechanical properties, especially with respect to the abrasion resistance or bursting pressure of the underlying particulate structures.

Similarly, the systems according to the invention should also be tailor-made or individually designed or equipped with regard to the respective application or use case.

In addition, the present invention is intended to provide an efficient method on the basis of which the catalyst system according to the invention with at least one catalytically active component can be obtained.

As the applicant has now found out in a completely surprising manner, the previously stated task underlying the present invention can be solved in an unexpected manner by providing, within the scope of the present invention, a special method for the production of a special catalyst system as well as a corresponding catalyst system as such.

In this context, according to the invention, a special activated carbon is used as catalyst support which, in addition to its granular or spherical design or shape, has a specially designed pore system, namely with a high proportion of mesopores and macropores in the total pore volume of the activated carbon, so that according to the invention, an activated carbon with high mesopores and macropores (with a simultaneously defined proportion of micropores) is used. In addition, the activated carbon used according to the invention has a special BET surface area with, at the same time, a special ratio of total pore volume to specific BET surface area.

In addition, in the method according to the invention, a targeted oxidation, in particular surface oxidation (i.e. oxidation in particular also of the inner surface of the catalyst support), of the activated carbon subsequently used as catalyst support is aimed at or targeted for the purpose of adjusting a specific oxygen content, in particular surface oxygen content, and with the formation of a specific hydrophilicity, such a specific activated carbon then being equipped with a catalytically active component or a precursor thereto, followed by a reduction to obtain the catalyst system according to the invention.

In other words, according to the invention, a special catalyst system or a supported catalyst with at least one catalytically active component applied to a catalyst support is thus provided, wherein the catalyst support is in the form of a very specially formed granular or spherical activated carbon with special porosity, in particular with regard to the formation of a high meso- and macroporosity (i.e. with a high proportion of meso- and macropores in the total pore volume with a simultaneously defined proportion of micropores), and wherein the application of the catalytically active component to the activated carbon is carried out in oxidized form of the activated carbon (i.e. to the oxidized activated carbon), followed by a further reduction of the underlying system (i.e. the active centers or the active components) in this respect to obtain the catalyst system according to the invention. In addition to the high meso- and macroporosity, the activated carbon used as catalyst support also exhibits a defined microporosity (i.e. a defined proportion of micropores in the total pore volume), albeit generally to a degree that is subordinate to the meso- and macropore volume but sufficient for catalysis.

Surprisingly, a catalyst system according to the invention or a supported catalyst is provided on this basis which, due to improved transport or diffusion properties for reactants or products caused by the special pore system and improved loading with the catalytically active component, exhibits excellent catalytic properties, accompanied by high catalytic conversions and high space/time yields when used in catalytic methods. In this regard, the catalyst system according to the invention also exhibits a high degree of dispersion and an optimized crystallite size of the catalytically active component, which can be used as a parameter or measure of catalytic performance.

The catalyst system provided according to the invention is also particularly suitable for use in the field of chemical catalysis, and in particular on a (large) industrial scale. In addition, the catalyst system according to the invention is also particularly suitable for corresponding filter applications for removing, for example, pollutants and toxic substances from a medium containing these substances. In particular, the catalyst systems according to the invention are also suitable for use in or for protective materials, in particular for the civilian or military sector, in particular protective materials for NBC use.

In particular, due to the spherical design or spherical shape, the outstanding mechanical properties of the catalyst support and the controllable or specially designed meso- and macroporosity (with simultaneously defined microporosity), the catalyst systems according to the invention are also of great importance, especially for continuous catalysis, whereby disadvantages of the prior art are also overcome with regard to discontinuous catalysis, which are associated, for example, with conventional powder catalysts or the like, as explained above.

To solve the object described above, the present invention thus proposes—according to a first aspect of the present invention—the method according to the invention for producing a catalyst system having at least one catalytically active component is discussed. Further, in particular advantageous embodiments of the method according to the present invention are also provided.

A further object of the present invention—according to a second aspect of the present invention—is furthermore the catalyst system according to the invention or the supported catalyst according to the invention, wherein the catalyst system or the supported catalyst comprises at least one catalytically active component and wherein a special granular activated carbon is used as catalyst support, according to the disclosure relating thereto and concerning the catalyst system according to the invention. Further, in particular advantageous, embodiments of the catalyst system according to the invention are illustrated.

Again, further subject matter of the present invention—according to a third aspect of the present invention—are the uses according to the invention.

In addition, further subject matter of the present invention—according to a fourth aspect of the present invention—are the protective materials according to the invention, in particular for the civilian or military field, in particular protective clothing.

In addition, further subject matter of the present invention—according to a fifth aspect of the present invention—are also filters and filter materials, in particular for removing pollutants, odors and toxic substances of all kinds. Further, in particular advantageous embodiments of the filters and filter materials according to the present invention are also provided.

It goes without saying that in the following description of the present invention, such embodiments, advantages, examples or the like which are set forth below—for the purpose of avoiding unnecessary repetition—only with respect to a single aspect of the invention, naturally also apply mutatis mutandis with respect to the remaining aspects of the invention without the need for express mention.

Furthermore, it goes without saying that in the following statements of values, numbers and ranges, the relevant statements of values, numbers and ranges are not to be understood as limiting; it goes without saying for the person skilled in the art that, depending on the individual case or application, deviations from the stated ranges or statements can be made without leaving the scope of the present invention.

In addition, it applies that all values or parameters or the like mentioned in the following can basically be determined with standardized or explicitly stated determination methods or otherwise with determination or measurement methods familiar to the expert in this field.

In addition, it should be noted that in the case of all the relative or percentage, in particular weight-related, quantitative data listed below, these data are to be selected or combined by the person skilled in the art within the scope of the present invention in such a way that in total—if necessary including further components or ingredients, in particular as defined below—always 100% or 100% by weight results. However, this is self-evident for the person skilled in the art.

Having said this, the present invention is described in more detail below.

### BRIEF DESCRIPTION OF THE DRAWINGS

FIG. 1 provides a diagram of the nitrogen isotherms of various catalyst supports or activated carbons used in this connection to determine the porosity;

FIG. 2 provides a diagram of the mercury intrusion curves of various catalyst supports or activated carbons used in this connection for further determination of the porosity;

FIG. 3 provides a diagrammatic representation of the values determined for different catalyst systems for the dispersion as well as the crystallite size of the catalytically active component or the metal in question (5 wt. % palladium catalyst);

FIG. 4 provides a schematic representation of the kinetics underlying heterogeneous catalysis based on substeps comprising the first step (1) of diffusion of reactants (E) to the surface of the catalyst (K) through the stationary boundary layer (G); the second step (2) of diffusion of reactants (E) into the pores of the catalyst (K) to the catalytically active center or to the catalytically active component; with the third step (3) of adsorption of the reactants (E) on the active center; with the fourth step (4) of reaction of the reactants (E) on the active center to obtain products (P) thereof; with the fifth step (5) of desorption of the products (P) from the active center; with the sixth step (6) of diffusion of the products (P) through the pore system of the catalyst (K) and with the seventh step (7) of diffusion of the products (P) through the boundary layer (G) to the external region and removal of the products (P);

FIG. 5 provides a schematic representation of a method sequence according to one embodiment of the present invention [with EP=precious metal precursor, TR=PBSAC carrier, TV=carrier pretreatment (e.g., oxidation with mineral acids or air oxidation), I=impregnation (e.g., dip impregnation or spray impregnation), W=washing, T=drying, R=reduction (e.g., gas phase or liquid phase reduction), Cat=catalyst, CatR=catalyst reactivation, MR=metal recovery];

FIG. 6 provides a schematic representation of a device based on a fixed-bed reactor used for heterogeneous catalysis, in particular hydrogenation;

FIG. 7A provides a reaction underlying the hydrogenation of cinnamic acid using the catalyst system according to the invention;

FIG. 7B provides a diagram showing the time course of the catalytic conversion (hydrogenation) of cinnamic acid as a reactant by means of various catalyst systems according to the invention using activated carbon as a catalyst support with a high proportion of mesopores and macropores in the total pore volume of the activated carbon (mesoporous and macroporous activated carbon);

FIG. 7C provides a diagram showing the time course of the catalytic conversion (hydrogenation) of cinnamic acid by means of various catalyst systems using activated carbon as the catalyst support with a high proportion of micropores in the total pore volume of the relevant activated carbon (microporous activated carbon).

### DETAILED DESCRIPTION OF THE INVENTION

According to the first aspect of the present invention, the present invention thus relates to a method for preparing a catalyst system comprising at least one catalytically active component, in particular a supported catalyst, preferably for use in heterogeneous catalysis,
wherein at least one catalytically active component is applied and/or fixed to a catalyst support, said catalytically active component comprising and/or consisting of at least one metal,
wherein the method comprises the following steps in the sequence (a) to (d) specified below:
(a) Provision and/or production of a granular, preferably spherical, activated carbon (=initial activated carbon) used as catalyst support,
   wherein the activated carbon (i.e. the initial activated carbon)
   (i) has a total pore volume (Vₜₒₜₐₗ), in particular a total pore volume according to Gurvich, in the range from 0.8 cm³/g to 3.9 cm³/g, at least 50% of the total pore volume, in particular the total pore volume according to Gurvich, of the activated carbon being formed by pores having pore diameters of at least 2 nm, in particular by pores having pore diameters in the range from 2 nm to 500 nm, preferably by meso- and macropores, and
   (ii) has a specific BET surface area (S_{BET}) in the range from 1,000 m²/g to 3,000 m²/g, but with the proviso that the ratio (quotient; Q) of total pore volume (Vₜₒₜₐₗ), in particular total pore volume according to Gurvich, to specific BET surface area (S_{BET}), in particular according to the equation Q=Vₜₒₜₐₗ/S_{BET}, is at least 0.5*10⁻⁹ m;
   then
(b) oxidation, in particular surface oxidation, of the activated carbon prepared and/or produced in method step (a), with the proviso that the oxidized, in particular surface-oxidized, activated carbon has an oxygen content, in particular surface oxygen content, in particular determined by means of X-ray photoelectron spectroscopy (XPS or ESCA), of at least 4% (atomic %), based on the total element composition of the oxidized activated carbon, and/or with the proviso that the oxidized, in particular surface-oxidized, activated carbon has a hydrophilicity, determined as water vapor adsorption behavior, such that at least 30% of the maximum water vapor saturation loading of the activated carbon is reached at a partial pressure p/p₀ of 0.6;
then
(c) equipping, in particular loading and/or coating and/or impregnation, of the activated carbon oxidized in method step (b), in particular surface-oxidized, with the catalytically active component, in particular with at least one precursor of the catalytically active component;
then
(d) reduction (i.e. on the one hand surface reduction in particular of the previously oxidized activated carbon and/or on the other hand in particular reduction of the catalytically active component or the precursor thereof, preferably of the metal or metal compound underlying the catalytically active component) of the activated carbon obtained in method step (c) equipped with the catalytically active component, in particular with the precursor of the catalytically active component, of the oxidized, in particular surface-oxidized, activated carbon, in particular for transferring the precursor of the catalytically active component into the catalytically active component, in particular so that the catalyst system having at least one catalytically active component, in particular the supported catalyst, is obtained.

A fundamental idea of the present invention is thus to be seen, as indicated above, in particular in the fact that a very special activated carbon is used as catalyst carrier for receiving or equipping with the catalytically active component, wherein the activated carbon used according to the invention is, on the one hand, in granular or spherical form on the one hand and with a defined porosity on the other hand, in particular with regard to a high meso- and macroporosity and at the same time a defined proportion (i.e. in a degree which is subordinate to the meso- and macropores but sufficient for catalysis) of micropores, wherein in addition an oxidation treatment or a surface oxidation of the activated carbon is carried out in a specific manner prior to equipping with the catalytically active component. In this context, the applicant has equally found completely surprisingly that, using an activated carbon with defined porosity as previously indicated, overall improved catalytic properties of the resulting catalyst system are provided, in particular with regard to high conversions with simultaneously high catalytic activity and correspondingly high space/time yields in the underlying catalytic conversions or reactions.

Without wishing to be limited to this theory, the use of a special activated carbon with a high proportion of mesopores and macropores and at the same time a defined proportion of micropores improves in particular the transport and diffusion methods of the reactants and products on which the catalytic reaction is based, while at the same time providing high accessibility and optimized formation of the catalytically active component incorporated in the catalyst support.

In this context, the kinetics of the underlying catalysis are improved overall, in particular with regard to improved transport and diffusion methods within the pore system and in the region of the boundary layer of the catalyst support, while at the same time the reactants to be reacted have a high degree of accessibility to the catalytically active component or the catalytic centers.

According to the invention, an overall improved catalyst system is thus also provided due to the special tuning and formation of the pore system of the activated carbon used as catalyst support, which exhibits very good efficiency with regard to the catalytic activity. In this respect, the target and purpose-oriented (surface) oxidation of the activated carbon used as catalyst support prior to equipping with the catalytically active component is also of great importance, since this improves the binding or loading with the catalytically active component or the relevant precursor, also with regard to the formation of catalytic centers with a defined (metal) dispersion and crystallite size, as will be explained in detail below.

A further central advantage of the present invention is also to be seen in the fact that the activated carbons used according to the invention have a high mechanical stability or resistance, accompanied by low abrasion during their use in catalytic methods, so that a correspondingly high durability of the catalytic system according to the invention is given with simultaneously high recyclability.

By the specific use of a granular or spherical activated carbon, i.e. an activated carbon with a special shape, the application properties of the catalyst system according to the invention are further improved, namely also with regard to the use of the catalyst system provided according to the invention in discontinuous as well as continuous catalytic applications. This is because, on the one hand, the special shaping, in particular based on discrete spheres, achieves improved bulk porosity with respect to discontinuous applications, which both prevents sludge formation in the reaction system and significantly improves the separation or recovery of the catalyst from the reaction system. On the other hand, the improved bulk properties of the catalyst system according to the invention lead to lower pressure losses with simultaneous high accessibility of the catalyst system for reactants or reactants to be reacted, so that, using the catalyst system according to the invention, high flow rates can also be realized with respect to a medium containing the reactants or reactants to be reacted.

The activated carbon (spherical carbon) used in accordance with the invention in granular form and in particular in spherical form also has a number of advantages, especially compared with other forms of activated carbon, such as powdered carbon, crushed carbon and carbon from coal or the like, in terms of improved flowability, abrasion resistance and freedom from dust, which also leads not least to high mechanical resistance and durability, accompanied by long service lives of the underlying systems. Consequently, closure during use is also reduced, leading to increased service lives.

As will be indicated in the following, it is also possible to provide overall customized catalytic systems with optimized application properties in each case, in particular with regard to the recovery of the catalyst system or the flow behavior or the pressure loss, by specifically adjusting the particle sizes or diameters of the underlying spherical activated carbon, with the catalytic activity of the catalyst system according to the invention being further improved at the same time. In particular, the pressure loss or the flow rate can be adjusted or changed by specifying the particle size, so that optimized systems can also be provided against the respective background of use or application.

In the context of the present invention, in particular extremely abrasion-resistant or mechanically stable spherical activated carbons are used in a purposeful manner for the catalyst support employed, such as are provided in particular by the special activated carbons based on organic polymers, in particular based on sulfonated organic polymers, still defined below. In this context, it is completely surprising in the context of the present invention that a sulfur content which may be present in the activated carbon, which may amount, for example, to up to 0.1% by weight, based on the activated carbon, is not detrimental to the catalytic function of the catalyst system according to the invention or does not lead to any detrimental impairment of the catalytic activity and, in particular, does not lead to so-called catalyst poisoning.

Furthermore, as a result of the (surface) oxidation of the activated carbon used prior to equipping with the catalytically active component, the present invention has succeeded in a surprising manner in ensuring a high and at the same time permanent or stable loading of the activated carbon used as a carrier material with the catalytically active component. This leads to a significantly increased catalytic activity and at the same time improved durability of the catalyst system according to the invention, in particular since a washing out or detachment of the catalytically active component from the carrier material is also reduced or avoided in the case of application.

Without wanting to commit to this theory, the targeted oxidation or surface oxidation of the activated carbon leads to the formation of special oxygen-containing functional groups on the activated carbon used according to the invention or in its pore system, both in the area of the micropores, mesopores and macropores, whereby the affinity of the activated carbon for the catalytically active component used according to the invention is increased. As a result of the oxidation or surface oxidation treatment of the activated carbon carried out in accordance with the invention prior to equipping with the catalytically active component, a less hydrophobic or a hydrophilic surface of the activated carbon or special functional groups are generated or provided on the surface of the activated carbon or in the pore system of the activated carbon, which significantly improves the incorporation of the catalytically active component in a completely surprising manner.

In this context, it is equally completely surprising that the catalyst system according to the invention based on the spherical activated carbon with defined particle shape or particle size, which is subjected to oxidation before loading with the catalytically active component, also exhibits significantly improved catalytic activity compared to powdered activated carbons. In this context, it is completely surprising that with respect to the catalyst system according to the invention, there are no significant restrictions or limitations with respect to mass transport, in particular with respect to the underlying reactants or reactants, in the pore system of the activated carbon, which is also due in particular to the defined pore structure, as indicated below, of the activated carbons used according to the invention. In this context, it has proved particularly advantageous in accordance with the invention if a meso- and macroporous activated carbon, in particular with a defined, albeit subordinate, proportion of micropores, is used as the catalyst support for the catalyst system according to the invention.

In particular, it is completely surprising that the catalyst system provided according to the invention exhibits a high catalytic activity even with relatively large particle or particulate sizes, especially in comparison with powdered carbon. In this context, the interaction of the measures according to the invention—without wishing to be limited to this theory—has made it possible, on the one hand, to achieve a particularly uniform and high loading of the activated carbon with the catalytically active component and, on the other hand, to reduce mass transport or diffusion limitations in the catalyst system which are detrimental to the catalytic activity.

In the context of the conception according to the invention, in particular due to the special matching of the support system on the one hand and the catalytically active component on the other hand, clogging of the pore system underlying the activated carbon by the catalytically active component—for example due to excessive crystal size in the context of crystallization of metal salts—is also at least substantially prevented, which further improves the performance of the catalyst system provided according to the invention.

According to the invention, it has thus been possible for the first time to provide, on the basis of the method according to the invention, a very special catalyst system with a very special activated carbon as support material, which is equipped in a targeted manner with at least one catalytically active component, the catalyst system having significant advantages and improved properties compared with systems of the prior art and being suitable both for discontinuous and continuous catalytic applications.

The catalyst system according to the invention provided by the method according to the invention exhibits both improved mechanical and improved catalytic properties, accompanied by method time reductions and high recovery rate with reduced time and excellent recycling of the underlying catalyst or catalytically active component. In addition, as previously stated, the catalyst system according to the invention exhibits improved flow properties with low pressure drop, particularly when used or applied in the form of (loose) bulk.

Furthermore, the catalyst system according to the invention, which is provided on the basis of the method according to the invention, is also suitable for use in or as filter(s) or filter material(s), in particular for rendering harmful or toxic substances or the like harmless.

The catalyst system provided on the basis of the method according to the invention thus combines excellent mechanical properties on the one hand with outstanding catalytic properties on the other.

Based on the method according to the invention, the result is an effective equipment of the activated carbon used as carrier material with at least one catalytically active component to obtain the catalyst system according to the invention.

The term “catalyst system”, as used in accordance with the invention and also referred to synonymously as “supported catalyst”, is to be understood very broadly in accordance with the invention and refers in particular to a functional unit based on at least one catalytically active component on the one hand and a support material on the other, wherein the catalytic properties can be attributed substantially to the catalytically active component, which for this purpose comprises or consists of at least one metal. In this context, it is provided in particular according to the invention that the activated carbon used is provided with the catalytically active component, in particular in the form of an equipment or loading or coating or impregnation, in particular based on a fixation of the catalytically active component on the underlying catalyst support, for obtaining the catalyst system according to the invention.

Furthermore, the terms “equipment” or “loading” or “coating” or “impregnation”, as used in accordance with the invention, refer in particular to such a “impregnation”, as used according to the invention, refer in particular to such an equipment of the activated carbon used according to the invention as a carrier material with the catalytically active component, according to which the outer and/or the inner surface structure of the activated carbon used, together with the relevant pores, in particular micropores, mesopores and/or macropores, are at least partially and/or sectionally in contact with the catalytically active component or are provided or equipped therewith. In this context, the catalytically active component—without wishing to limit itself to this theory—forms on the activated carbon surface, as it were, a catalytic structure or chemisorptive properties which functionally supplement the physisorptive properties of the activated carbon, so that the catalyst system provided on the basis of the method according to the invention basically combines both chemisorptive and physisorptive properties in one and the same material. In particular, the catalytically active component can be bound to the activated carbon surface in a physisorptive and/or chemisorptive manner, in particular wherein the properties of the catalytically active centers or the catalytically active component can depend in particular on the surface properties of the activated carbon, the catalytically active component itself and/or the reduction conditions. The catalytically active component is present in or on the activated carbon, in particular in particulate or crystalline form.

Furthermore, with regard to the term “spherical”, synonymously also referred to as “spheric”, as used for the activated carbon used as a carrier material according to the invention, this term is to be understood very broadly and, according to a preferred embodiment of the present invention, relates in particular to an at least substantially ideal spherical or spheric shape of the activated carbon, but also such formations or physical designs of the activated carbon used which deviate from the spherical shape, such as a formation of the activated carbon in the form of a (rotational) ellipsoid or the like. In addition, the term “spherical” also includes such spherical or ellipsoidal forms of the activated carbon in which the activated carbon may have protrusions or indentations, dents, depressions, cracks or the like. According to the invention, the use of a spherical activated carbon or a spherical carbon or a spherical activated carbon is therefore decisive.

As far as the term “surface oxidation” is concerned, as used according to the invention, this means in particular an oxidation of those surfaces of the activated carbon used as starting material which are in contact with the environment containing in particular the oxidizing agent or which are accessible, so to speak, from the outside for the oxidizing agent used according to the invention. In particular, this also refers to the pore system of the activated carbon in the form of macro-, meso- and micropores.

Furthermore, the ratio (quotient; Q) of total pore volume (Vₜₒₜₐₗ), in particular total pore volume according to Gurvich, to specific BET surface area (S_{BET}), in particular according to the equation Q=Vₜₒₜₐₗ S_{BET}, the value underlying this serves to further characterize the pore system of the activated carbon used as a catalyst support according to the invention, in particular to the effect that, on the basis of the quotient Q, the porosity or the pore system of the activated carbon is further characterized and defined on the basis of the quotient Q, namely in particular to the effect that for the activated carbon used according to the invention as catalyst support there is overall a high proportion of meso- and macropores in the total pore volume with a simultaneously defined proportion of micropores. In particular, the underlying quotient describes the high meso- and macroporosity of the activated carbon used according to the invention. In this context, the quotient Q can furthermore be used as a measure of the improved kinetics during heterogeneous catalysis when using the catalyst system according to the invention, or of the improved catalytic activity, as a result of the specially formed activated carbon. Thus, as a result of the specially formed pore system of the activated carbon, which is further characterized by the quotient, there is an overall improvement with regard to the rate-determining steps of the kinetics underlying heterogeneous catalysis, for example with regard to the improved diffusion behavior of reactants or products and the accessibility of the catalytically active component. The quotient Q thus further reflects the properties of the catalyst system according to the invention provided in the method according to the invention, in particular with regard to its improved catalytic performance.

As far as the activated carbon used as catalyst support or the related activated carbon particles as such are concerned, the parameter data listed in this respect are determined using standardized or explicitly stated determination methods or using determination methods familiar to the skilled person per se. In particular, the parameter data concerning the characterization of the porosity or pore size distribution and other adsorption properties are generally derived, unless otherwise stated, from the corresponding nitrogen sorption isotherms of the respective activated carbon or the measured products.

In the context of the present invention, the term “micropores” refers to such pores having pore diameters of less than 2 nm, whereas the term “mesopores” refers to such pores having pore diameters in the range of 2 nm (i.e., 2 nm inclusive) to 50 nm inclusive, and the term “macropores” refers to such pores having pore diameters greater than 50 nm (i.e. >50 nm) and, more particularly, up to 500 nm inclusive.

In the following, the production of the activated carbon used as catalyst support as described in step (a) is described in more detail:

Thus, according to the invention, it can be provided in particular that the activated carbon prepared or produced in method step (a) (i.e. initial activated carbon) has a total pore volume (Vₜₒₜₐₗ), in particular a total pore volume according to Gurvich, in the range from 0.9 cm³/g to 3.4 cm³/g, in particular in the range from 1 cm³/g to 2.9 cm³/g, preferably in the range from 1.1 cm³/g to 2.4 cm³/g, preferably in the range from 1.2 cm³/g to 1.9 cm³/g, particularly preferably in the range from 1.5 cm³/g to 1.9 cm³/g.

As equally indicated before, according to the invention it is in particular such an activated carbon used as catalyst support which has a high overall meso- and macroporosity. In this context, it can be provided according to the invention that 50% to 90%, in particular 52.5% to 87.5%, preferably 55% to 85%, preferably 57.5% to 82.5%, particularly preferably 60% to 80%, of the total pore volume, in particular the total pore volume according to Gurvich, of the activated carbon prepared and/or produced in method step (a) (i.e., initial activated carbon) is passed through the catalyst carrier (i.e. starting activated carbon) are formed by pores with pore diameters of at least 2 nm, in particular by pores with pore diameters in the range from 2 nm to 500 nm, preferably by meso- and macropores.

In addition, the activated carbon provided or produced in method step (a) can equally have a defined, subordinate, but sufficient microporosity for catalysis, whereby in general relatively small proportions of the total pore volume are present in relation to the micropores (and in particular to a degree sufficient for catalysis): Thus, according to the invention, it can be provided in particular that 2.5% to 50%, in particular 5% to 50%, preferably 10% to 50%, particularly preferably 12.5% to 47.5%, especially preferably 15% to 45%, very particularly preferably 17.5% to 42.5%, further preferably 20% to 40%, of the total pore volume, in particular the total pore volume according to Gurvich, of the activated carbon provided and/or produced in method step (a) (i.e. starting activated carbon) are formed by pores with pore diameters of less than 2 nm, preferably by micropores.

Furthermore, it can be provided according to the invention that the activated carbon prepared or produced in method step (a) (i.e. initial activated carbon) has a total pore volume (Vₜₒₜₐₗ), in particular a total pore volume according to Gurvich, in the range from 0.8 cm³/g to 3.9 cm³/g, in particular in the range from 0.9 cm³/g to 3.4 cm³/g, preferably in the range from 1 cm³/g to 2.9 cm³/g, preferably in the range from 1.1 cm³/g to 2.4 cm³/g, particularly preferably in the range from 1.2 cm³/g to 1.9 cm³/g, very particularly preferably in the range from 1.5 cm³/g to 1.9 cm³/g, wherein 50% to 90%, in particular 52.5% to 87.5%, preferably 55% to 85%, preferably 57.5% to 82.5%, particularly preferably 60% to 80%, of the total pore volume, in particular the total pore volume according to Gurvich, of the activated carbon is formed by pores having pore diameters of at least 2 nm, in particular by pores having pore diameters in the range from 2 nm to 500 nm, preferably by meso- and macropores.

In addition, it can be provided according to the invention that the activated carbon prepared or produced in method step (a) (i.e. initial activated carbon) has a total pore volume (Vₜₒₜₐₗ), in particular a total pore volume according to Gurvich, in the range from 0.8 cm³/g to 3.9 cm³/g, in particular in the range from 0.9 cm³/g to 3.4 cm³/g, preferably in the range from 1 cm³/g to 2.9 cm³/g, preferably in the range from 1.1 cm³/g to 2.4 cm³/g, particularly preferably in the range from 1.2 cm³/g to 1.9 cm³/g, very particularly preferably in the range from 1.5 cm³/g to 1.9 cm³/g, wherein 2.5 to 50%, in particular 5% to 50%, preferably 10 to 50%, particularly preferably 12.5% to 47.5%, especially preferably 15% to 45%, very particularly preferably 17.5% to 42.5%, further preferably 20% to 40%, of the total pore volume, in particular the total pore volume according to Gurvich, of the activated carbon prepared and/or produced in method step (a) (i.e., starting activated carbon) are formed by pores with pore diameters of less than 2 nm, in particular by micropores.

As far as the determination of the total pore volume according to Gurvich is concerned, this is a measurement/determination method well known to the expert in this field. For further details concerning the determination of the total pore volume according to Gurvich, reference can be made, for example, to L. Gurvich (1915), J. Phys. Chem. Soc. Russ. 47, 805, and to S. Lowell et al., Characterization of Porous Solids and Powders: Surface Area Pore Size and Density, Kluwer Academic Publishers, Article Technology Series, pages 111 ff. In particular, the pore volume of the activated carbon can be determined on the basis of the Gurvich rule according to the formula Vₚ=Wₐ/ρᵢ, where Wₐ represents the adsorbed amount of an underlying adsorbate and ρᵢ represents the density of the adsorbate used (see also formula (8.20) according to page 111, chapter 8.4.) of S. Lowell et al.).

Furthermore, the activated carbon prepared or produced in method step (a) (i.e. initial activated carbon) can have a specific BET surface area (S_{BET}) in the range of 1.100 m²/g to 2.600 m²/g, in particular in the range of 1.200 m²/g to 2.400 m²/g, preferably in the range from 1.300 m²/g to 2.200 m²/g, preferably in the range from 1.350 m²/g to 1.950 m²/g, particularly preferably in the range from 1.375 m²/g to 1.900 m²/g.

The determination of the specific surface area according to BET is basically known as such to the person skilled in the art, so that no further details need to be elaborated in this respect. All BET surface area data refer to the determination according to ASTM D6556-04. Within the scope of the present invention, the so-called MultiPoint-BET determination method (MP-BET) is used for the determination of the BET surface area-generally and unless expressly stated otherwise below—in a partial pressure range p/p₀ of 0.05 to 0.1.

For further details on the determination of the BET surface area or on the BET method, reference can be made to the above-mentioned ASTM D6556-04 as well as to Römpp Chemielexikon, 10th edition, Georg Thieme Verlag, Stuttgart/New York, keyword: “BET method”, including the literature referenced therein, and to Winnacker-Küchler (3rd edition), volume 7, pages 93 ff. as well as to Z. Anal. Chem. 238, pages 187 to 193 (1968).

The formation of a defined pore system with a high mesopore and macropore volume or proportion, as described above, also leads to improved transport and diffusion properties for the reactants or products underlying the catalytic reaction, in particular as a result of the high mesopore and macropore proportion. At the same time, with regard to the catalyst system provided, improved catalytic properties are also present from the fact that catalytic active centers or active centers can also form in particular in smaller pores, such as micropores.

As a result of the balanced and coordinated pore distribution with the underlying defined hierarchical pore system with high mesopore and macropore volume and micropore volume sufficient for catalysis or catalytic activity, respectively, overall improved properties are thus provided with regard to the kinetics of heterogeneous catalysis. In this context, the aforementioned properties of the activated carbon used in method step (a) (i.e., the starting activated carbon) are directly reflected in the catalyst system according to the invention obtained in method step (d).

In this context, it can be provided according to the invention in particular that for the activated carbon prepared or produced in method step (a) (i.e. initial activated carbon) the ratio (quotient; Q) of total pore volume (Vₜₒₜₐₗ), in particular total pore volume according to Gurvich, to specific BET surface area (S_{BET}), in particular according to the equation Q=Vₜₒₜₐₗ/S_{BET}, in the range from 0.5*10⁻⁹ m to 1.9*10⁻⁹ m, in particular in the range from 0.55*10⁻⁹ m to 1.9*10⁻⁹ m, preferably in the range from 0.6*10⁻⁹ m to 1.8*10⁻⁹ m, preferably in the range from 0.65*10⁻⁹ m to 1.7*10⁻⁹ m, particularly preferably in the range from 0.65*10⁻⁹ m to 1.6*10⁻⁹ m, most preferably in the range from 0.7*10⁻⁹ m to 1.5*10⁻⁹ m, more preferably in the range from 0.75*10⁻⁹ m to 1.4*10⁻⁹ m, still more preferably in the range from 0.8*10⁻⁹ m to 1.3*10 m⁻⁹.

The aforementioned lower limits still ensure good occupancy of the activated carbon with the catalytically active component with simultaneous good mass transfer and thus high conversions in the underlying catalysis. Furthermore, the aforementioned upper limits still ensure a sufficient micropore volume, which is particularly associated with the formation of a correspondingly high number of active sites or centers with regard to the catalytic activity involving the catalytically active component.

According to the invention, it can be provided in particular that the activated carbon prepared or produced in method step (a) (i.e. initial activated carbon) has a specific BET surface area (S_{BET}) in the range of 1.000 m²/g to 3.000 m²/g, in particular in the range of 1.100 m²/g to 2.600 m²/g, preferably in the range from 1.200 m²/g to 2.400 m²/g, preferably in the range from 1.300 m²/g to 2.200 m²/g, particularly preferably in the range from 1.350 m²/g to 1.950 m²/g, most preferably in the range from 1.375 m²/g to 1.900 m²/g, whereby the ratio (quotient; Q) of total pore volume (Vₜₒₜₐₗ), in particular total pore volume according to Gurvich, to specific BET surface area (S_{BET}), in particular according to the equation Q=Vₜₒₜₐₗ/S_{BET}, in the range from 0.5*10⁻⁹ m to 1.9*10⁻⁹ m, in particular in the range from 0.55*10⁻⁹ m to 1.9*10⁻⁹ m, preferably in the range from 0.6*10⁻⁹ m to 1.8*10⁻⁹ m, preferably in the range from 0.65*10⁻⁹ m to 1.7*10⁻⁹ m, particularly preferably in the range from 0.65*10⁻⁹ m to 1.6*10⁻⁹ m, most preferably in the range from 0.7*10⁻⁹ m to 1.5*10⁻⁹ m, more preferably in the range from 0.75*10⁻⁹ m to 1.4*10⁻⁹ m, still more preferably in the range from 0.8*10⁻⁹ m to 1.3*10 m⁻⁹.

Furthermore, it has proven advantageous in the context of the present invention if the activated carbon provided and/or produced in method step (a) (i.e. starting activated carbon) has a mean pore diameter of at least 15 nm or if the activated carbon has a mean pore diameter of at most 100 nm.

In particular, the activated carbon provided and/or produced in method step (a) (i.e. starting activated carbon) may have an average pore diameter in the range of 15 nm to 100 nm, in particular in the range of 16 nm to 90 nm, preferably in the range of 17 nm to 85 nm, more preferably in the range of 18 nm to 80 nm, more preferably in the range of 20 nm to 70 nm, most preferably in the range of 22 nm to 60 nm, more preferably in the range of 25 nm to 50 nm.

The determination of the textural properties of the meso- and macroporous activated carbon used according to the invention or the determination of the textural properties in the meso- or macropore area can be carried out in particular with regard to the mean pore diameter by mercury intrusion. Depending on the method, an evaluation range in the range from 0.01 μm to 20 μm is recorded with regard to the pore diameter.

In general, the average pore diameter can also be determined from the quotient of four times the volume value of a liquid (adsorbate) absorbed or adsorbed by the activated carbon with completely filled pores (Vₜₒₜₐₗ) on the one hand and the BET surface area (BET) on the other (pore diameter d=4*Vₜₒₜₐₗ/BET). In this respect, reference can be made to the corresponding explanations according to R. W. Magee (loc. cit.), in particular to the formula representation (15) on page 71 of the literature reference in question.

Furthermore, it is advantageous according to the invention if the activated carbon prepared and/or produced in method step (a) (i.e. initial activated carbon) is spherical or if the activated carbon prepared and/or produced in method step (a) is used in the form of a spherical activated carbon.

In the context of its catalytic application based on the catalyst system according to the invention, the special shape of the activated carbon is also accompanied by better inflow properties, which further improves the transport of reactants and products.

As far as the spherical activated carbon is concerned, this is particularly associated with improved properties, for example, when the catalyst system according to the invention is used in fixed-bed reactors or the like.

According to the invention, the activated carbon provided and/or produced in method step (a) (i.e. initial activated carbon) may have a particle size, in particular a particle diameter, in the range from 60 μm to 1.000 μm, in particular in the range from 70 μm to 800 μm, preferably in the range from 80 μm to 600 μm, preferably in the range from 100 μm to 400 μm, particularly preferably in the range from 150 μm to 375 μm, most preferably in the range from 175 μm to 250 μm. In this context, at least 80% by weight, in particular at least 90% by weight, preferably at least 95% by weight, of the activated carbon particles, in particular activated carbon particles, may have particle sizes, in particular particle diameters, in the aforementioned ranges.

In general, the activated carbon provided or produced in method step (a) (i.e., initial activated carbon) may have a mean particle size (D50), in particular a mean particle diameter (D50), in the range of 60 μm to 900 μm, in particular in the range of 75 μm to 750 μm, preferably in the range of 85 μm to 550 μm, preferably in the range of 110 μm to 375 μm, more preferably in the range of 175 μm to 350 μm, most preferably in the range of 185 μm to 225 μm.

The corresponding particle sizes or diameters can be determined in particular on the basis of the method according to ASTM D2862-97/04. In addition, the above-mentioned sizes can be determined using determination methods based on sieve analysis, X-ray diffraction, laser diffractometry or the like. The respective determination methods are well known to the skilled person as such, so that no further explanations are required in this respect.

In addition, the activated carbon (i.e., starting activated carbon) provided and/or produced in method step (a) may have a ball pan hardness and/or abrasion hardness of at least 90%, in particular at least 95%, preferably at least 97%, more preferably at least 98%, most preferably at least 99%, most preferably at least 99.5%, further preferably at least 99.8%. The abrasion resistance can generally be determined according to ASTM D3802-05. Thus, the activated carbon used according to the invention is further characterized by excellent mechanical properties, which is also expressed in the high abrasion resistance.

The high mechanical strength of the activated carbon used according to the invention leads to low abrasion in the context of the application of the resulting catalyst system according to the invention, which is particularly advantageous with respect to the application or service life. The excellent mechanical properties with the low abrasion also result in further advantages with regard to the production of the catalyst system according to the method of the invention, in particular with regard to the avoidance of abrasion or the like when carrying out the respective method steps. The high mechanical strength of the activated carbon and thus also of the catalyst system according to the invention leads to only low abrasion in the context of use in catalysis, which is advantageous in particular with regard to the time of use as well as the avoidance of sludge formation due to abrasion or the like.

The high mechanical stability of the activated carbon used according to the invention is also reflected in a high compressive and/or bursting strength (weight load capacity per activated carbon grain). In this context, the activated carbon provided or produced in method step (a) (i.e., starting activated carbon) may have a compressive and/or bursting strength (weight loading capacity) per activated carbon grain, in particular per activated carbon bead, of at least 5 Newtons, in particular at least 10 Newtons, preferably at least 15 Newtons, preferably at least 20 Newtons, particularly preferably at least 22.5 Newtons. In particular, the activated carbon provided or produced in method step (a) (i.e., starting activated carbon) may have a compressive and/or bursting strength (weight loading capacity) per activated carbon grain, in particular per activated carbon pellet, in the range of 5 to 50 newtons, in particular 10 to 45 newtons, preferably 15 to 40 newtons, preferably 17.5 to 35 newtons. The determination of the compressive or bursting strength can be carried out in a manner known to the skilled person, in particular on the basis of the determination of the compressive or bursting strength on individual particles or particles via the application of force by means of a punch until the respective particle or particle bursts.

The activated carbon prepared or produced in method step (a) (i.e. starting activated carbon) may further have a vibrated or tamped density in the range of 100 g/l to 1,500 g/l, in particular 125 g/l to 1,000 g/l, preferably 150 g/l to 800 g/l, preferably 200 g/l to 600 g/l, particularly preferably 225 g/l to 500 g/l, most preferably 250 g/l to 400 g/l, further preferably 255 g/l to 395 g/l. In particular, the activated carbon prepared or produced in method step (a) (i.e. starting activated carbon) may also have a bulk density in the range of 150 g/l to 1,000 g/l, especially 250 g/l to 700 g/l, preferably 300 g/l to 600 g/l, more preferably 300 g/l to 550 g/l. The vibration or tamped density can be determined in particular according to DIN 53194. The bulk density can be determined in particular in accordance with ASTM B527-93/00.

In addition, the activated carbon provided or produced in method step (a) (i.e. starting activated carbon) may have a butane adsorption of at least 35%, in particular at least 40%, preferably at least 45%, preferably at least 47.5%, and/or wherein the activated carbon has a butane adsorption in the range of 35% to 90%, in particular in the range of 40% to 85%, preferably in the range of 45% to 80%, preferably in the range of 47.5% to 75%. The butane adsorption can be determined in particular in accordance with ASTM D5742-95/00.

Furthermore, the activated carbon prepared and/or produced in method step (a) (i.e. starting activated carbon) may have an iodine value of at least 1,250 mg/g, in particular at least 1,300 mg/g, preferably at least 1,400 mg/g, preferably at least 1.425 mg/g, and/or wherein the activated carbon prepared and/or produced in method step (a) has an iodine value in the range from 1,250 mg/g to 2,100 mg/g, in particular in the range from 1,300 mg/g to 2,000 mg/g, preferably in the range from 1,400 mg/g to 1,900 mg/g, preferably in the range from 1,425 mg/g to 1,850 mg/g. In particular, the iodine value may be determined in accordance with ASTM D4607-94/99. The iodine number can be evaluated as a measure of that available surface area which is also predominantly provided by small mesopores; the above-mentioned values of the iodine number show that the activated carbons used according to the invention can in particular have a high mesoporosity.

Furthermore, the activated carbon prepared and/or produced in method step (a) (i.e. starting activated carbon) has a methylene blue value of at least 17 ml, in particular at least 18 ml, preferably at least 19 ml, preferably at least 19.5 ml, and/or wherein the activated carbon prepared and/or produced in method step (a) has a methylene blue value in the range from 17 ml to 65 ml, in particular in the range from 18 ml to 55 ml, preferably in the range from 19 ml to 50 ml, preferably in the range from 19.5 ml to 47.5 ml.

In particular, the activated carbon prepared and/or produced in method step (a) (i.e. starting activated carbon) may have a molasses number of at least 255, in particular at least 310, preferably at least 375, preferably at least 510, and/or wherein the activated carbon prepared and/or produced in method step (a) has a molasses number in the range from 255 to 1,500, in particular in the range from 310 to 1,400, preferably in the range from 375 to 1,300, preferably in the range from 510 to 1,250.

Due to the high meso- and macroporosity, the activated carbon according to the invention thus exhibits equally high methylene blue and molasses adsorption numbers, which together can be evaluated as a measure of that available surface area which is predominantly provided by meso- and macropores. Thus, the methylene blue number or methylene blue adsorption, which refers to the amount of methylene blue adsorbed per defined amount of the adsorbents under defined conditions (i.e., the volume or the number of milliliters (ml) of a methylene blue standard solution decolorized by a defined amount of dry and powdered adsorbents), tends to be smaller mesopores and gives an indication of the adsorption capacity of the activated carbon of the invention with respect to molecules that have a comparable size to methylene blue. Furthermore, the molasses number is to be considered as a measure of meso- and macroporosity and denotes the amount of adsorbents required to decolorize a standard molasses solution, so that the molasses number gives an indication of the adsorption capacity of the activated carbon according to the invention with respect to molecules having a comparable size to molasses (generally sugar beet molasses). Together, the methylene blue and molasses numbers can thus be taken as a measure of the meso- and macroporosity, in particular mesoporosity, of the activated carbon according to the invention.

The dimensionless molasses number can basically be determined either according to the Norit method (Norit N.V., Amersfoort, The Netherlands, Norit standard method NSTM 2.19 “Molasses Number (Europe)”) or alternatively according to the PACS method (PACS=Professional Analytical and Consulting Services Inc., Coraopolis Pennsylvania, USA). In the context of the present invention, the values for the molasses number are determined according to the PACS method. In determining the molasses number by the Norit or PACS method, the amount of powdered activated carbon required to decolorize a standard molasses solution is determined. The determination is made photometrically, adjusting the standard molasses solution against a standardized activated carbon with a molasses number of 245 and/or 350. For further details in this regard, reference can be made to the two aforementioned regulations.

The methylene blue value can be determined according to the method according to CEFIC (Conseil Européen des Fédérations des l'Industrie Chimique, Avenue Louise 250, Bte 71, B—1050 Brussels, November 1986, European Council of Chemical Manufacturers' Federations, Test methods for Activated Carbon, section 2.4 “Methylene Blue Value”, pages 27/28).

The methylene blue value according to the aforementioned CEFIC method is thus defined as the number of ml of a methylene blue standard solution decolorized by 0.1 g of dry and powdered activated carbon. To perform this method, a glass vessel with a ground-glass stopper, a filter, and a methylene blue standard solution are required, which is prepared as follows: An amount of 1,200 mg of pure dye methylene blue (corresponding to approximately 1.5 g of methylene blue according to DAB VI [German Pharmacopoeia, 6th edition] or equivalent product) is dissolved in water in a 1,000 ml volumetric flask, and the solution is allowed to stand for several hours or overnight; for checking, 5.0 ml of the solution is made up to 1.0 l with 0.25% (volume fraction) acetic acid in a volumetric flask, and then the absorbance is measured at 620 nm and 1 cm path length, and it must be (0.840±0.010). If the absorbance is higher, dilute with the calculated amount of water; if it is lower, discard the solution and prepare it again. For sample production, the activated carbon is pulverized (<0.1 mm) and then dried at 150° C. to constant weight. Exactly 0.1 g of the spherical carbon is combined with 25 ml (5 ml) of the methylene blue standard solution in a ground glass flask (a pre-test is performed to determine whether an initial addition of 25 ml of methylene blue standard solution with 5 ml additions or an initial addition of 5 ml of methylene blue standard solution with 1 ml additions can be used). Shaking is performed until decolorization occurs. Then add another 5 ml (1 ml) of the methylene blue standard solution and shake until decolorization occurs. Repeat the addition of methylene blue standard solution in 5 ml (1 ml) volumes as long as decolorization still occurs within 5 minutes. The total volume of test solution decolorized by the sample is noted. Repeat the test to confirm the results obtained. The volume of methylene blue standard solution in ml just decolorized is the methylene blue value of the activated carbon. It should be noted in this context that the dye methylene blue must not be dried, as it is sensitive to heat; rather, the water content must be corrected purely by calculation.

According to the invention, the activated carbon prepared and/or produced in method step (a) (i.e. starting activated carbon) may further have a weight-related adsorbed N₂-volume Vads_{(wt)}, determined at a partial pressure p/p₀ of 0.25, of at least 250 cm³/g, in particular at least 300 cm³/g, preferably at least 350 cm³/g, preferably at least 375 cm³/g. In this context, the activated carbon provided and/or prepared in method step (a) may have a weight adsorbed N₂ volume Vads_{(wt)}, determined at a partial pressure p/p₀ of 0.25, in the range from 250 cm³/g to 850 cm³/g, in particular in the range from 300 cm³/g to 700 cm³/g, preferably in the range from 350 cm³/g to 650 cm³/g, preferably in the range from 375 cm³/g to 625 cm³/g.

In general, the activated carbon provided and/or produced in method step (a) (i.e., initial activated carbon) may have a volume-based adsorbed N2 volume Vads (vol.), determined at a partial pressure p/p0 of 0.25, of at least 50 cm³/cm³, in particular at least 100 cm³/cm³, preferably at least 110 cm³/cm³. In this respect, it may be provided in particular that the activated carbon provided or produced in method step (a) has a volume-related adsorbed N2 volume Vads (vol.), determined at a partial pressure p/p0 of 0.25, in the range from 50 cm³/cm³ to 300 cm³/cm³, in particular in the range from 80 cm³/cm³ to 275 cm³/cm³, preferably in the range from 90 cm³/cm³ to 250 cm³/cm³, preferably in the range from 95 cm³/cm³ to 225 cm³/cm³.

Similarly, it may be provided according to the invention that the activated carbon provided or produced in method step (a) (i.e., starting activated carbon) has a weight-based adsorbed N₂ volume Vads_{(wt.)}, determined at a partial pressure p/p₀ of 0.995, of at least 300 cm³/g, in particular at least 450 cm³/g, preferably at least 475 cm³/g. In particular, the activated carbon provided or produced in method step (a) may have a weight-based adsorbed N₂ volume Vads_{(wt.)}, determined at a partial pressure p/p₀ of 0.995, in the range from 300 cm³/g to 2,300 cm³/g, in particular in the range from 400 cm³/g to 2,200 cm³/g, preferably in the range from 450 cm³/g to 2,100 cm³/g, preferably in the range from 475 cm³/g to 2,100 cm³/g.

In addition, the activated carbon provided or produced in method step (a) (i.e. initial activated carbon) can have a volume-related adsorbed N₂ volume V_{ads(vol.)}, determined at a partial pressure p/p₀ of 0.995, of at least 200 cm³/cm³, in particular at least 250 cm³/cm³, preferably at least 275 cm³/cm³, preferably at least 295 cm³/cm³. According to the invention, it may also be provided that the activated carbon provided or produced in method step (a) has a volume-related adsorbed N₂ volume Vads_{(vol.)} determined at a partial pressure p/p₀ of 0.995, in the range from 200 cm³/cm³ to 500 cm³/cm³, in particular in the range from 250 cm³/cm³ to 400 cm³/cm³, preferably in the range from 275 cm³/cm³ to 380 cm³/cm³, preferably in the range from 295 cm³/cm³ to 375 cm³/cm³.

Consequently, the weight- and volume-related volume V_{ads} (N₂) of the activated carbon according to the invention is very large at different partial pressures p/p₀, which can equally be taken as evidence of the excellent adsorption properties, accompanied by the outstanding suitability as a catalyst support, of the activated carbon used according to the invention.

According to the invention, the activated carbon prepared or produced in method step (a) (i.e. starting activated carbon) may have a fractal dimension of open porosity in the range of 2.6 to 2.99, in particular 2.7 to 2.95, preferably 2.8 to 2.95, and/or wherein the activated carbon has a fractal dimension of open porosity of at least 2.7, in particular at least 2.8, preferably at least 2.85, preferably at least 2.9. The fractal dimension of the open porosity represents a measure of the micro-roughness of the inner surface of the activated carbon. For further details in this respect, in particular also for the determination of the fractal dimension of the activated carbons used according to the invention, reference can be made to the publications DE 102 54 241 A1, WO 2004/046033 A1, EP 1 562 855 B1 as well as to US 2006/148645 A1 belonging to the same patent family, in particular to the embodiment example 4 cited in the respective publications. The respective contents of the cited publications are hereby fully included by reference. The aforementioned fractal dimensions lead to further improved catalytic properties of the catalyst system produced by the method according to the invention.

According to the invention, the activated carbon provided and/or produced in method step (a) (i.e. starting activated carbon) may be an activated carbon obtainable by carbonization and subsequent activation of an organic polymer-based starting material, in particular in the form of a polymer-based, preferably spherical (spherical) activated carbon (PBSAC or Polymer-based Spherical Activated Carbon).

Activated carbon in the form of PBSAC is associated in particular with defined pore properties, a defined shape and high mechanical stability.

In particular, the starting material of the activated carbon provided and/or produced in method step (a) (i.e. starting activated carbon) may be used in the form of a granular and/or spherical, preferably spherical, starting material and/or wherein the starting material of the activated carbon provided and/or produced in method step (a) is used in granular and/or spherical, preferably spherical, form.

In addition, the starting material of the activated carbon provided or produced in method step (a) (i.e. starting activated carbon) may have a particle size, in particular a particle diameter, in the range from 60 μm to 1,000 μm, in particular in the range from 70 μm to 800 μm, preferably in the range from 80 μm to 600 μm, preferably in the range from 100 μm to 400 μm, particularly preferably in the range from 150 μm to 375 μm, most preferably in the range from 175 μm to 250 μm. In this context, it may be provided in accordance with the invention in particular that at least 80% by weight, in particular at least 90% by weight, preferably at least 95% by weight, of the particles of the starting material have particle sizes, in particular particle diameters, in the above-mentioned ranges.

In addition, the starting material of the activated carbon provided or produced in method step (a) (i.e., starting activated carbon) may have a mean particle size (D50), in particular a mean particle diameter (D50), in the range from 60 μm to 900 μm, in particular in the range from 75 μm to 750 μm, preferably in the range from 85 μm to 550 μm, preferably in the range from 110 μm to 375 μm, more preferably in the range from 175 μm to 350 μm, most preferably in the range from 185 μm to 225 μm.

In particular, the starting material of the activated carbon provided and/or produced in method step (a) (i.e., starting activated carbon) may be a starting material based on ion exchange resin precursors.

Furthermore, the starting material of the activated carbon provided and/or produced in method step (a) (i.e., starting activated carbon) may be a starting material based on organic polymers, in particular based on divinylbenzene-crosslinked polystyrene, preferably based on styrene/divinylbenzene copolymers. In this respect, the content of divinylbenzene in the starting material can be in the range from 0.1% by weight to 25% by weight, in particular in the range from 0.5% by weight to 20% by weight, preferably in the range from 1% by weight to 15% by weight, preferably in the range from 2% by weight to 10% by weight, based on the starting material. With regard to specific starting materials used, reference can be made to the further explanations on the embodiment examples.

According to the invention, it may be provided in particular that the activated carbon provided and/or produced in method step (a) (i.e. initial activated carbon) is obtainable by:
(i) Carbonization of a polymeric organic sulfonated starting material (containing sulfonic acid groups), in particular a particulate, preferably spherical, polymeric organic sulfonated starting material; then
(ii) activation of the carbonizate (carbonized starting material) obtained in step (i), in particular to obtain the activated carbon, in particular activated carbon as defined in any of the preceding claims.

In addition, it may be provided in this context that a method step of sulfonation of the polymeric organic starting material is carried out prior to the method step (i) of carbonization, in particular by bringing the starting material into contact with at least one sulfonating agent. In this context, the sulfonating agent may be used in liquid form.

In particular, sulfur trioxide (SO₃), especially in the form of oleum and/or preferably concentrated sulfuric acid, can be used as sulfonating agent. According to the invention, however, it is equally possible to start from a material that has already been sulfonated.

Generally, in the context of the present invention, in the aforementioned method step (i), carbonization can be carried out at temperatures in the range of 100° C. to 1,200° C., in particular in the range of 120° C. to 1,100° C., preferably in the range of 140° C. to 1,000° C., more preferably in the range of 150° C. to 950° C.

According to the invention, it may be provided in this context that in method step (i) the carbonization is carried out in multiple stages, in particular in two stages, preferably using a temperature gradient and/or a temperature profile. In this regard, in a first stage, the method can be carried out at temperatures in the range from 100° C. to 600° C., in particular in the range from 120° C. to 590° C., preferably in the range from 140° C. to 570° C., preferably at temperatures in the range from 150° C. to 550° C. In addition, in a second stage, the method can be carried out at temperatures in the range from 500° C. to 1,200° C., in particular in the range from 510° C. to 1,100° C., preferably in the range from 530° C. to 1,000° C., preferably at temperatures in the range from 550° C. to 950° C.

According to the invention, in method step (i), carbonization can be carried out for a period of time in the range from 0.1 h to 20 h, in particular in the range from 0.5 h to 15 h, preferably in the range from 1 h to 10 h, preferably in the range from 1.5 h to 8 h, particularly preferably in the range from 2 h to 6 h.

Within the scope of the method according to the invention, in method step (i) the carbonization can be carried out in particular in such a way that chemical groups, in particular strongly acidic chemical groups, preferably sulfonic acid groups, are thermally decomposed or split off from the in particular sulfonated starting material, in particular with the formation of free radicals or with the formation of crosslinkings, preferably in such a way that in particular an onset of the carbonization or a thermal decomposition of the starting material occurs, preferably with crosslinking of the polymers of the starting material and/or with the formation of carbon.

In addition, in method step (i), carbonization can be carried out in such a way that, in particular, after thermal decomposition or elimination of the chemical groups, in particular the strongly acidic chemical groups, preferably the sulfonic acid groups, more extensive or, in particular, complete carbonization of the starting material takes place.

For example, method step (i) can be carried out in such a way that the thermal decomposition or the elimination of the chemical groups, in particular the strongly acidic chemical groups, preferably the sulfonic acid groups, takes place in the first stage of carbonization. In addition, method step (i) can be carried out in such a way that the further and/or complete carbonization of the starting material is carried out in the second stage.

In general, method step (i) can be carried out in an inert atmosphere, in particular a nitrogen atmosphere, or at most in a slightly oxidizing atmosphere. According to the invention, it may optionally be provided that in method step (i) water, in particular in the form of water vapor and/or an inert gas/water vapor mixture, preferably nitrogen/water vapor mixture, is added to the carbonization atmosphere, in particular inert atmosphere, during carbonization.

Furthermore, as regards method step (ii), the activation can be carried out at temperatures in the range from 500 to 1,200° C., in particular in the range from 800° C. to 1,100° C., preferably in the range from 850°C. to 1,000° C., preferably in the range from 900 to 975° C. Moreover, in method step (ii), the activation can be carried out for a period of time in the range from 0.5 h to 20 h, in particular in the range from 1 h to 15 h, preferably in the range from 2 h to 10 h.

In general, in method step (ii), the activation can be carried out in the presence of at least one activation gas, in particular oxygen, preferably in the form of air, water vapor and/or carbon dioxide or mixtures of these activation gases, and/or in the presence of an inert gas/water vapor mixture, preferably a nitrogen/water vapor mixture, and/or in the presence of, in particular, pure carbon dioxide or an inert gas/carbon dioxide mixture, in particular a nitrogen/carbon dioxide mixture.

The basic principle of the activation provided in method step (ii) according to the invention consists in particular in selectively and specifically decomposing or burning off part of the carbon generated during carbonization under suitable conditions, whereby the pore system can be further formed or specifically adjusted and, so to speak, finalized.

As far as the activated carbon provided or produced in method step (a) is concerned in general, it is in principle also commercially available in the specificities indicated herein, in particular also from Blücher GmbH. In addition, for further details on the activated carbon provided or produced according to the invention in method step (a), and in particular also with regard to the method steps of carbonization and activation, reference can be made to the international patent application WO 98/07655 A1 as well as to the patent applications DE 196 53 238 A1, DE 196 50 414 A1, EP 0 952 960 A1 and U.S. Pat. No. 6,300,276 B1 belonging to the same patent family, the respective disclosure of which is hereby fully incorporated by reference. In addition, reference may be made to DE 43 04 026 A1 and to U.S. Pat. No. 6,184,177 B1 belonging to the same patent family, the respective disclosure of which is hereby also fully incorporated by reference. In addition, reference can also be made to the international patent application WO 2017/097447 A1 as well as to the parallel patent applications DE 10 2016 101 215 A1, EP 3 362 407 A1 as well as US 2019/177170 A1, the respective disclosure of each of which is hereby equally fully incorporated by reference.

In the following, method step (b) with the oxidation of the activated carbon is described in more detail:

In general, it can be provided in the context of the present invention that the activated carbon oxidized in method step (b), in particular surface oxidized, has an oxygen content, in particular surface oxygen content, in particular determined by means of X-ray photoelectron spectroscopy [XPS(=X-Ray Photoelectron Spectroscopy) resp. ESCA (=Electron Spectroscopy for Chemical Analysis)], in the range from 4% (atomic %) to 20%, in particular in the range from 5% to 20%, preferably in the range from 5.5% to 18%, preferably in the range from 6% to 15%, particularly preferably in the range from 7% to 12.5%, based on the total elemental composition of the oxidized activated carbon.

According to the invention, it can be provided in particular that the activated carbon oxidized in method step (b), in particular surface-oxidized, has an oxygen content, in particular surface oxygen content, in particular determined by means of X-ray photoelectron spectroscopy (XPS or ESCA), of at least 5% (atomic %), preferably at least 5.5%, preferably at least 6%, particularly preferably at least 7%, based on the total elemental composition of the oxidized activated carbon.

According to the invention, it can be provided in particular that the activated carbon oxidized in method step (b), in particular surface-oxidized, has an oxygen content, in particular surface oxygen content, in particular determined by means of X-ray photoelectron spectroscopy (XPS or ESCA), of at most 20% (atomic %), preferably at most 18%, preferably at most 15%, particularly preferably at most 12.5%, based on the total elemental composition of the oxidized activated carbon.

In this context, it is preferred according to the invention if the elements other than oxygen of the activated carbon oxidized in method step (b), in particular surface-oxidized, are formed at least essentially by carbon. In this context, the activated carbon oxidized in method step (b), in particular surface-oxidized, may have at most traces of oxygen and elements other than carbon, in particular nitrogen, sulfur and/or chlorine, preferably in an amount of at most 2% (atomic %), in particular at most 1.5%, preferably at most 1%, based on the total elemental composition of the oxidized activated carbon and calculated as the sum of the elements other than oxygen and carbon.

Without wishing to be limited to this theory, the method according to the invention results in an oxidized layer, in particular on the (pore) surface of the activated carbon, which generally has the oxygen-containing functional groups mentioned below. The subsequent finishing of the surface oxidation with the catalytically active component then takes place-likewise without wishing to limit or commit oneself to this theory—in particular in the region of the oxidized (boundary) layer, whereby the oxygen-containing functional group increases the affinity and in particular also the interaction with the catalytically active component, or in a manner of speaking acts as binding or anchoring points for the catalytically active component used according to the invention.

The method according to the invention thus provides the catalyst system according to the invention as such with catalytic or reactive surfaces by equipping the activated carbon with the catalytically active component following the oxidation.

With regard to the previously stated range for the oxygen content of the activated carbon oxidized in method step (b), the stated lower limit ensures that there are still sufficient binding sites for the catalytically active component or its precursor. The upper limit also ensures that the carbon content in the oxidized activated carbon is still sufficiently high to form a stable framework, accompanied by corresponding mechanical stability and the presence of a pore system that continues to be defined, in particular also with regard to the corresponding total pore volume according to Gurvich and the specific BET surface area.

As previously indicated, as a result of the target and purpose-oriented oxidation treatment in method step (b), a relatively hydrophilic activated carbon is obtained, so that on this basis the finishing with the catalytically active component or its precursor is improved.

Against this background, the following can be stated about the hydrophilicity of activated carbon:
In particular, the activated carbon oxidized in method step (b), in particular surface-oxidized, can have a hydrophilicity, determined as water vapor adsorption behavior, such that at a partial pressure p/p₀ of 0.6 at least 35%, in particular at least 40%, preferably at least 50%, preferably at least 60%, of the maximum water vapor saturation loading of the activated carbon is achieved.
In addition, the activated carbon oxidized in method step (b), in particular surface-oxidized, can have a hydrophilicity, determined as water vapor adsorption behavior, such that at a partial pressure p/p₀ of 0.6 at most 100%, in particular at most 99%, preferably at most 98%, preferably at most 95%, particularly preferably at most 90%, of the maximum water vapor saturation loading of the activated carbon is achieved.
Furthermore, the activated carbon oxidized in method step (b), in particular surface-oxidized, can have a hydrophilicity, determined as water vapor adsorption behavior, such that at a partial pressure p/p₀ of 0.6 30% to 100%, in particular 35% to 99%, preferably 40% to 98%, preferably 50% to 95%, particularly preferably 60% to 90%, of the maximum water vapor saturation loading of the activated carbon is achieved.
In particular, the activated carbon oxidized in method step (b), in particular surface-oxidized, can have a hydrophilicity, determined as water vapor adsorption behavior, such that in a partial pressure range p/p₀ of 0.1 to 0.6 at least 30%, in particular at least 35%, preferably at least 40%, preferably at least 50%, particularly preferably at least 60%, of the maximum water vapor saturation loading of the activated carbon is achieved.
According to the invention, the activated carbon oxidized in method step (b), in particular surface-oxidized, can have a hydrophilicity, determined as water vapor adsorption behavior, such that in a partial pressure range p/p₀ of 0.1 to 0.6 at most 100%, in particular at most 99%, preferably at most 98%, preferably at most 95%, particularly preferably at most 90%, of the maximum water vapor saturation loading of the activated carbon is achieved.
Furthermore, the activated carbon oxidized in method step (b), in particular surface-oxidized, can have a hydrophilicity, determined as water vapor adsorption behavior, such that in a partial pressure range p/p₀ of 0.1 to 0.6 30% to 100%, in particular 35% to 99%, preferably 40% to 98%, preferably 50% to 95%, particularly preferably 60% to 90%, of the maximum water vapor saturation loading of the activated carbon is achieved.

In addition to the hydrophilicity of the activated carbon oxidized in method step (b), the following can be mentioned:
Thus, with respect to the activated carbon oxidized in method step (b), it can behave within the scope of the present invention in such a way that in method step (b) the oxidation, in particular surface oxidation, of the activated carbon prepared or produced in method step (a) takes place with the proviso that the oxidized activated carbon has a hydrophilicity, determined as water vapor adsorption behavior, in such a way that at a partial pressure p is carried out with the proviso that the oxidized, in particular surface-oxidized, activated carbon has a hydrophilicity, determined as water vapor adsorption behavior, such that at a partial pressure p/p₀ of 0.6 at least 30% of the maximum water vapor adsorption capacity of the activated carbon is exhausted or utilized.
In particular, the activated carbon oxidized in method step (b), in particular surface-oxidized, can have a hydrophilicity, determined as water vapor adsorption behavior, such that at a partial pressure p/p₀ of 0.6 at least 30%, in particular at least 35%, preferably at least 40%, preferably at least 50%, particularly preferably at least 60%, of the maximum water vapor adsorption capacity of the activated carbon is exhausted and/or utilized.

In addition, the activated carbon oxidized in method step (b), in particular surface-oxidized, may have a hydrophilicity, determined as water vapor adsorption behavior, such that at a partial pressure p/p₀ of 0.6 at most 100%, in particular at most 99%, preferably at most 98%, preferably at most 95%, particularly preferably at most 90%, of the maximum water vapor adsorption capacity of the activated carbon is exhausted and/or utilized.

Similarly, the activated carbon oxidized in method step (b), in particular surface oxidized, may have a hydrophilicity, determined as water vapor adsorption behavior, such that at a partial pressure p/p₀ of 0.6 30% to 100%, in particular 35% to 99%, preferably 40% to 98%, preferably 50% to 95%, particularly preferably 60% to 90%, of the maximum water vapor adsorption capacity of the activated carbon is exhausted and/or utilized.
In addition, the activated carbon oxidized in method step (b), in particular surface-oxidized, can have a hydrophilicity, determined as water vapor adsorption behavior, such that in a partial pressure range p/p₀ of 0.1 to 0.6 at least 30%, in particular at least 35%, preferably at least 40%, preferably at least 50%, particularly preferably at least 60%, of the maximum water vapor adsorption capacity of the activated carbon is exhausted and/or utilized.
In particular, it can be provided according to the invention that the activated carbon oxidized in method step (b), in particular surface-oxidized, has a hydrophilicity, determined as water vapor adsorption behavior, such that in a partial pressure range p/p₀ of 0.1 to 0.6 at most 100%, in particular at most 99%, preferably at most 98%, preferably at most 95%, particularly preferably at most 90%, of the maximum water vapor adsorption capacity of the activated carbon is exhausted and/or utilized.
According to the invention, the activated carbon oxidized in method step (b), in particular surface-oxidized, can have a hydrophilicity, determined as water vapor adsorption behavior, such that in a partial pressure range p/p₀ of 0.1 to 0.6 30% to 100%, in particular 35% to 99%, preferably 40% to 98%, preferably 50% to 95%, particularly preferably 60% to 90%, of the maximum water vapor adsorption capacity of the activated carbon is exhausted and/or utilized.

In addition, the activated carbon oxidized in method step (b) may also have the following properties with respect to hydrophilicity:
Furthermore, the activated carbon oxidized in method step (b), in particular surface-oxidized, can have a hydrophilicity, determined as water vapor adsorption behavior, such that at a partial pressure p/p₀ of 0.6, the amount of water vapor adsorbed by the activated carbon (H₂O volume) Vads_{(H2O)}, based on the weight of the activated carbon, is at least 200 cm³/g, in particular at least 250 cm³/g, preferably at least 300 cm³/g, preferably at least 325 cm³/g, particularly preferably at least 350 cm³/g.
In addition, the activated carbon oxidized in method step (b), in particular surface-oxidized, can have a hydrophilicity, determined as water vapor adsorption behavior, such that in a partial pressure p/p₀ of 0.6 the amount of water vapor adsorbed by the activated carbon (H₂O volume) V_{ads(H2O)}, based on the weight of the activated carbon, is at most 1,000 cm³/g, in particular at most 900 cm³/g, preferably at most 800 cm³/g, preferably at most 700 cm³/g, particularly preferably at most 600 cm³/g.
According to the invention, it can be provided in particular that the activated carbon oxidized in method step (b), in particular surface-oxidized, has a hydrophilicity, determined as water vapor adsorption behavior, such that in a partial pressure p/p₀ of 0.6 the amount of water vapor adsorbed by the activated carbon (H₂O volume) Vads_{(H2O)}, based on the weight of the activated carbon, is in the range from 200 cm³/g to 1.000 cm³/g, in particular 250 cm³/g to 900 cm³/g, preferably 300 cm³/g to 800 cm³/g, preferably 325 cm³/g to 700 cm³/g, particularly preferably 350 cm³/g to 600 cm³/g.

The above values of the water vapor adsorption behavior refer in particular to the underlying water vapor adsorption isotherm of the activated carbon obtained according to the invention in method step (b).

As far as the determination of the water vapor adsorption behavior is concerned, this is carried out within the scope of the present invention on the basis of DIN 66135-1, with water or water vapor being used as the underlying adsorptive or adsorbate. In this context, the determination of the water vapor adsorption behavior is performed statically-volumetrically at a temperature of 25° C. (298 Kelvin). The determination of the pressure-dependent volume of adsorbed water or adsorbed water vapor V_{ads} (STP) underlying the water vapor adsorption behavior is carried out at different or variable ambient pressures p/p₀ in the range from 0.0 to 1.0, where p₀ represents the pressure under standard conditions (1,013.25 hPa). The water vapor adsorption behavior used according to the invention relates to the adsorption isotherm of the underlying activated carbon.

For further information and explanations on water vapor adsorption, reference can also be made to the doctoral thesis by M. Neitsch, “Water Vapor and n-Butane Adsorption on Activated Carbon—Mechanism, Equilibrium and Dynamics of 1-Component and Coadsorption”, Faculty of Mechanical, method and Energy Engineering, Freiberg University of Mining and Technology, whose entire content in this regard, especially with regard to the explanations on the adsorption of water vapor or water on activated carbons, is hereby fully included by reference.

The water vapor adsorption behavior, as specified above, functions as a measure of the hydrophilicity or hydrophobicity of the activated carbon used in accordance with the invention, to the effect that, on the basis of the values specified above, an activated carbon is obtained in method step (b) and used in the subsequent method steps which is polar or hydrophilic overall (i.e., in comparison with the starting activated carbon used) and which can thus be described as hydrophilic overall according to common usage.

According to the invention, moreover, the oxidation, in particular surface oxidation, of the activated carbon in method step (b) can be carried out in such a way that the oxidized, in particular surface-oxidized, activated carbon thus obtained has a content of oxygen-containing groups, calculated and/or expressed as a content of volatile components (“fB”) and based on the dry weight of the oxidized activated carbon, of at least 1 wt. %, in particular at least 2 wt. %, preferably at least 3 wt. %, preferably at least 4 wt. % and/or in the range of 1 wt. % to 30 wt. %, in particular 1.5 wt. % to 25 wt. %, preferably 2 wt. % to 20 wt. %, preferably 3 wt. % to 15 wt. %. In this context, the content of oxygen-containing functional groups can be adjusted by temperature and/or time duration and/or type and/or concentration of oxidizing agent.

In this context, the method according to the invention can thus also be used to tailor the oxidation of the activated carbon, also with a view to optimizing the subsequent finishing with the catalytically active component.

Within the scope of the method according to the invention, it is possible to proceed in such a way that the oxygen content of the activated carbon oxidized on its surface is significantly increased compared to the starting activated carbon used-which generally has an oxygen content of less than 1% by weight, expressed as the content of volatile components (“fB”) and based on the dry weight of the starting activated carbon. The stated oxygen content refers in particular to the activated carbon oxidized in method step (b) before carrying out the subsequently provided reduction according to method step (d). The volatile content (“fB”) thereby generally functions as a measure of the oxidation and thus refers in particular to the surface oxides formed by the oxidation. In particular, the volatile content can be determined based on ISO 562:1981. In particular, the content of volatile components (“fB”) can be determined on a previously dried activated carbon that has been oxidized on its surface when heated appropriately to 900° C. for a period of 7 minutes under inert conditions.

By the purpose-directed formation and adjustment of the content of oxygen-containing functional groups, the uptake quantity of the catalytically active component used subsequently, in particular in method step (c), or of the relevant precursor can be predetermined or influenced. In this context, the person skilled in the art is able at any time to select the relevant properties and to match them to each other in such a way that the desired loading with the catalytically active component results in the sense of the present invention.

In general, oxidation can be carried out in a gas atmosphere or wet-chemically (especially when acids are used).

According to the invention, in method step (b) the oxidation, in particular surface oxidation, of the activated carbon can be carried out using at least one oxidizing agent. The oxidizing agent can be selected from the group of oxygen, ozone, inorganic or organic oxides and peroxides, in particular hydrogen peroxide, inorganic or organic acids and peracids, in particular mineral acids, and combinations thereof.

In particular, the oxidizing agent is selected from the group of oxygen, hydrogen peroxide (H₂O₂), nitrogen oxides (preferably NO and/or NO₂), hydrochloric acid (HCl), nitric acid (HNO₃), sulfuric acid (H₂ SO₄), perchloric acid (HClO₄), phosphoric acid (H₃ PO₄), and combinations thereof.

Further preferably the oxidizing agent is selected from the group of oxygen (O₂), hydrochloric acid (HCl), nitric acid (HNO₃), sulfuric acid (H₂ SO₄), perchloric acid (HClO₄), phosphoric acid (H₃ PO₄), hydrogen peroxide (H₂O₂) and combinations thereof, particularly preferably from the group consisting of oxygen (O₂), hydrochloric acid (HCl) and nitric acid (HNO₃) and combinations thereof, very particularly preferably from the group consisting of oxygen (O₂) and nitric acid (HNO₃) and combinations thereof.

With regard to the use of oxygen, it is possible to resort in particular to atmospheric oxygen or synthetic air.

Generally, in the context of the present invention, in method step (b) the oxidation, in particular surface oxidation, of the activated carbon can be carried out with heating, in particular wherein the surface oxidation can be carried out at such temperatures that a reaction of the oxidizing agent with the activated carbon takes place with the formation of oxygen-containing functional groups on the surface of the activated carbon. The oxidation, in particular surface oxidation, of the activated carbon can thereby be carried out at a temperature in the range from −20° C. to 1,000° C., in particular in the range from 0° C. to 800° C., preferably in the range from 5° C. to 700° C., preferably in the range from 10° C. to 600° C., particularly preferably in the range from 20° C. to 550° C. In this context, the oxidation, in particular surface oxidation, of the activated carbon can also be carried out for a period of up to 48 h, in particular up to 24 h, preferably up to 12 h. According to the invention, the oxidation, in particular surface oxidation, of the activated carbon can be carried out, for example, for a period of time in the range from 1 minute to 1,000 minutes, in particular in the range from 5 minutes to 800 minutes, preferably in the range from 10 minutes to 600 minutes.

According to the invention, the oxidation, in particular surface oxidation, of the activated carbon can be carried out with the formation of a hydrophilic surface of the activated carbon. In this regard, the oxidation, in particular surface oxidation, of the activated carbon can be carried out with the formation of oxygen-containing functional groups on the surface of the activated carbon. Moreover, the oxidation, in particular surface oxidation, of the activated carbon may result in the formation of oxygen-containing functional groups, in particular on the surface of the activated carbon. In this regard, the oxygen-containing functional groups may be selected from acidic and basic oxygen-containing functional groups and combinations thereof, in particular acidic and basic surface oxides. In particular, the oxygen-containing functional groups may be selected from hydroxyl, carboxyl, carbonyl, anhydride, lactone, quinone, pyrone, chromene and ether groups as well as combinations thereof, in particular from the group of hydroxyl, carboxyl, carbonyl and ether groups as well as combinations thereof.

According to a first embodiment of the present invention, in method step (b) the oxidation, in particular surface oxidation, of the activated carbon can be carried out using an oxidizing agent in the form of oxygen (O₂). Thus, in method step (b), the oxidation, in particular surface oxidation, can be carried out using oxygen (O₂) as oxidant. In this context, the oxidation, in particular surface oxidation, of the activated carbon can be carried out at a temperature in the range from 100° C. to 1,000° C., in particular in the range from 200° C. to 800° C., preferably in the range from 300° C. to 700° C., preferably in the range from 350° C. to 600° C., particularly preferably in the range from 400° C. to 550° C. In particular, the oxidation, in particular surface oxidation, of the activated carbon can be carried out for a period of up to 10 h, in particular up to 8 h, preferably up to 6 h, wherein the oxidation, in particular surface oxidation, of the activated carbon is carried out for a period of time in the range from 30 minutes to 1,000 minutes, in particular in the range from 60 minutes to 800 minutes, preferably in the range from 100 minutes to 600 minutes. In this respect, it is possible to proceed in particular within the framework of an air oxidation or oxidation in a gas atmosphere.

In contrast, according to a further embodiment of the invention, the oxidation, in particular surface oxidation, of the activated carbon can also be carried out in method step (b) using an oxidizing agent, the oxidizing agent being a mineral acid, such as nitric acid (HNO₃), for example. In this respect, in particular, a wet chemical method may be used. In this context, it can thus be provided according to the invention that in method step (b) the oxidation, in particular surface oxidation, is carried out using a mineral acid, in particular nitric acid (HNO₃), as oxidizing agent. In this regard, the oxidation, in particular surface oxidation, of the activated carbon can be carried out at a temperature in the range from −20° C. to 250° C., in particular in the range from 0° C. to 200° C., preferably in the range from 5° C. to 175° C., preferably in the range from 10° C. to 150° C., particularly preferably in the range from 15° C. to 125° C. Moreover, the oxidation, in particular surface oxidation, of the activated carbon can be carried out for a period of up to 6 h, in particular up to 5 h, preferably up to 4 h. Similarly, the oxidation, in particular surface oxidation, of the activated carbon can be carried out for a period of time in the range from 5 minutes to 500 minutes, in particular in the range from 10 minutes to 400 minutes, preferably in the range from 20 minutes to 300 minutes.

According to this embodiment of the present invention, the mineral acid, in particular nitric acid (HNO₃), may be a 10% (vol %) to 75%, in particular 15% to 60%, preferably 20% to 55%, preferably about 25%, more preferably about 50%.

In addition, it can be provided according to the invention that in method step (b), following the oxidation, in particular surface oxidation, and in particular before method step (c), purification and/or drying of the oxidized activated carbon takes place. In this case, the purification can be carried out by means of at least one washing method in a liquid, in particular water. In addition, the drying can be carried out with heating of the oxidized, in particular surface oxidized, activated carbon, in particular to temperatures in the range from 40° C. to 200° C., in particular 50° C. to 150° C., preferably 60° C. to 120° C. In particular, the drying can be carried out under reduced (air) pressure and/or in a vacuum and/or in particular wherein the drying is carried out at an (air) pressure in the range of 0.01 Pa to 100 Pa, in particular 0.1 Pa to 10 Pa.

In the following, method step (c) with the equipment of the previously oxidized activated carbon with the catalytically active component or with the relevant precursor is described in more detail: In general, in method step (c), the equipment of the activated carbon oxidized in method step (b), in particular surface-oxidized, or of the catalyst support can be carried out by applying and/or bringing into contact, preferably fixing, the catalytically active component on the catalyst support.

In general, the catalytically active component may comprise or consist of at least one metal, in particular in the form of a metal compound, preferably in the form of an ionic metal compound, and/or in particular in elemental form.

In general, the catalytically active component may comprise at least one metal in a positive oxidation state, in particular at least one metal cation, in particular wherein the oxidation state of the metal is in the range of +I to +VII, in particular in the range of +I to +IV, preferably in the range of +I to +III, and particularly preferably is +I or +II, and/or wherein the catalytically active component comprises at least one metal with the oxidation state zero. With respect to simple ions, the oxidation number corresponds to the charge number, whereas in the case of polynuclear ions, in particular so-called clusters, the oxidation number may deviate from the charge number, which is well known as such to the skilled person.

In particular, the catalytically active component may comprise at least one metal selected from main or subgroups of the periodic table of the elements or at least one lanthanide. In particular, the catalytically active component may comprise at least one metal selected from elements of main group IV or subgroups I, II, III, IV, V, VI, VII and VIII of the periodic table of the elements, in particular from elements of main group IV or subgroups I and II of the periodic table of the elements. According to the invention, it may be provided that the catalytically active component comprises at least one metal selected from the group consisting of Cu, Ag, Au, Zn, Hg, Sn, Ce, Ti, Zr, V, Nb, Cr, Mo, W, Mn, Fe, Bi, Ru, Os, Co, Rh, Re, Ir, Ni, Pd and Pt, in particular Fe, Bi, V, Cu, Pb, Zn, Ag, Sn, Pd, Pt, Ru and Ni, preferably Fe, Bi, V, Cu, Pt, Ru and Pb, preferably Pd, Pt and Ru, particularly preferably Pd and Pt. The catalytically active component can be used in method step (c), in particular in the form of a precursor (precursor).

In particular, it can be provided according to the invention that the precursor of the catalytically active component is formed or constituted in such a way that the precursor is converted into the catalytically active component by the reduction carried out in method step (d). In particular, the precursor of the catalytically active component may be an oxidized form of the catalytically active component or may be formed therefrom.

In general, the precursor of the catalytically active component may comprise at least one metal compound, preferably based on at least one previously defined metal, which is soluble and/or dissociable, in particular in an aqueous and/or in particular aqueous-based solvent and/or dispersant.

In addition, the precursor of the catalytically active component may comprise at least one inorganic or organic metal compound, preferably based on at least one previously defined metal, in particular a metal salt or metal oxide, preferably a metal salt.

In particular, the precursor of the catalytically active component may comprise at least one organic or inorganic metal salt, preferably based on at least one previously defined metal, the salt being selected from the group consisting of halide salts, hydroxides, amines, sulfates, sulfides, sulfites, nitrates, nitrites, phosphates, phosphides, phosphites, carbamates, alkoxides and carboxylic acid salts, in particular halide salts, nitrates, hydroxides and carboxylic acid salts.

Moreover, the precursor of the catalytically active component may comprise at least one metal halide, preferably based on at least one previously defined metal, in particular a fluoride, chloride, bromide or iodide, preferably chloride, and/or at least one carboxylic acid salt of a metal, preferably based on at least one previously defined metal, in particular acetate.

Generally, the precursor of the catalytically active component may comprise at least one metal compound selected from the group consisting of palladium chloride, palladium nitrate, hexachloroplatinic acid, platinum nitrate, tetraaminoplatinum dihydroxide, ruthenium chloride, copper chloride, iron chloride, vanadium chloride and lead chloride, in particular palladium chloride, palladium nitrate, hexachloroplatinic acid, platinum nitrate and tetraaminoplatinum dihydroxide.

In particular, the precursor may comprise or consist of palladium chloride, palladium nitrate, hexachloroplatinic acid, platinum nitrate, and/or tetraamine platinum dihydroxide.

According to the invention, H₂PdCl₄ and/or Pd(NO₃)₂ can be used in a preferred manner as precursor (palladium precursor). According to the invention, H₂(PtCl₆), (NH₃)₄Pt(OH)₂ and/or Pt(NO₃)₂ can equally preferably be used as precursor (platinum precursor).

In particular, the precursor of the catalytically active component can be used in the form of a particularly aqueous and/or particularly aqueous-based solution and/or in dispersion form (dispersion), in particular for purposes of finishing and/or loading and/or coating and/or impregnating the oxidized, in particular surface-oxidized, activated carbon.

In this context, the solution or dispersion form (dispersion) may comprise water as solvent or dispersant. In addition, the solution or dispersion form (dispersion) may comprise at least one organic or inorganic acid or base, preferably hydrochloric acid.

In addition, the precursor of the catalytically active component may be present in the solution or dispersion form (dispersion) at least substantially free of crystals and/or crystallite. In particular, the precursor of the catalytically active component in the solution or dispersion form (dispersion) may be at least substantially dissolved, in particular at least substantially dissociated.

In general, the solution and/or dispersion form (dispersion) may contain the precursor of the catalytically active component in amounts ranging from 0.01 wt % to 80 wt %, in particular from 0.1 wt % to 60 wt %, preferably from 1 wt % to 50 wt %, preferably from 2 wt % to 40 wt %, based on the solution and/or dispersion form (dispersion) and calculated as metal.

The term “solution” or “dispersion form (dispersion)”, as used in this context in the context of the present invention, is to be understood in particular in such a way that, at the underlying amounts or concentrations, the precursor of the catalytically active component is present at least substantially completely dissolved or dissociated or dispersed in the underlying solvent or dispersant. For example, within the scope of the present invention, for purposes of equipping or loading the activated carbon with the catalytically active component, it may be provided that the activated carbon used according to the invention is immersed or soaked with or in a corresponding solution or dispersion (of the precursor) of the catalytically active component. In this way, according to the invention, it is ensured in particular that the underlying solution or dispersion form (dispersion) at least substantially fills the entire pore system of the activated carbon, which leads to a homogeneous loading of the activated carbon with the catalytically active component.

In general, according to the invention, in method step (c) the equipment of the oxidized, in particular surface-oxidized, activated carbon with the catalytically active component, in particular with the precursor of the catalytically active component, can comprise an application and/or bringing into contact, preferably a fixing, of the oxidized, in particular surface-oxidized, activated carbon with the catalytically active component, in particular with the precursor of the catalytically active component. In particular, the application and/or bringing into contact, preferably the fixing, can be carried out by dipping and/or impregnating and/or wetting and/or covering and/or coating and/or spraying the oxidized, in particular surface-oxidized, activated carbon into and/or with the catalytically active component, in particular into and/or with the precursor of the catalytically active component. The application and/or bringing into contact can thereby be carried out with energy input, in particular by means of vibration and/or by means of ultrasonic input. In this context, the catalytically active component, in particular the precursor of the catalytically active component, can be used in the form of a solution and/or dispersion form (dispersion), as previously indicated.

In addition, in particular following application and/or contacting and/or in particular for the purpose of equipping the oxidized, in particular surface-oxidized, activated carbon with the catalytically active component, in particular with the precursor of the catalytically active component, it may be provided that excess amounts of catalytically active component, in particular excess amounts of the precursor of the catalytically active component, preferably excess amounts of solution and/or dispersion form (dispersion) of the catalytically active component, preferably excess amounts of solution and/or dispersion form (dispersion) of the precursor of the catalytically active component, are removed and/or removed from the activated carbon or the catalyst system. removed and/or separated from the catalyst system.

In this context, in particular following the application or bringing into contact and/or in particular for the purpose of finishing the oxidized, in particular surface-oxidized, activated carbon with the catalytically active component, in particular with the precursor of the catalytically active component, purification and/or drying of the activated carbon obtained can take place. In this regard, the purification and/or drying may be performed by means of at least one washing step in a liquid, in particular water. Moreover, the purification and/or drying can be carried out by heating the activated carbon equipped with the catalytic component, in particular to temperatures in the range from 40° C. to 200° C., in particular 50° C. to 150° C., preferably 60° C. to 120° C. Moreover, the purification and/or drying can be carried out under reduced (air) pressure and/or in a vacuum. Moreover, the purification and/or drying can be carried out at an (air) pressure in the range of 100 Pa to 0.01 Pa, in particular 10 Pa to 0.1 Pa. The removal of solvent or dispersant or the drying of the activated carbon leads in particular to the formation of a dried or particulate form of the precursor of the catalytically active component, which is then present in particular in crystalline form on or on the surfaces of the activated carbon used as catalyst support.

In general, it is provided in the method according to the invention that in method step (c) both the outer and the inner surfaces, in particular the micropores, mesopores and/or macropores, of the oxidized, in particular surface-oxidized, activated carbon are equipped with the catalytically active component, in particular loaded and/or coated and/or impregnated, and in particular in the form of the corresponding precursor. In this way, a high loading quantity of the catalytically active component can be realized.

In the following, method step (d) is described in more detail with the reduction of the oxidized, in particular surface-oxidized, activated carbon obtained in method step (c) and equipped with the catalytically active component, in particular with the precursor of the catalytically active component: As far as the reduction of the oxidized, in particular surface-oxidized, activated carbon obtained in method step (c) and equipped with the catalytically active component, in particular with the precursor of the catalytically active component, carried out according to the invention in method step (d) is concerned, this leads—without wishing to be limited to this theory—on the one hand in particular to an at least partial reduction of the catalytically active component incorporated or applied in the activated carbon or of the precursor relating thereto. In particular, the catalytically active component or the relevant precursor or the underlying metal compound or the underlying metal can be reduced in this way, in particular if the catalytically active component or the relevant precursor is present in oxidized form or in the form of salts, ions or the like. The reduction treatment can thus generally also be carried out against the background of a catalyst activation and/or conversion of the catalyst or the catalytically active component or the precursor relating thereto into an active form, in particular by changing and/or reducing the oxidation number of the metal of the catalytically active component. The reduction treatment can thus be carried out, in particular, against the background of the activation of the catalytically active component or the precursor relating thereto.

The reduction treatment according to method step (d) can be carried out in particular with regard to a metal, in particular a noble metal, of the catalytically active component or of the relevant precursor which, for example, is not used in the zero oxidation state or is not present in the form of a compound, in particular in the form of a salt, when the activated carbon is equipped with the catalytically active component or the relevant precursor in method step (c), in such a way that a corresponding conversion of the metal or noble metal into the elemental form or into the zero oxidation state takes place. in the form of a compound, in particular in the form of a salt, can be carried out in such a way that a corresponding conversion of the metal or noble metal into the elemental form or into the oxidation state zero takes place, in particular so that in this way a catalyst activation or a conversion into the catalytically active form is realized or carried out.

Furthermore, the reduction treatment according to method step (d)—without wishing to limit itself to this theory—can lead to at least partial removal or reduction of the functional groups, in particular those containing oxygen, on the surface of the activated carbon or of the pore system of the activated carbon relating thereto (surface reduction). In method step (d), a surface reduction of the oxidized activated carbon equipped with the catalytically active component or the relevant precursor can thus be carried out. In this way, a neutral surface or neutralization of the catalyst support or the relevant activated carbon and thus of the catalyst system can be carried out.

The catalyst system according to the invention treated in this way, or the activated carbon in this respect, consequently also exhibits in particular a reduced self-reaction as a result of the reduced content of functional groups on the surface in question associated with the reduction treatment, which is beneficial to the catalytic property as a whole.

Similarly—without wishing to be limited to this theory—the hydrophilicity of the activated carbon and thus of the catalyst system as a whole is reduced on the basis of the reduction treatment carried out, or the content of polar groups is reduced, which improves the overall penetration or diffusion behavior of, in particular, hydrophobic or apolar reactants or products originating from the catalytic reaction.

In general, in method step (d), the reduction can be carried out as a gas-phase reduction or as a liquid-phase reduction.

In particular, it may be provided in accordance with the invention that in method step (d) the reduction is carried out at a temperature in the range from 20° C. to 400° C., in particular in the range from 50° C. to 300° C., preferably in the range from 100° C. to 250° C., preferably in the range from 110° C. to 200° C., particularly preferably in the range from 115° C. to 160° C., most preferably in the range from 120° C. to 150° C., further preferably in the range from 130° C. to 145° C. Furthermore, in method step (d), the reduction can generally be carried out at a temperature in the range of 0° C. to 750° C., in particular 10° C. to 600° C.

According to the invention, in method step (d) the reduction can be carried out for a period of time in the range from 0.05 h to 48 h, in particular in the range from 0.1 h to 36 h, preferably in the range from 0.5 h to 24 h, more preferably in the range from 1 h to 12 h.

The reduction treatment using a gaseous reducing agent is now described in more detail below, this embodiment being preferred according to the invention.
In this context, it can be provided according to the invention that in method step (d) the reduction of the catalyst system is carried out using at least one gaseous reducing agent, in particular gaseous reducing agent, preferably hydrogen.
In this respect, in method step (d), the reduction can be carried out in an atmosphere containing the reducing agent, in particular hydrogen, in particular an inert atmosphere, preferably a nitrogen atmosphere. In this context, the atmosphere may contain the reducing agent, in particular hydrogen, in amounts ranging from 0.1% by volume to 20% by volume, in particular ranging from 0.5% by volume to 10% by volume, preferably ranging from 2% by volume to 8% by volume, based on the volume of the atmosphere.
Furthermore, in method step (d), the reduction can be carried out at a temperature in the range of in the range of 50° C. to 300° C., in particular in the range of 100° C. to 250° C., preferably in the range of 110° C. to 200° C., preferably in the range of 115° C. to 160° C., more preferably in the range of 120° C. to 150° C., most preferably in the range of 130° C. to 145° C.
Furthermore, in method step (d), the reduction can be carried out at a volumetric flow rate of the atmosphere containing the reducing agent in the range from 5 l/h to 1,000 l/h, in particular in the range from 10 l/h to 500 l/h, preferably in the range from 50 l/h to 300 l/h.
According to the invention, it may also be provided in this context that in method step (d) the reduction is carried out using a gaseous reducing agent for a period of time in the range from 0.1 h to 36 h, in particular in the range from 0.2 h to 24 h, preferably in the range from 0.5 h to 12 h.

In accordance with another embodiment of the invention, reduction treatment using a liquid reducing agent is further described below:
Thus, according to the invention, it can be provided that in method step (d) the reduction of the catalyst system is carried out using at least one liquid reducing agent, in particular a liquid alkaline reducing agent, preferably based on at least one alkali metal hydroxide, preferably potassium hydroxide, in particular in combination with at least one alkali metal formiate, preferably potassium formiate.
In this context, in method step (d), the reduction can be carried out using a liquid reducing agent at a temperature in the range from 10° C. to 250° C., in particular in the range from 20° C. to 200° C., preferably in the range from 30° C. to 150° C., preferably in the range from 40° C. to 125° C., particularly preferably in the range from 50° C. to 120° C.
In this regard, in method step (d), the reduction may be carried out for a period of time in the range of 0.05 h to 24 h, in particular in the range of 0.1 h to 12 h, preferably in the range of 0.5 h to 8 h.

In the context of the present invention, the reduction carried out in method step (d) can thus be carried out using at least one gaseous and/or liquid reducing agent. In addition to the above-mentioned reducing agent, formalin, hydrazine as well as complex hydrides, such as LiAlH₄ and/or NaBH₄, and/or formic acid can in principle also be considered as reducing agents.

Overall, in or after carrying out method step (d), in particular also such a catalyst system according to the invention is obtained as is described or defined below in the second aspect of the present invention, so that the explanations there apply accordingly to the present aspect.

Overall, in method step (d), a catalyst system according to the invention can be obtained, wherein the catalyst system has at least one catalytically active component applied to and/or fixed to a catalyst support, wherein the catalytically active component comprises and/or consists of at least one metal and wherein the catalyst support is formed in the form of and/or based on activated carbon, wherein the catalyst support is present in the form of a granular, preferably spherical, activated carbon, wherein the activated carbon (i.e., the activated carbon forming the catalyst support)
(i) has a total pore volume (Vₜₒₜₐₗ), in particular a total pore volume according to Gurvich, in the range from 0.8 cm³/g to 3.9 cm³/g, at least 50% of the total pore volume, in particular the total pore volume according to Gurvich, being formed by pores having pore diameters of at least 2 nm, in particular by pores having pore diameters in the range from 2 nm to 500 nm, preferably by meso- and macropores, and
(ii) has a specific BET surface area (S_{BET}) in the range from 1,000 m²/g to 3,000 m²/g, but with the proviso that the ratio (quotient; Q) of total pore volume (Vₜₒₜₐₗ), in particular total pore volume according to Gurvich, to specific BET surface area (S_{BET}), in particular according to the equation Q=Vₜₒₜₐₗ/S_{BET}, is at least 0.5*10⁻⁹ m.

In the context of the present invention, in method step (d), in particular a catalyst system can be obtained, wherein the catalyst system has at least one catalytically active component applied to or fixed to a catalyst support, wherein the catalytically active component comprises and/or consists of at least one metal and wherein the catalyst support is formed in the form of or based on activated carbon, wherein the catalyst support is in the form of a granular, preferably spherical, activated carbon.

According to the invention, the catalyst system can have an activity, determined as the percentage degree of dispersion (degree of dispersion D, metal dispersity) of the catalytically active component, in particular of the metal of the catalytically active component, on the catalyst support, in particular measured by chemisorption using a (dynamic) flow method, preferably according to DIN 66136-3:2007-01, of at least 15%, in particular at least 20%, preferably at least 25%, preferably at least 28%, and/or in the range from 15% to 90%, in particular in the range from 20% to 80%, preferably in the range from 25% to 70%, preferably in the range from 28% to 60%.

In particular, the catalyst system can comprise the catalytically active component, in particular the metal of the catalytically active component, with an average crystallite size (average crystallite size d_{Me}), preferably determined according to DIN 66136, of at most 80 Å (Angstrom), in particular at most 70 Å, preferably at most 60 Å, preferably at most 58 Å, particularly preferably at most 45 Å, very particularly preferably at most 40 Å, still more preferably at most 38 Å, and/or in the range from 5 Å (Angstrom) to 80 Å, in particular in the range from 7 Å to 70 Å, preferably in the range from 10 Å to 60 Å, preferably in the range from 15 Å to 58 Å, particularly preferably in the range from 17 Å to 45 Å, very particularly preferably in the range from 18 Å to 40 Å, still more preferably in the range from 20 Å to 38 Å.

In this context, it can thus be generally provided according to the invention that the catalyst system obtained in method step (d) has an activity, determined as the percentage degree of dispersion of the catalytically active component, in particular of the metal of the catalytically active component, on the catalyst support, in particular measured by chemisorption by means of a (dynamic) flow method, preferably according to DIN 66136-3:2007-01, of at least 15%, in particular at least 20%, preferably at least 25%, preferably at least 28%, and/or in the range from 15% to 90%, in particular in the range from 20% to 80%, preferably in the range from 25% to 70%, preferably in the range from 28% to 60%.

Moreover, it may be equally provided in this context within the scope of the present invention that the catalyst system obtained in method step (d) comprises the catalytically active component, in particular the metal of the catalytically active component, with an average crystallite size, preferably determined according to DIN 66136, of at most 80 Å (Angstrom), in particular at most 70 Å, preferably at most 60 Å, preferably at most 58 Å, particularly preferably at most 45 Å, very particularly preferably at most 40 Å, still further preferably at most 38 Å, and/or in the range from 5 Å (Angstrom) to 80 Å, particularly in the range from 7 Å to 70 Å, preferably in the range from 10 Å to 60 Å, preferably in the range from 15 Å to 58 Å, particularly preferably in the range from 17 Å to 45 Å, very particularly preferably in the range from 18 Å to 40 Å, still further preferably in the range from 20 Å to 38 Å.

According to the invention, it is thus possible to obtain in particular a catalyst system according to the invention which, in addition to a defined percentage degree of dispersion of the catalytically active component or of the metal in question, also has a defined crystallite size with respect to the catalytically active component or the metal in question, the metal in question, the above-mentioned properties of the special percentage degree of dispersion and the special crystallite size characterizing the outstanding catalytic properties of the catalyst system according to the invention, in particular with regard to the provision of large catalytically active surfaces with optimum equipment or occupancy of the pore system of the activated carbon with the catalytically active component.

The degree of dispersion of the catalytically active component or the metal dispersion thus also describes the catalytic activity of the catalyst system or the supported catalyst according to the invention. In particular, the catalytic activity is also characterized by the dispersion of the catalytically active component or the metal of the catalytically active component on the catalyst support material, against the background that it is significantly the surface atoms of the catalytically active component that participate in or enable the catalytic conversion. According to the invention, the term “degree of dispersion” (also referred to as “degree of dispersion D”) is used synonymously with the term “metal dispersity” or “metal dispersity D”. The percentage degree of dispersion is based in particular on the ratio of the atoms or molecules of the catalytically active component actually present on the surface to the theoretically possible size of the atoms or molecules of the catalytically active component present on the surface. In other words, the percentage degree of dispersion describes in particular the ratio of the number of surface atoms or molecules of the catalytically active component (as can be determined, for example, by means of chemisorption of a sample gas using the atoms or molecules of the catalytically active component that are accessible to the sample gas) to the total number of atoms or molecules of the catalytically active component (i.e. to the theoretically available or used total number of atoms or molecules of the catalytically active component or to the total number of atoms or molecules of the catalytically active component present in the catalyst support). In particular, the determination can be carried out by means of chemisorption. In particular, carbon monoxide (CO) can be used as the measuring gas. The degree of dispersion or the metal dispersity can thus be measured in particular by means of carbon monoxide chemisorption.

The percentage degree of dispersion (D) of the catalytically active component, in particular the metal of the catalytically active component, on the catalyst support or the activated carbon can be calculated in particular on the basis of the following formula (I):

$$D = \frac{{n}_{m} \cdot M}{W \cdot x} \cdot 100$$

In particular, the average crystallite size (synonymously referred to as average crystallite size d_{Me}) can be calculated based on the following formula (II):

$${d}_{Me} = \frac{f \cdot W}{{S}_{ME} \cdot {ρ}_{Me}}$$

With regard to the formulas (I) and (II) given above, the formula symbols given below apply:

| Formula | | |
|---|---|---|
| symbol | Naming | Unit |
| D: | Percentage degree of dispersion or percentage metal | % |
| | dispersity D | |
| nₘ: | Monolayer capacity | mol/kg |
| M: | Molar mass of the metal or catalytically active | kg/mol |
| | component | |
| W: | Metal content or proportion of the catalytically active | |
| | component in the catalyst (mass fraction based on the | |
| | sample mass) | |
| X: | Stoichiometric factor of chemisorption | |
| d_{Me}: | Average crystallite size of the metal or catalytically | m |
| | active component | |
| f: | Shape factor for calculating the average crystallite size | |
| | of the metal or catalytically active component. | |
| S_{Me}: | Specific surface area of the metal or catalytically active | m²/kg |
| | component | |
| ρ_{Me}: | Metal density | kg/m³ |

As far as the average crystallite size according to the invention is concerned, this also characterizes the catalytic activity, in particular also against the background of the existence of an improved accessibility of the catalytically active component for reactants to be reacted. In particular, the average crystallite sizes according to the invention also have an optimized ratio of the surface area of the catalytically active component forming the crystallites to the corresponding volume, which also leads to an improvement in the catalytic activity.

In particular, according to the invention, the average degree of dispersion on the one hand and the average crystallite size on the other interlock with respect to the overall improved catalytic activity provided and mutually reinforce each other beyond the sum of the respective individual effects, so that in this respect there is also a synergistic effect with respect to the improved catalytic activity of the catalyst systems according to the invention, in particular also with respect to higher conversions or an improved space/time yield.

On the basis of the method according to the invention, the amount or content of catalytically active component can be specifically adjusted or tailored with respect to the catalyst system according to the invention, so that the catalytic activity of the catalyst system obtained according to the invention can also be specifically predetermined from this point of view.

Thus, according to the invention, it can be provided that the catalyst system obtained in method step (d) comprises the catalytically active component in amounts of at least 0.05% by weight, in particular at least 0.1% by weight, preferably at least 0.2% by weight, preferably at least 0.5% by weight, particularly preferably at least 0.6% by weight, most preferably at least 1% by weight, further preferably at least 1.5% by weight, calculated as metal and based on the total weight of the catalyst system. The lower limits thereby ensure the provision of a defined catalytic activity.

In addition, according to the invention, it can be provided in particular that the catalyst system obtained in method step (d) comprises the catalytically active component in amounts of at most 25% by weight, in particular at most 20% by weight, preferably at most 15% by weight, preferably at most 10% by weight, particularly preferably at most 8% by weight, very particularly preferably at most 7% by weight, calculated as metal and based on the total weight of the catalyst system. The upper limit ensures in particular good accessibility to the catalytically active component, and in particular avoids clogging of pores.

In this context, it is particularly possible in the context of the present invention for the catalyst system obtained in method step (d) to contain the catalytically active component in amounts in the range from 0.05 wt. % to 25 wt. %, in particular in the range from 0.1 wt. % to 25 wt. %, preferably in the range from 0.2 wt. % to 20 wt. %, preferably in the range from 0.5 wt.-% to 15 wt. %, particularly preferably in the range from 0.6 wt. % to 10 wt. %, very particularly preferably in the range from 1 wt. % to 8 wt. %, further preferably in the range from 1.5 wt. % to 7 wt. %, calculated as metal and based on the total weight of the catalyst system.

Further, for the catalytically active component of the catalyst system obtained in method step (d) according to the invention, it may be as follows:

In particular, the catalytically active component of the catalyst system obtained in method step (d) may comprise or consist of at least one metal, in particular in the form of a metal compound, preferably in the form of an ionic metal compound, and/or in particular in elemental form.

In particular, the catalytically active component of the catalyst system obtained in method step (d) may comprise at least one metal in a positive oxidation state, in particular at least one metal cation. In this context, the oxidation state of the metal may be in the range from +I to +VII, in particular in the range from +I to +IV, preferably in the range from +I to +III, or particularly preferably +I or +II. According to the invention, it may also be provided that the catalytically active component comprises at least one metal having an oxidation state of zero.

In particular, in the course of the reduction carried out in method step (d), the catalytically active component used in accordance with method step (c) or the metal relating thereto can be reduced accordingly, in particular so that in method step (d) the metal is present with the oxidation state zero. In the context of the present invention, it is particularly preferred that the catalytically active component of the catalyst system obtained in method step (d) (and thus of the final product resulting from the method) comprises at least one metal with the oxidation state zero.

In particular, the catalytically active component of the catalyst system obtained in method step (d) may comprise at least one metal from the main or subgroups of the periodic table of the elements or at least one lanthanide.

In general, the catalytically active component of the catalyst system obtained in method step (d) may comprise at least one metal selected from elements of main group IV or subgroups I, II, III, IV, V, VI, VII and VIII of the periodic table of elements, in particular from elements of main group IV or subgroups I and II of the periodic table of elements.

In particular, the catalytically active component of the catalyst system obtained in method step (d) may comprise at least one metal selected from the group consisting of Cu, Ag, Au, Zn, Hg, Sn, Ce, Ti, Zr, V, Nb, Cr, Mo, W, Mn, Fe, Bi, Ru, Os, Co, Rh, Re, Ir, Ni, Pd and Pt, in particular Fe, Bi, V, Cu, Pb, Zn, Ag, Sn, Pd, Pt, Ru and Ni, preferably Fe, Bi, V, Cu, Pt, Ru and Pb, preferably Pd, Pt and Ru, particularly preferably Pd and Pt.

This is because particularly high catalytic activities are achieved with the aforementioned metals with regard to underlying catalytic methods, such as hydrogenation reactions or the like.

With regard to the activated carbon present in the catalyst system, this can be based on or derived from activated carbons of the following type, with the properties relating thereto equally leading to improved performance of the catalyst system according to the invention (for example, by improved equipment with or formation of the catalytically active component):
Thus the ((surface-) reduced) activated carbon of the catalyst system obtained in method step (d) (i.e. the activated carbon forming the catalyst support) may have been oxidized prior to the application and/or fixing of the catalytically active component, in particular at its surface, in particular wherein the oxidation, in particular surface oxidation, of the activated carbon has been carried out using and/or in the presence of at least one oxidizing agent. In this regard, reference can also be made to the above explanations, in particular to method step (c).
Similarly, within the scope of the present invention, it may behave in particular in such a way that the activated carbon has been reduced, in particular at its surface, after being equipped with the catalytically active component, in particular wherein the reduction of the activated carbon has been carried out using and/or in the presence of at least one reducing agent. In particular, it behaves in such a way that the activated carbon, in particular after being equipped with the catalytically active component and/or after the reduction has been carried out, is a reduced, in particular surface-reduced, activated carbon. In particular, according to the invention, it behaves in such a way that the precursor of the catalytically active component is converted into the active form or into the catalytically active component in the course of the reduction treatment, in particular wherein the underlying metal component is converted into the elemental form.
In addition, the activated carbon (i.e. the activated carbon forming the catalyst support) may be obtainable by carbonization and subsequent activation of a starting material based on organic polymers, followed by oxidation(s) treatment, wherein the oxidation(s) treatment is carried out prior to equipping with the catalytically active component, and followed by reduction(s) treatment, wherein the reduction(s) treatment is carried out after equipping with the catalytically active component. In this respect, reference can also be made to the above explanations.
Equally, the activated carbon (i.e. the activated carbon forming the catalyst support) may be an activated carbon based on an activated carbon obtainable by carbonization and subsequent activation of an organic polymer-based starting material and/or based on an activated carbon in the form of a polymer-based, preferably spherical (spherical), activated carbon (PBSAC or Polymer-based Spherical Activated Carbon).
In addition, the activated carbon of the catalyst system obtained in method step (d) (i.e. the activated carbon forming the catalyst support) may be an activated carbon based on or derived from a starting material described herein (cf. also claim 21). In particular, the activated carbon of the catalyst system obtained in method step (d) can be an activated carbon going back to or based on an activated carbon obtained according to the production method for the activated carbon described herein (cf. claims 22 to 25) or according to the oxidation method described herein according to method step (b) (cf. also claims 30 to 34).

Furthermore, the catalytically active component of the catalyst system obtained according to the invention may be based on a precursor of the catalytically active component reduced in particular in method step (d).

In particular, in the context of the present invention, it may be the case that the catalyst system obtained in method step (d) is a catalyst system reduced in particular at its surface (which includes in particular a corresponding oxidation of the catalyst support and thus of the activated carbon relating thereto as well as of the catalytically active component or the precursor relating thereto).

Furthermore, for further explanations of the catalyst system according to the invention obtained in method step (d), reference may be made to the following explanations according to the second aspect of the present invention with the catalyst system, the explanations relating thereto applying mutatis mutandis.

Turning further to the present first aspect of the present invention, the present invention also relates to a method for producing a catalyst system comprising at least one catalytically active component, in particular a supported catalyst, preferably for use in heterogeneous catalysis, in particular a method as defined herein,
wherein at least one catalytically active component is applied and/or fixed to a catalyst support, said catalytically active component comprising and/or consisting of at least one metal,
wherein the method comprises the following steps in the sequence (a) to (d) specified below:
(a) Provision and/or production of a granular, preferably spherical, activated carbon (=initial activated carbon) used as catalyst support,
   where the activated carbon (i.e. initial activated carbon)
   (i) has a total pore volume (Vₜₒₜₐₗ), in particular a total pore volume according to Gurvich, in the range from 0.8 cm³/g to 3.9 cm³/g, at least 50% of the total pore volume, in particular the total pore volume according to Gurvich, of the activated carbon being formed by pores having pore diameters of at least 2 nm, in particular by pores having pore diameters in the range from 2 nm to 500 nm, preferably by meso- and macropores,
   (ii) has a specific BET surface area (S_{BET}) in the range from 1,000 m²/g to 3,000 m²/g, but with the proviso that the ratio (quotient; Q) of total pore volume (Vₜₒₜₐₗ), in particular total pore volume according to Gurvich, to specific BET surface area (S_{BET}), in particular according to the equation Q=Vₜₒₜₐₗ/S_{BET}, is at least 0.5*10⁻⁹ m, and
   (iii) has an average pore diameter in the range from 15 nm to 100 nm, in particular in the range from 16 nm to 90 nm, preferably in the range from 17 nm to 85 nm, preferably in the range from 18 nm to 80 nm, particularly preferably in the range from 20 nm to 70 nm, most preferably in the range from 22 nm to 60 nm, further preferably in the range from 25 nm to 50 nm;
then
(b) oxidation, in particular surface oxidation, of the activated carbon prepared and/or produced in method step (a), with the proviso that the oxidized, in particular surface-oxidized, activated carbon has an oxygen content, in particular surface oxygen content, in particular determined by X-ray photoelectron spectroscopy (XPS or ESCA), of at least 4% (atomic %), based on the total element composition of the oxidized activated carbon, and/or with the proviso that the oxidized, in particular surface-oxidized, activated carbon has a hydrophilicity, determined as water vapor adsorption behavior, such that at least 30% of the maximum water vapor saturation loading of the activated carbon is reached at a partial pressure p/p₀ of 0.6;
then
(c) equipping, in particular loading and/or coating and/or impregnation, of the activated carbon oxidized in method step (b), in particular surface-oxidized, with the catalytically active component, in particular with at least one precursor of the catalytically active component;
then
(d) reduction of the oxidized, in particular surface-oxidized, activated carbon obtained in method step (c) and equipped with the catalytically active component, in particular with the precursor of the catalytically active component, in particular to convert the precursor of the catalytically active component into the catalytically active component, in particular so that the catalyst system having at least one catalytically active component, in particular the supported catalyst, is obtained.

In this context, the present invention equally relates according to the present first aspect also to a method for preparing a catalyst system comprising at least one catalytically active component, in particular a supported catalyst, preferably for use in heterogeneous catalysis, in particular as previously defined,
wherein at least one catalytically active component is applied and/or fixed to a catalyst support, said catalytically active component comprising and/or consisting of at least one metal,
wherein the method comprises the following steps in the sequence (a) to (d) specified below:
(a) Provision and/or production of a granular, preferably spherical, activated carbon (=initial activated carbon) used as catalyst support,
   wherein the activated carbon (i.e. initial activated carbon)
   (i) has a total pore volume (Vₜₒₜₐₗ), in particular a total pore volume according to Gurvich, in the range from 0.8 cm³/g to 3.9 cm³/g, at least 50% of the total pore volume, in particular the total pore volume according to Gurvich, of the activated carbon being formed by pores having pore diameters of at least 2 nm, in particular by pores having pore diameters in the range from 2 nm to 500 nm, preferably by meso- and macropores,
   (ii) has a specific BET surface area (S_{BET}) in the range from 1,000 m²/g to 3,000 m²/g, but with the proviso that the ratio (quotient; Q) of total pore volume (Vₜₒₜₐₗ), in particular total pore volume according to Gurvich, to specific BET surface area (S_{BET}), in particular according to the equation Q=Vₜₒₜₐₗ/S_{BET}, is at least 0.5*10⁻⁹ m,
   (iii) has an average pore diameter in the range from 15 nm to 100 nm, in particular in the range from 16 nm to 90 nm, preferably in the range from 17 nm to 85 nm, preferably in the range from 18 nm to 80 nm, particularly preferably in the range from 20 nm to 70 nm, most preferably in the range from 22 nm to 60 nm, further preferably in the range from 25 nm to 50 nm, and
   (iv) has a particle size, in particular a particle diameter, in the range from 60 μm to 1,000 μm, in particular in the range from 70 μm to 800 μm, preferably in the range from 80 μm to 600 μm, preferably in the range from 100 μm to 400 μm, particularly preferably in the range from 150 μm to 375 μm, very particularly preferably in the range from 175 μm to 250 μm, in particular at least 80% by weight, in particular at least 90% by weight, preferably at least 95%, of the activated carbon particles, in particular activated carbon particles, have particle sizes, in particular particle diameters, in the abovementioned ranges; and/or have a mean particle size (D50), in particular a mean particle diameter (D50), in the range from 60 μm to 900 μm, in particular in the range from 75 μm to 750 μm, preferably in the range from 85 μm to 550 μm, preferably in the range from 110 μm to 375 μm, particularly preferably in the range from 175 μm to 350 μm, very particularly preferably in the range from 185 μm to 225 μm;
then
(b) oxidation, in particular surface oxidation, of the activated carbon prepared and/or produced in method step (a), with the proviso that the oxidized, in particular surface-oxidized, activated carbon has an oxygen content, in particular surface oxygen content, in particular determined by X-ray photoelectron spectroscopy (XPS or ESCA), of at least 4% (atomic %), based on the total element composition of the oxidized activated carbon, and/or with the proviso that the oxidized, in particular surface-oxidized, activated carbon has a hydrophilicity, determined as water vapor adsorption behavior, such that at least 30% of the maximum water vapor saturation loading of the activated carbon is reached at a partial pressure p/p₀ of 0.6;
then
(c) equipping, in particular loading and/or coating and/or impregnation, of the activated carbon oxidized in method step (b), in particular surface-oxidized, with the catalytically active component, in particular with at least one precursor of the catalytically active component;
then
(d) reduction of the oxidized, in particular surface-oxidized, activated carbon obtained in method step (c) and equipped with the catalytically active component, in particular with the precursor of the catalytically active component, in particular to convert the precursor of the catalytically active component into the catalytically active component, in particular so that the catalyst system having at least one catalytically active component, in particular the supported catalyst, is obtained.

More particularly, according to the first aspect of the present invention, the present invention equally relates to a method for preparing a catalyst system comprising at least one catalytically active component, in particular a supported catalyst, preferably for use in heterogeneous catalysis, in particular method as defined herein, wherein at least one catalytically active component is applied and/or fixed to a catalyst support, said catalytically active component comprising and/or consisting of at least one metal,
wherein the method comprises the following steps in the sequence (a) to (d) specified below:
(a) Provision and/or production of a granular, preferably spherical, activated carbon (=initial activated carbon) used as catalyst support,
   wherein the activated carbon (i.e. initial activated carbon)
   (i) has a total pore volume (Vₜₒₜₐₗ), in particular a total pore volume according to Gurvich, in the range from 0.8 cm³/g to 3.9 cm³/g, at least 50% of the total pore volume, in particular the total pore volume according to Gurvich, of the activated carbon being formed by pores having pore diameters of at least 2 nm, in particular by pores having pore diameters in the range from 2 nm to 500 nm, preferably by meso- and macropores,
   (ii) has a specific BET surface area (S_{BET}) in the range from 1,000 m²/g to 3,000 m²/g, but with the proviso that the ratio (quotient; Q) of total pore volume (Vₜₒₜₐₗ), in particular total pore volume according to Gurvich, to specific BET surface area (S_{BET}), in particular according to the equation Q=Vₜₒₜₐₗ/S_{BET}, is at least 0.5*10⁻⁹ m, and
   (iii) has an average pore diameter in the range from 15 nm to 100 nm, in particular in the range from 16 nm to 90 nm, preferably in the range from 17 nm to 85 nm, preferably in the range from 18 nm to 80 nm, particularly preferably in the range from 20 nm to 70 nm, most preferably in the range from 22 nm to 60 nm, further preferably in the range from 25 nm to 50 nm,
   (iv) has a particle size, in particular a particle diameter, in the range from 60 μm to 1,000 μm, in particular in the range from 70 μm to 800 μm, preferably in the range from 80 μm to 600 μm, preferably in the range from 100 μm to 400 μm, particularly preferably in the range from 150 μm to 375 μm, very particularly preferably in the range from 175 μm to 250 μm, in particular at least 80% by weight, in particular at least 90% by weight, preferably at least 95%, of the activated carbon particles, in particular activated carbon particles, have particle sizes, in particular particle diameters, in the abovementioned ranges; and/or have a mean particle size (D50), in particular a mean particle diameter (D50), in the range from 60 μm to 900 μm, in particular in the range from 75 μm to 750 μm, preferably in the range from 85 μm to 550 μm, preferably in the range from 110 μm to 375 μm, particularly preferably in the range from 175 μm to 350 μm, very particularly preferably in the range from 185 μm to 225 μm,
   (v) optionally has a ball pan hardness of at least 90%, in particular at least 95%, preferably at least 97%, preferably at least 98%, particularly preferably at least 99%, very particularly preferably at least 99.5%, further preferably at least 99.8%,
   (vi) optionally has a vibrating or tamping density in the range from 100 g/l to 1,500 g/l, in particular 125 g/l to 1,000 g/l, preferably 150 g/l to 800 g/l, preferably 200 g/l to 600 g/l, particularly preferably 225 g/l to 500 g/l, most preferably 250 g/l to 400 g/l, further preferably 255 g/l to 395 g/l, and/or a bulk density in the range from 150 g/l to 1.000 g/l, in particular from 250 g/l to 700 g/l, preferably 300 g/l to 600 g/l, preferably 300 g/l to 550 g/l,
   (vii) optionally having a butane adsorption in the range of 35% to 90%, particularly in the range of 40% to 85%, preferably in the range of 45% to 80%, preferably in the range of 47.5% to 75%,
   (viii) optionally having an iodine value in the range of 1,250 mg/g to 2,100 mg/g, particularly in the range of 1,300 mg/g to 2,000 mg/g, preferably in the range of 1,400 mg/g to 1,900 mg/g, preferably in the range of 1,425 mg/g to 1,850 mg/g,
   (ix) optionally has a methylene blue value in the range of from 17 ml to 65 ml, particularly in the range of from 18 ml to 55 ml, preferably in the range of from 19 ml to 50 ml, preferably in the range of from 19.5 ml to 47.5 ml,
   (x) optionally has a molasses number in the range from 255 to 1,500, in particular in the range from 310 to 1,400, preferably in the range from 375 to 1,300, preferably in the range from 510 to 1,250,
   (xi) optionally having a weight-based adsorbed N₂ volume V_{ads(wt.)}, determined at a partial pressure p/p₀ of 0.25, in the range from 250 cm³/g to 850 cm³/g, in particular in the range from 300 cm³/g to 700 cm³/g, preferably in the range from 350 cm³/g to 650 cm³/g, preferably in the range from 375 cm³/g to 625 cm/g.³
   (xii) optionally a volume-related adsorbed Ny volume V_{ads (vol.)}, determined at a partial pressure p/p₀ of 0.25, in the range from 50 cm³/cm³ to 300 cm³/cm³, in particular in the range from 80 cm³/cm³ to 275 cm³/cm³, preferably in the range from 90 cm³/cm³ to 250 cm³/cm³, preferably in the range from 95 cm³/cm³ to 225 cm³/cm³,
   (xiii) optionally having a weight adsorbed N₂ volume V_{ads} (wt.), determined at a partial pressure p/p₀ of 0.995, in the range from 300 cm³/g to 2,300 cm³/g, particularly in the range from 400 cm³/g to 2,200 cm³/g, preferably in the range from 450 cm³/g to 2,100 cm³/g, preferably in the range from 475 cm³/g to 2,100 cm³/g,
   (xiv) optionally a volume-related adsorbed Ny volume Vads_{(vol.)} determined at a partial pressure p/p₀ of 0.995, ranging from 200 cm³/cm³ to 500 cm³/cm³, in particular ranging from 250 cm³/cm³ to 400 cm³/cm³, preferably ranging from 275 cm³/cm³ to 380 cm³/cm³, preferably ranging from 295 cm³/cm³ to 375 cm³/cm³, and
   (xv) optionally having a fractal dimension of open porosity in the range of 2.6 to 2.99, in particular 2.7 to 2.95, preferably 2.8 to 2.95, and/or wherein the activated carbon has a fractal dimension of open porosity of at least 2.7, in particular at least 2.8, preferably at least 2.85, preferably at least 2.9;
then
(b) oxidation, in particular surface oxidation, of the activated carbon prepared and/or produced in method step (a), with the proviso that the oxidized, in particular surface-oxidized, activated carbon has an oxygen content, in particular surface oxygen content, in particular determined by means of X-ray photoelectron spectroscopy (XPS or ESCA), of at least 4% (atomic %), based on the total element composition of the oxidized activated carbon, and/or with the proviso that the oxidized, in particular surface-oxidized, activated carbon has a hydrophilicity, determined as water vapor adsorption behavior, such that at least 30% of the maximum water vapor saturation loading of the activated carbon is reached at a partial pressure p/p₀ of 0.6;
then
(c) equipping, in particular loading and/or coating and/or impregnation, of the activated carbon oxidized in method step (b), in particular surface-oxidized, with the catalytically active component, in particular with at least one precursor of the catalytically active component;
then
(d) reduction of the oxidized, in particular surface-oxidized, activated carbon obtained in method step (c) and equipped with the catalytically active component, in particular with the precursor of the catalytically active component, in particular to convert the precursor of the catalytically active component into the catalytically active component, in particular so that the catalyst system having at least one catalytically active component, in particular the supported catalyst, is obtained.

Moreover, according to the first aspect of the present invention, the present invention further relates to a method for preparing a catalyst system comprising at least one catalytically active component, in particular a supported catalyst, preferably for use in heterogeneous catalysis, in particular method as previously defined,
wherein at least one catalytically active component is applied and/or fixed to a catalyst support, said catalytically active component comprising and/or consisting of at least one metal,
wherein the method comprises the following steps in the sequence (a) to (d) specified below:
(a) Provision and/or production of a granular, preferably spherical, activated carbon (=initial activated carbon) used as catalyst support,
   wherein the activated carbon (i.e. initial activated carbon)
   (i) has a total pore volume (Vₜₒₜₐₗ), in particular a total pore volume according to Gurvich, in the range from 0.8 cm³/g to 3.9 cm³/g, at least 50% of the total pore volume, in particular the total pore volume according to Gurvich, of the activated carbon being formed by pores having pore diameters of at least 2 nm, in particular by pores having pore diameters in the range from 2 nm to 500 nm, preferably by meso- and macropores,
   (ii) has a specific BET surface area (S_{BET}) in the range from 1,000 m²/g to 3,000 m²/g, but with the proviso that the ratio (quotient; Q) of total pore volume (Vₜₒₜₐₗ), in particular total pore volume according to Gurvich, to specific BET surface area (S_{BET}), in particular according to the equation Q=Vₜₒₜₐₗ/S_{BET}, is at least 0.5*10⁻⁹ m, and
   (iii) has an average pore diameter in the range from 15 nm to 100 nm, in particular in the range from 16 nm to 90 nm, preferably in the range from 17 nm to 85 nm, preferably in the range from 18 nm to 80 nm, particularly preferably in the range from 20 nm to 70 nm, most preferably in the range from 22 nm to 60 nm, further preferably in the range from 25 nm to 50 nm,
   (iv) has a particle size, in particular a particle diameter, in the range from 60 μm to 1,000 μm, in particular in the range from 70 μm to 800 μm, preferably in the range from 80 μm to 600 μm, preferably in the range from 100 μm to 400 μm, particularly preferably in the range from 150 μm to 375 μm, very particularly preferably in the range from 175 μm to 250 μm, in particular at least 80% by weight, in particular at least 90% by weight, preferably at least 95%, of the activated carbon particles, in particular activated carbon particles, have particle sizes, in particular particle diameters, in the abovementioned ranges; and/or have a mean particle size (D50), in particular a mean particle diameter (D50), in the range from 60 μm to 900 μm, in particular in the range from 75 μm to 750 μm, preferably in the range from 85 μm to 550 μm, preferably in the range from 110 μm to 375 μm, particularly preferably in the range from 175 μm to 350 μm, very particularly preferably in the range from 185 μm to 225 μm,
   (v) has an abrasion resistance (ball pan hardness) and/or abrasion hardness of at least 90%, in particular at least 95%, preferably at least 97%, preferably at least 98%, particularly preferably at least 99%, very particularly preferably at least 99.5%, further preferably at least 99.8%,
   (vi) has a vibrating or tamping density in the range from 100 g/l to 1,500 g/l, in particular 125 g/l to 1,000 g/l, preferably 150 g/l to 800 g/l, preferably 200 g/l to 600 g/l, particularly preferably 225 g/l to 500 g/l, most preferably 250 g/l to 400 g/l, further preferably 255 g/l to 395 g/l, and/or a bulk density in the range from 150 g/l to 1.000 g/l, in particular from 250 g/l to 700 g/l, preferably 300 g/l to 600 g/l, preferably 300 g/l to 550 g/l,
   (vii) has a butane adsorption in the range of 35% to 90%, in particular in the range of 40% to 85%, preferably in the range of 45% to 80%, preferably in the range of 47.5% to 75%,
   (viii) has an iodine value in the range from 1,250 mg/g to 2,100 mg/g, in particular in the range from 1,300 mg/g to 2,000 mg/g, preferably in the range from 1,400 mg/g to 1,900 mg/g, preferably in the range from 1,425 mg/g to 1,850 mg/g,
   (ix) has a methylene blue value in the range from 17 ml to 65 ml, in particular in the range from 18 ml to 55 ml, preferably in the range from 19 ml to 50 ml, preferably in the range from 19.5 ml to 47.5 ml,
   (x) has a molasses number in the range from 255 to 1,500, in particular in the range from 310 to 1,400, preferably in the range from 375 to 1,300, preferably in the range from 510 to 1,250,
   (xi) has a weight-based adsorbed N₂ volume V_{ads (wt.)}, determined at a partial pressure p/p₀ of 0.25, in the range from 250 cm³/g to 850 cm³/g, in particular in the range from 300 cm³/g to 700 cm³/g, preferably in the range from 350 cm³/g to 650 cm³/g, preferably in the range from 375 cm³/g to 625 cm/g,³
   (xii) has a volume-related adsorbed N₂ volume V_{ads (vol.)}, determined at a partial pressure p/p₀ of 0.25, in the range from 50 cm³/cm³ to 300 cm³/cm³, in particular in the range from 80 cm³/cm³ to 275 cm³/cm³, preferably in the range from 90 cm³/cm³ to 250 cm³/cm³, preferably in the range from 95 cm³/cm³ to 225 cm³/cm³,
   (xiii) has a weight adsorbed N₂ volume V_{ads (wt.)}, determined at a partial pressure p/p₀ of 0.995, in the range from 300 cm³/g to 2,300 cm³/g, in particular in the range from 400 cm³/g to 2,200 cm³/g, preferably in the range from 450 cm³/g to 2,100 cm³/g, preferably in the range from 475 cm³/g to 2,100 cm/g,
   (xiv) has a volume-related adsorbed N₂ volume V_{ads (vol.)} determined at a partial pressure p/p₀ of 0.995, ranging from 200 cm³/cm³ to 500 cm³/cm³, in particular ranging from 250 cm³/cm³ to 400 cm³/cm³, preferably ranging from 275 cm³/cm³ to 380 cm³/cm³, preferably ranging from 295 cm³/cm³ to 375 cm³/cm³, and
   (xv) has a fractal dimension of open porosity in the range from 2.6 to 2.99, in particular 2.7 to 2.95, preferably 2.8 to 2.95, and/or wherein the activated carbon has a fractal dimension of open porosity of at least 2.7, in particular at least 2.8, preferably at least 2.85, preferably at least 2.9;
then
(b) oxidation, in particular surface oxidation, of the activated carbon prepared and/or produced in method step (a), with the proviso that the oxidized, in particular surface-oxidized, activated carbon has an oxygen content, in particular surface oxygen content, in particular determined by means of X-ray photoelectron spectroscopy (XPS or ESCA), of at least 4% (atomic %), based on the total element composition of the oxidized activated carbon, and/or with the proviso that the oxidized, in particular surface-oxidized, activated carbon has a hydrophilicity, determined as water vapor adsorption behavior, such that at least 30% of the maximum water vapor saturation loading of the activated carbon is reached at a partial pressure p/p₀ of 0.6;
then
(c) equipping, in particular loading and/or coating and/or impregnation, of the activated carbon oxidized in method step (b), in particular surface-oxidized, with the catalytically active component, in particular with at least one precursor of the catalytically active component;
then
(d) reduction of the oxidized, in particular surface-oxidized, activated carbon obtained in method step (c) and equipped with the catalytically active component, in particular with the precursor of the catalytically active component, in particular to convert the precursor of the catalytically active component into the catalytically active component, in particular so that the catalyst system having at least one catalytically active component, in particular the supported catalyst, is obtained.

Overall, the present invention provides an efficient method for the production of a catalyst system according to the invention with high catalytic performance, whereby a catalyst system is provided which can be specifically adjusted or tailored, in particular with respect to its catalytic activity, while at the same time the method is simplified, which catalyst system has a high catalytic activity overall, as is also shown in particular on the basis of the average degree of dispersion and the average crystallite size of the catalytically active component.

The provision of the high-performance catalyst system according to the invention is thereby ensured by the specific sequence and coordination of the respective method steps as defined above. In this context, the use of a special activated carbon as catalyst support with a defined pore system or the performance of a special oxidation is also of great importance, in particular also with regard to the provision of a higher loading with the catalytically active component as well as a better accessibility for reactants or products.

The method according to the invention as well as the catalyst system according to the invention obtainable therewith are thus associated with a large number of advantages and special properties as already indicated above. Due to the outstanding catalytic properties of the catalyst system according to the invention obtained by the method according to the invention, a wide range of application or use is possible, whereby, within the scope of use for catalytic applications, correspondingly high catalytic conversions and high space/time yields are also ensured.

With regard to the method according to the invention, reference can also be made in addition to the explanations on the further aspects of the present invention, which apply accordingly in the present case.

A further object of the present invention—according to a second aspect of the present invention—is furthermore also the catalyst system according to the invention, in particular the supported catalyst according to the invention, preferably for use in heterogeneous catalysis, wherein the catalyst system according to the invention or the supported catalyst relating thereto is obtainable or is obtained according to the method according to the invention described above.

Similarly, according to this aspect of the invention, the present invention also relates to the catalyst system according to the invention, in particular the supported catalyst according to the invention, preferably for use in heterogeneous catalysis, in particular the catalyst system previously defined, wherein the catalyst system has at least one catalytically active component applied and/or fixed to a catalyst support, wherein the catalytically active component comprises and/or consists of at least one metal and wherein the catalyst support is in the form of and/or based on activated carbon, wherein the catalyst support is in the form of a granular, preferably spherical, activated carbon,
wherein the activated carbon (i.e. the activated carbon forming the catalyst support)
(i) has a total pore volume (Vₜₒₜₐₗ), in particular a total pore volume according to Gurvich, in the range from 0.8 cm³/g to 3.9 cm³/g, at least 50% of the total pore volume, in particular the total pore volume according to Gurvich, being formed by pores having pore diameters of at least 2 nm, in particular by pores having pore diameters in the range from 2 nm to 500 nm, preferably by meso- and macropores, and
(ii) has a specific BET surface area (S_{BET}) in the range from 1,000 m²/g to 3,000 m²/g, but with the proviso that the ratio (quotient; Q) of total pore volume (Vₜₒₜₐₗ), in particular total pore volume according to Gurvich, to specific BET surface area (S_{BET}), in particular according to the equation Q=Vₜₒₜₐₗ/S_{BET}, is at least 0.5*10⁻⁹ m.

In this context, the invention according to the second aspect also relates to a catalyst system, in particular a supported catalyst, preferably for use in heterogeneous catalysis, in particular a catalyst system as previously defined,
wherein the catalyst system has at least one catalytically active component applied and/or fixed to a catalyst support, wherein the catalytically active component comprises and/or consists of at least one metal and wherein the catalyst support is in the form of and/or based on activated carbon, wherein the catalyst support is in the form of a granular, preferably spherical, activated carbon,
wherein the activated carbon (i.e. the activated carbon forming the catalyst support)
(i) has a total pore volume (Vₜₒₜₐₗ), in particular a total pore volume according to Gurvich, in the range from 0.8 cm³/g to 3.9 cm³/g, at least 50% of the total pore volume, in particular the total pore volume according to Gurvich, being formed by pores having pore diameters of at least 2 nm, in particular by pores having pore diameters in the range from 2 nm to 500 nm, preferably by meso- and macropores, and
(ii) has a specific BET surface area (S_{BET}) in the range from 1,000 m²/g to 3,000 m²/g, but with the proviso that the ratio (quotient; Q) of total pore volume (Vₜₒₜₐₗ), in particular total pore volume according to Gurvich, to specific BET surface area (S_{BET}), in particular according to the equation Q=Vₜₒₜₐₗ/S_{BET}, is at least 0.5*10⁻⁹ m; and
the catalyst system having an activity, determined as the percentage degree of dispersion of the catalytically active component, in particular of the metal of the catalytically active component, on the catalyst support, in particular measured by chemisorption by means of a (dynamic) flow method, preferably in accordance with DIN 66136-3:2007-01, of at least 15%, in particular at least 20%, preferably at least 25%, preferably at least 28%, and/or in the range from 15% to 90%, in particular in the range from 20% to 80%, preferably in the range from 25% to 70%, preferably in the range from 28% to 60%; and/or wherein the catalyst system comprises the catalytically active component having an average crystallite size, preferably determined according to DIN 66136, of at most 80 Å (Angstrom), in particular at most 70 Å, preferably at most 60 Å, preferably at most 58 Å, particularly preferably at most 45 Å, very particularly preferably at most 40 Å, even more preferably at most 38 Å, and/or in the range from 5 Å (Angstrom) to 80 Å, in particular in the range from 7 Å to 70 Å, preferably in the range from 10 Å to 60 Å, preferably in the range from 15 Å to 58 Å, especially preferably in the range from 17 Å to 45 Å, most preferably in the range from 18 Å to 40 Å, even more preferably in the range from 20 Å to 38 Å.

Similarly, according to the present aspect, the invention also relates to a catalyst system, in particular a supported catalyst, preferably for use in heterogeneous catalysis, in particular the catalyst system previously defined,
wherein the catalyst system comprises at least one catalytically active component applied and/or fixed to a catalyst support, wherein the catalytically active component comprises and/or consists of at least one metal and wherein the catalyst support is in the form of and/or based on activated carbon, wherein the catalyst support is in the form of a granular, preferably spherical, activated carbon, and
the catalyst system having an activity, determined as the percentage degree of dispersion of the catalytically active component, in particular of the metal of the catalytically active component, on the catalyst support, in particular measured by chemisorption by means of a (dynamic) flow method, preferably in accordance with DIN 66136-3:2007-01, of at least 15%, in particular at least 20%, preferably at least 25%, preferably at least 28%, and/or in the range from 15% to 90%, in particular in the range from 20% to 80%, preferably in the range from 25% to 70%, preferably in the range from 28% to 60%; and/or wherein the catalyst system comprises the catalytically active component having an average crystallite size, preferably determined according to DIN 66136, of at most 80 Å (Angstrom), in particular at most 70 Å, preferably at most 60 Å, preferably at most 58 Å, particularly preferably at most 45 Å, very particularly preferably at most 40 Å, even more preferably at most 38 Å, and/or in the range from 5 Å(Angstrom) to 80 Å, in particular in the range from 7 Å to 70 Å, preferably in the range from 10 Å to 60 Å, preferably in the range from 15 Å to 58 Å, especially preferably in the range from 17 Å to 45 Å, most preferably in the range from 18 Å to 40 Å, even more preferably in the range from 20 Å to 38 Å.

The catalyst system according to the invention is thus characterized by a defined percentage degree of dispersion as well as a defined average crystallite size of the underlying catalytically active component, so that overall excellent catalytic properties result. In addition, the use of a special activated carbon as catalyst support with a defined pore system improves the transport properties with regard to reactants as well as products resulting from the catalytic reaction, leading to overall extremely efficient catalyst systems, also with regard to the provision of high conversions with simultaneously high space/time yields with regard to use in heterogeneous catalysis.

According to the invention, it is particularly provided that the catalyst system according to the invention has an activity, determined as the percentage degree of dispersion of the catalytically active component, in particular of the metal of the catalytically active component, on the catalyst support, in particular measured by chemisorption by means of a (dynamic) flow method, preferably according to DIN 66136-3:2007-01, of at least 15%, in particular at least 20%, preferably at least 25%, preferably at least 28%, and/or in the range from 15% to 90%, in particular in the range from 20% to 80%, preferably in the range from 25% to 70%, preferably in the range from 28% to 60%.

Moreover, according to the invention, it is particularly provided that the catalyst system comprises the catalytically active component, in particular the metal of the catalytically active component, with an average crystallite size, preferably determined according to DIN 66136, of at most 80 Å (Angstrom), in particular at most 70 Å, preferably at most 60 Å, preferably at most 58 Å, particularly preferably at most 45 Å, very particularly preferably at most 40 Å, still more preferably at most 38 Å, and/or in the range from 5 Å (Angstrom) to 80 Å, in particular in the range from 7 Å to 70 Å, preferably in the range from 10 Å to 60 Å, preferably in the range from 15 Å to 58 Å, particularly preferably in the range from 17 Å to 45 Å, very particularly preferably in the range from 18 Å to 40 Å, still more preferably in the range from 20 Å to 38 Å.

In addition, the catalyst system according to the invention has defined amounts of catalytically active component, so that the catalytic activity can also be specifically specified from this point of view. In particular, a high overall catalytic activity with simultaneous good accessibility of the catalytically active component can also be ensured on this basis.

Thus, according to the invention, it may be provided that the catalyst system comprises the catalytically active component in amounts of at least 0.05% by weight, in particular at least 0.1% by weight, preferably at least 0.2% by weight, more preferably at least 0.5% by weight, particularly preferably at least 0.6% by weight, most preferably at least 1% by weight, further preferably at least 1.5% by weight, calculated as metal and based on the total weight of the catalyst system.

In particular, the catalyst system may comprise the catalytically active component in amounts of not more than 25% by weight, in particular not more than 20% by weight, preferably not more than 15% by weight, preferably not more than-10% by weight, more preferably not more than 8% by weight, most preferably not more than 7% by weight, calculated as metal and based on the total weight of the catalyst system.

Thus, according to the invention as a whole, it can be provided that the catalyst system contains the catalytically active component in amounts in the range from 0.05 wt. % to 25 wt. %, in particular in the range from 0.1 wt. % to 25 wt. %, preferably in the range from 0.2 wt. % to 20 wt. %, more preferably in the range from 0.5 wt.-% to 15% by weight-, particularly preferably in the range from 0.6% by weight to 10% by weight, most preferably in the range from 1% by weight to 8% by weight, further preferably in the range from 1.5% by weight to 7% by weight, calculated as metal and based on the total weight of the catalyst system.

With regard to the catalyst system according to the invention furthermore, the catalytically active component may comprise or consist of at least one metal, in particular in the form of a metal compound, preferably in the form of an ionic metal compound, and/or in particular in elemental form.

In particular, the catalytically active component may have at least one metal in a positive oxidation state, in particular at least one metal cation, in particular where the oxidation state of the metal is in the range from +I to +VII, in particular in the range from +I to +IV, preferably in the range from +I to +III, and particularly preferably is +I or +II. According to the invention, it is particularly preferred if the catalytically active component comprises at least one metal with an oxidation state of zero.

In particular, the catalytically active component may comprise at least one metal from the main or subgroups of the periodic table of the elements or at least one lanthanide.

In addition, it may be provided according to the invention that the catalytically active component comprises at least one metal selected from elements of main group IV or subgroups I, II, III, IV, V, VI, VII and VIII of the periodic table of the elements, in particular from elements of main group IV or subgroups I and II of the periodic table of the elements.

In this context, it is preferred according to the invention if the catalytically active component comprises at least one metal selected from the group consisting of Cu, Ag, Au, Zn, Hg, Sn, Ce, Ti, Zr, V, Nb, Cr, Mo, W, Mn, Fe, Bi, Ru, Os, Co, Rh, Re, Ir, Ni, Pd and Pt, in particular Fe, Bi, V, Cu, Pb, Zn, Ag, Sn, Pd, Pt, Ru and Ni, preferably Fe, Bi, V, Cu, Pt, Ru and Pb, preferably Pd, Pt and Ru, particularly preferably Pd and Pt. Particularly high catalytic activities can be provided with the aforementioned metals.

With regard to the catalyst system according to the invention, it also behaves in particular in such a way that both the outer and the inner surfaces, in particular the micropores, mesopores and/or macropores, of the activated carbon are equipped with the catalytically active component.

As previously indicated, it may be particularly envisaged in the context of the present invention that the catalyst system has an activity, determined as the percentage degree of dispersion of the catalytically active component, in particular of the metal of the catalytically active component, on the catalyst support, in particular measured by chemisorption by means of a (dynamic) flow method, preferably according to DIN 66136-3:2007-01, of at least 15%, in particular at least 20%, preferably at least 25%, preferably at least 28%, and/or in the range from 15% to 90%, in particular in the range from 20% to 80%, preferably in the range from 25% to 70%, preferably in the range from 28% to 60%.

According to the invention, it can be provided in particular that the catalyst system comprises the catalytically active component with an average crystallite size, preferably determined according to DIN 66136, of at most 80 Å (Angstrom), in particular at most 70 Å, preferably at most 60 Å, preferably at most 58 Å, particularly preferably at most 45 Å, very preferably at most 40 Å, even more preferably at most 38 Å, and/or in the range from 5 Å (Angstrom) to 80 Å, in particular in the range from 7 Å to 70 Å, preferably in the range from 10 Å to 60 Å, preferably in the range from 15 Å to 58 Å, especially preferably in the range from 17 Å to 45 Å, most preferably in the range from 18 Å to 40 Å, even more preferably in the range from 20 Å to 38 Å.

According to the invention, it can be provided in particular that the activated carbon (i.e., the activated carbon forming the catalyst support) is based on an activated carbon which has been oxidized, in particular surface-oxidized, before the application and/or fixing of the catalytically active component and which has been reduced, in particular at its surface, after the application and/or fixing of the catalytically active component. Hereby, with regard to the catalyst system according to the invention, a particularly good equipment with the catalytically active component is achieved, as previously indicated. In particular, correspondingly good degrees of dispersion as well as crystallite sizes are achieved hereby, so that such an activated carbon finds its reflection in the improved properties of the resulting product in the form of the catalyst system according to the invention. As equally indicated above, the reduction carried out can also reduce the content of oxygen-containing functional groups and the hydrophilicity of the activated carbon, which can also be advantageous in particular with regard to the transport properties of reactants or products in the activated carbon system as catalyst support.

In general, according to the invention, it may further be provided that the activated carbon (i.e. the activated carbon forming the catalyst support) is based on an activated carbon which is obtainable by carbonization and subsequent activation of a starting material based on organic polymers, followed by an oxidation (treatment), the oxidation (treatment) having taken place before the application and/or fixing of the catalytically active component, and followed by a reduction (treatment), the reduction (treatment) having taken place after the application and/or fixing of the catalytically active component.

In particular, the activated carbon (i.e. the activated carbon forming the catalyst support) may be based on an activated carbon obtainable by carbonization and subsequent activation of an organic polymer-based starting material, or which is in the form of a polymer-based, preferably spherical (spherical) activated carbon (PBSAC or Polymer-based Spherical Activated Carbon).

Such activated carbons have particularly defined properties with regard to the pore system. In addition, these are activated carbons with high mechanical stability, which is associated, for example, with high abrasion resistance or the like.

In general, the activated carbon can be an activated carbon based on a previously described starting material (cf. also patent claim 21). In particular, the activated carbon can be an activated carbon going back to or based on an activated carbon obtained according to a previously described manufacturing method (cf. patent claims 22 to 25 as well as 30 to 34).

In addition, the catalyst system may be a surface-reduced catalyst system in particular.

Further properties of the activated carbon forming the catalyst support of the catalyst system according to the invention are given below:

In particular, the activated carbon can have a defined total pore volume:
Thus, the activated carbon (i.e. the activated carbon forming the catalyst support) can have a total pore volume (Vₜₒₜₐₗ), in particular a total pore volume according to Gurvich, in the range from 0.9 cm³/g to 3.4 cm³/g, in particular in the range from 1 cm³/g to 2.9 cm³/g, preferably in the range from 1.1 cm³/g to 2.4 cm³/g, preferably in the range from 1.2 cm³/g to 1.9 cm³/g, particularly preferably in the range from 1.5 cm³/g to 1.9 cm³/g.
In addition, it can behave in this context in such a way that 50% to 90%, in particular 52.5% to 87.5%, preferably 55% to 85%, preferably 57.5% to 82.5%, particularly preferably 60% to 80%, of the total pore volume, in particular the total pore volume according to Gurvich, of the activated carbon (i.e., the activated carbon forming the catalyst support) is formed by pores with pore diameters of at least 2 nm, in particular by pores with pore diameters in the range from 2 nm to 500 nm i.e. the activated carbon forming the catalyst support) is formed by pores with pore diameters of at least 2 nm, in particular by pores with pore diameters in the range from 2 nm to 500 nm, preferably by meso- and macropores.
In addition, the activated carbon (i.e. the activated carbon forming the catalyst support) can have a total pore volume (Vₜₒₜₐₗ), in particular a total pore volume according to Gurvich, in the range from 0.8 cm³/g to 3.9 cm³/g, in particular in the range from 0.9 cm³/g to 3.4 cm³/g, preferably in the range from 1 cm³/g to 2.9 cm³/g, preferably in the range from 1.1 cm³/g to 2.4 cm³/g, particularly preferably in the range from 1.2 cm³/g to 1.9 cm³/g, most preferably in the range from 1.5 cm³/g to 1.9 cm³/g, wherein 50% to 90%, in particular 52.5% to 87.5%, preferably 55% to 85%, preferably 57.5% to 82.5%, particularly preferably 60% to 80%, of the total pore volume, in particular the total pore volume according to Gurvich, of the activated carbon are formed by pores with pore diameters of at least 2 nm, in particular by pores with pore diameters in the range from 2 nm to 500 nm, preferably by meso- and macropores.

In addition, the activated carbon forming the catalyst support may also have the following properties:
In particular, the activated carbon (i.e., the activated carbon forming the catalyst support) can have a specific BET surface area (S_{BET}) in the range of 1,100 m²/g to 2,600 m²/g, especially in the range of 1.200 m²/g to 2,400 m²/g, preferably in the range from 1,300 m²/g to 2,200 m²/g, preferably in the range from 1,350 m²/g to 1,950 m²/g, particularly preferably in the range from 1,375 m²/g to 1,900 m/g.²
Furthermore, for the activated carbon (i.e. the activated carbon forming the catalyst support), the ratio (Q) of total pore volume (Vₜₒₜₐₗ), in particular total pore volume according to Gurvich, to specific BET surface area (S_{BET}), in particular according to the equation Q=Vₜₒₜₐₗ/S_{BET}, can be in the range from 0.5*10⁻⁹ m to 1.9*10⁻⁹ m, in particular in the range from 0.55*10⁻⁹ m to 1.9*10⁻⁹ m, preferably in the range from 0.6*10⁻⁹ m to 1.8*10⁻⁹ m, preferably in the range from 0.65*10⁻⁹ m to 1.7*10⁻⁹ m, particularly preferably in the range from 0.65*10⁻⁹ m to 1.6*10⁻⁹ m, most preferably in the range from 0.7*10⁻⁹ m to 1.5*10⁻⁹ m, more preferably in the range from 0.75*10⁻⁹ m to 1.4*10⁻⁹ m, still more preferably in the range from 0.8*10⁻⁹ m to 1.3*10⁻⁹ m.
In addition, the activated carbon (i.e., the activated carbon forming the catalyst support) can have a specific BET surface area (S_{BET}) in the range of 1,000 m²/g to 3,000 m²/g, especially in the range of 1,100 m²/g to 2.600 m²/g, preferably in the range from 1,200 m²/g to 2,400 m²/g, preferably in the range from 1,300 m²/g to 2,200 m²/g, particularly preferably in the range from 1,350 m²/g to 1,950 m²/g, most preferably in the range from 1,375 m²/g to 1.900 m²/g, wherein the ratio (Q) of total pore volume (Vₜₒₜₐₗ), in particular total pore volume according to Gurvich, to specific BET surface area (S_{BET}), in particular according to the equation Q=Vₜₒₜₐₗ/S_{BET}, is in the range from 0.5*10⁻⁹ m to 1.9*10⁻⁹ m, in particular in the range from 0.55*10⁻⁹ m to 1.9*10⁻⁹ m, preferably in the range from 0.6*10⁻⁹ m to 1.8*10⁻⁹ m, preferably in the range from 0.65*10⁻⁹ m to 1.7*10⁻⁹ m, particularly preferably in the range from 0.65*10⁻⁹ m to 1.6*10⁻⁹ m, most preferably in the range from 0.7*10⁻⁹ m to 1.5*10⁻⁹ m, more preferably in the range from 0.75*10⁻⁹ m to 1.4*10⁻⁹ m, still more preferably in the range from 0.8*10⁻⁹ m to 1.3*10 m⁻⁹.

Furthermore, the activated carbon used as a catalyst support may also have the following properties:
Thus, the activated carbon (i.e., the activated carbon forming the catalyst support) may have an average pore diameter of at least 15 nm and/or an average pore diameter of at most 100 nm.
In this regard, the activated carbon (i.e., the activated carbon forming the catalyst support) may have an average pore diameter in the range of 15 nm to 100 nm, particularly in the range of 16 nm to 90 nm, preferably in the range of 17 nm to 85 nm, preferably in the range of 18 nm to 80 nm, more preferably in the range of 20 nm to 70 nm, most preferably in the range of 22 nm to 60 nm, further preferably in the range of 25 nm to 50 nm.
In the context of the present invention, the activated carbon (i.e., the activated carbon forming the catalyst support) may be spherical. In particular, the activated carbon may be in the form of a spherical activated carbon.
In addition, the activated carbon (i.e., the activated carbon forming the catalyst support) may have a particle size, in particular a particle diameter, in the range from 60 μm to 1,000 μm, in particular in the range from 70 μm to 800 μm, preferably in the range from 80 μm to 600 μm, preferably in the range from 100 μm to 400 μm, particularly preferably in the range from 150 μm to 375 μm, most preferably in the range from 175 μm to 250 μm. In particular, it may be provided in this context that at least 80% by weight, in particular at least 90% by weight, preferably at least 95% by weight, of the activated carbon particles, in particular activated carbon particles, have particle sizes, in particular particle diameters, in the aforementioned ranges.
In particular, the activated carbon (i.e., the activated carbon forming the catalyst support) may have a mean particle size (D50), especially a mean particle diameter (D50), in the range from 60 μm to 900 μm, especially in the range from 75 μm to 750 μm, preferably in the range from 85 μm to 550 μm, preferably in the range from 110 μm to 375 μm, more preferably in the range from 175 μm to 350 μm, most preferably in the range from 185 μm to 225 μm.
In addition, the activated carbon (i.e., the activated carbon forming the catalyst support) may have a ball pan hardness and/or abrasion hardness of at least 90%, in particular at least 95%, preferably at least 97%, more preferably at least 98%, especially preferably at least 99%, most preferably at least 99.5%, further preferably at least 99.8%.
In addition, the activated carbon (i.e., the activated carbon forming the catalyst support) may have a compressive and/or bursting strength (weight loading capacity) per activated carbon grain, in particular per activated carbon globule, of at least 5 Newtons, in particular at least 10 Newtons, preferably at least 15 Newtons, preferably at least 20 Newtons, particularly preferably at least 22.5 Newtons.
In particular, the activated carbon (i.e., the activated carbon forming the catalyst support) may have a compressive and/or bursting strength (weight loading capacity) per activated carbon grain, in particular per activated carbon globule, in the range of 5 to 50 Newtons, in particular 10 to 45 Newtons, preferably 15 to 40 Newtons, preferably 17.5 to 35 Newtons.
Similarly, the activated carbon (i.e., the activated carbon forming the catalyst support) may have a shake or tamped density in the range of 100 g/l to 1,500 g/l, particularly 125 g/l to 1,000 g/l, preferably 150 g/l to 800 g/l, preferably 200 g/l to 600 g/l, more preferably 225 g/l to 500 g/l, most preferably 250 g/l to 400 g/l, further preferably 255 g/l to 395 g/l.
In addition, the activated carbon (i.e., the activated carbon forming the catalyst support) may have a bulk density in the range of 150 g/l to 1,000 g/l, in particular from 250 g/l to 700 g/l, preferably 300 g/l to 600 g/l, preferably 300 g/l to 550 g/l.

Still further, the activated carbon forming the catalyst support may have the following properties:
Thus, the activated carbon (i.e., the activated carbon forming the catalyst support) may have a butane adsorption of at least 35%, in particular at least 40%, preferably at least 45%, preferably at least 47.5%, and/or wherein the activated carbon has a butane adsorption in the range of 35% to 90%, in particular in the range of 40% to 85%, preferably in the range of 45% to 80%, preferably in the range of 47.5% to 75%.
In addition, the activated carbon (i.e. the activated carbon forming the catalyst support) may have an iodine value of at least 1,250 mg/g, in particular at least 1,300 mg/g, preferably at least 1,400 mg/g, preferably at least 1.425 mg/g, and/or wherein the activated carbon has an iodine value in the range from 1,250 mg/g to 2,100 mg/g, in particular in the range from 1,300 mg/g to 2,000 mg/g, preferably in the range from 1,400 mg/g to 1,900 mg/g, preferably in the range from 1,425 mg/g to 1,850 mg/g.
Furthermore, the activated carbon (i.e. the activated carbon forming the catalyst support) may have a methylene blue value of at least 17 ml, in particular at least 18 ml, preferably at least 19 ml, preferably at least 19.5 ml, and/or wherein the activated carbon has a methylene blue value in the range from 17 ml to 65 ml, in particular in the range from 18 ml to 55 ml, preferably in the range from 19 ml to 50 ml, preferably in the range from 19.5 ml to 47.5 ml.
In addition, the activated carbon (i.e., the activated carbon forming the catalyst support) may have a molasses number of at least 255, in particular at least 310, preferably at least 375, preferably at least 510, and/or wherein the activated carbon has a molasses number in the range of 255 to 1,500, in particular in the range of 310 to 1,400, preferably in the range of 375 to 1,300, preferably in the range of 510 to 1,250.
In addition, the activated carbon (i.e., the activated carbon forming the catalyst support) may have a methylene blue value of at least 17 ml, in particular at least 18 ml, preferably at least 19 ml, more preferably at least 20 ml.
Further, activated carbon may have a methylene blue value in the range of 17 ml to 65 ml, particularly in the range of 18 ml to 55 ml, preferably in the range of 19 ml to 50 ml, more preferably in the range of 20 ml to 47.5 ml.
In addition, the activated carbon (i.e., the activated carbon forming the catalyst support) may have a weight-based adsorbed N₂ volume V_{ads (wt)}, determined at a partial pressure p/p₀ of 0.25, of at least 250 cm³/g, in particular at least 300 cm³/g, preferably at least 350 cm³/g, preferably at least 375 cm³/g. In this regard, the activated carbon may have a weight adsorbed N₂ volume V_{ads (wt)}, determined at a partial pressure p/p₀ of 0.25, ranging from 250 cm³/g to 850 cm³/g, in particular ranging from 300 cm³/g to 700 cm³/g, preferably ranging from 350 cm³/g to 650 cm³/g, preferably ranging from 375 cm³/g to 625 cm³/g.
Similarly, the activated carbon (i.e., the activated carbon forming the catalyst support) may have a volume-based adsorbed Ny volume V_{ads (vol.)}, determined at a partial pressure p/p₀ of 0.25, of at least 50 cm³/cm³, in particular at least 100 cm³/cm³, preferably at least 110 cm³/cm³. In this context, the activated carbon may have a volume-based adsorbed N₂ volume Vads_{(vol.)}, determined at a partial pressure p/p₀ of 0.25, ranging from 50 cm³/cm³ to 300 cm³/cm³, in particular ranging from 80 cm³/cm³ to 275 cm³/cm³, preferably ranging from 90 cm³/cm³ to 250 cm³/cm³, preferably ranging from 95 cm³/cm³ to 225 cm³/cm³.
In addition, the activated carbon (i.e., the activated carbon forming the catalyst support) may have a weight-based adsorbed N₂ volume V_{ads (wt.)}, determined at a partial pressure p/p₀ of 0.995, of at least 300 cm³/g, particularly at least 450 cm³/g, preferably at least 475 cm³/g. In this context, the activated carbon may have a weight adsorbed N₂ volume V_{ads (wt.)}, determined at a partial pressure p/p₀ of 0.995, ranging from 300 cm³/g to 2.300 cm³/g, in particular in the range from 400 cm³/g to 2,200 cm³/g, preferably in the range from 450 cm³/g to 2,100 cm³/g, preferably in the range from 475 cm³/g to 2,100 cm³/g.
In particular, the activated carbon (i.e., the activated carbon forming the catalyst support) can have a volume-related adsorbed N₂ volume Vads_{(vol.)}, determined at a partial pressure p/p₀ of 0.995, of at least 200 cm³/cm³, in particular at least 250 cm³/cm³, preferably at least 275 cm³/cm³, preferably at least 295 cm³/cm³. In this context, the activated carbon may have a volume-based adsorbed N₂ volume Vads_{(vol.)} determined at a partial pressure p/p₀ of 0.995, ranging from 200 cm³/cm³ to 500 cm³/cm³, in particular ranging from 250 cm³/cm³ to 400 cm³/cm³, preferably ranging from 275 cm³/cm³ to 380 cm³/cm³, preferably ranging from 295 cm³/cm³ to 375 cm³/cm³.
With regard to the activated carbon further used according to the invention, the activated carbon (i.e., the activated carbon forming the catalyst support) may have a fractal dimension of open porosity in the range of 2.6 to 2.99, in particular 2.7 to 2.95, preferably 2.8 to 2.95, and/or wherein the activated carbon has a fractal dimension of open porosity of at least 2.7, in particular at least 2.8, preferably at least 2.85, preferably at least 2.9.

Within the scope of the present invention, an efficient catalyst system is thus provided overall, which has overall improved catalytic properties, as previously indicated. Also from this point of view, the catalyst systems according to the invention lead, for example, to a considerable shortening of the method time underlying a catalysis, in particular also with regard to discontinuous catalysis methods, with correspondingly high standstill or operating times being available, and this also due to the excellent mechanical stability of the catalyst system according to the invention. In addition, the use of the catalyst system according to the invention goes hand in hand with a simplified dosing and with a significantly lower cleaning effort of the underlying apparatus, minimized material losses and, in general, simplified handling. In addition, the catalyst systems according to the invention can be reused or recycled in a simple manner after appropriate reactivation of the catalyst. In particular, the defined pore system of the activated carbon used as support material according to the invention leads to a significant improvement of the activity, both with regard to an improvement of the transport methods of reactants or products and with regard to the equipment with the catalytically active component. Overall, the properties of the catalyst system according to the invention are also of great importance against the background of the cost-intensiveness of catalysts, since the catalyst systems according to the invention can be accompanied by considerable cost savings due to their properties.

In addition to use in discontinuous methods, the catalyst system according to the invention is also eminently suitable for use in continuous catalytic applications, whereby the catalyst systems according to the invention can, for example, be filled into corresponding reaction vessels or reactors and continuously flowed through with a medium containing reactants or reactants, whereby only low pressure losses with correspondingly high flow rates can be realized within the scope of use.

The catalyst system according to the invention has a wide range of applications: In addition to its use in catalysis, in particular on a (large) industrial scale, the catalyst system according to the invention is also suitable for (ad-)sorptive applications, for example for the removal of toxic substances such as pollutants or toxins, in particular due to its combined properties of chemisorption on the one hand and physisorption on the other.

Due to the in particular spherical shape, the outstanding mechanical properties of the underlying activated carbon material in the form of PBSAC and the present adjustable setting of the porosity, in particular with regard to the provision of a high meso- and macroporosity, the catalyst systems according to the invention are also of high importance in particular for continuous catalysis (i.e. for continuous reaction control in catalysis).

The catalyst systems according to the invention are in particular supported noble metal catalysts or metal catalysts supported by activated carbon. As previously indicated, polymer-based spherical high-performance adsorbents in particular, which can generally consist of more than 99% by weight carbon, serve as the basis for this, with the activated carbon thereby serving as the catalyst support. As previously described with regard to the method according to the invention, the catalyst support is pretreated by an oxidative method (before being equipped with the catalytically active component). In this method, the proportions of volatile components can vary in a range from 0.1 wt % to 15 wt %. With regard to the method according to the invention described above, in a further method step the catalyst support can be loaded, in particular by means of various impregnation technologies, preferably with noble metals as the catalytically active component. The impregnation level can thereby vary, for example, in a range from 0.05 wt. % to 20 wt. %. After immobilization of the catalytically active component or the noble metal ions relating thereto on the surface of the catalyst support, the metal ions can be converted in a reductive step. The reduction, which can also lead to a surface reduction of the activated carbon, can in particular take place either in the liquid phase or in the gas phase. On this basis, the catalyst systems according to the invention described above can thus be obtained.

With respect to the embodiment of the catalyst system according to the present aspect, reference may also be made to the explanations regarding the further aspects according to the invention, which apply accordingly.

A further object of the present invention—according to a third aspect of the present invention—is further to provide uses of the catalyst system according to the invention:

Thus, the catalyst system according to the invention can be used in particular as a catalyst or catalyst support. Moreover, the catalyst system according to the invention can be used in particular for chemical catalysis, in particular for heterogeneous catalysis, and/or for discontinuous catalysis or for continuous catalysis (i.e. continuous reaction control in catalysis).

Similarly, the catalyst system according to the invention can be used for catalyzing chemical methods and reactions, in particular hydrogenation reactions or oligomerization and polymerization reactions, preferably of olefins. Preferably, the catalyst system according to the invention can be used for catalyzing hydrogenation reactions. In particular, the catalyst system according to the invention can be used for hydrogenation of various functional groups. For example, the catalyst system according to the invention can be used for catalytic conversion or conversion of nitro groups to amine groups. Furthermore, the catalyst system according to the invention can be used for deprotection.

Furthermore, the catalyst system according to the present aspect can also be used for the production of filters and filter materials, in particular for the removal of pollutants, odors and toxins, in particular from air and/or gas streams, such as NBC protective mask filters, odor filters, surface filters, air filters, in particular filters for room air purification, adsorbable support structures and filters for the medical field.

In addition, the catalyst system according to the invention can be used as a sorption reservoir for gases or liquids.

Similarly, the catalyst system can be used in or as gas sensors or in fuel cells.

In addition, the catalyst system according to the invention can be used for sorptive applications, in particular adsorptive or chemisorptive applications, preferably chemisorptive applications, in particular as a preferably reactive and/or catalytic adsorbent.

Furthermore, the catalyst system according to the invention can be used for gas purification and/or gas treatment.

Furthermore, the catalyst system according to the invention can be used for the removal of pollutants, in particular gaseous pollutants, or substances or gases that are harmful to the environment, health or toxicity.

Furthermore, the catalyst system according to the invention can be used for the production and/or provision of clean room atmospheres, in particular for the electrical industry, especially for semiconductor or chip production.

Furthermore, the present invention relates—according to a fourth aspect of the present invention—to protective materials, in particular for civilian or military use, in particular protective clothing, such as protective suits, protective gloves, protective footwear, protective socks, protective headgear, as well as protective covers, preferably all of the aforementioned protective materials for NBC use, which are produced using the catalyst system according to the invention or which have the catalyst system according to the invention.

In addition, a further object of the present invention—according to a fifth aspect of the present invention—are filters and filter materials, in particular for the removal of pollutants, odors and toxic substances of all kinds, in particular from air or gas streams, such as NBC protective mask filters, odor filters, surface filters, air filters, in particular filters for room air purification, adsorption-capable and/or chemisorption-capable carrier structures and filters for the medical field, produced using the previously defined catalyst system according to the invention or comprising the previously defined catalyst system according to the invention.

As far as the filters and filter materials according to the invention are concerned, the catalyst system used in this respect may be self-supporting or may be in the form of a bulk material, in particular a loose bulk material. In addition, the catalyst system may be applied to a support material.

As regards the explanations relating to the third to fifth aspects of the present invention, reference may also be made in this respect to the further explanations according to the first and second aspects of the present invention, and the explanations relating thereto apply accordingly.

The present invention is also described with reference to further drawings and/or figure representations, whereby the explanations in this respect apply to all aspects according to the invention and whereby the explanations in this respect are in no way limiting. With respect to the drawings or figure representations, reference can also be made to the following explanations in the embodiment examples.

In the figure representations shows:

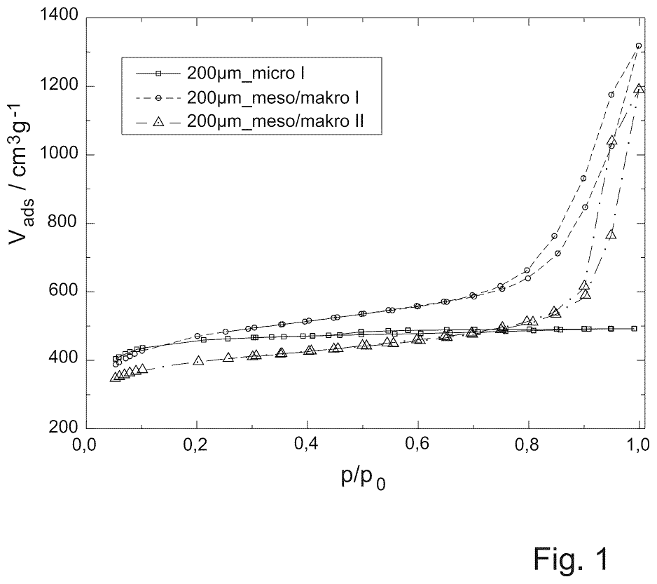

FIG. 1 a diagram of the nitrogen isotherms of various catalyst supports or activated carbons used in this connection to determine the porosity;

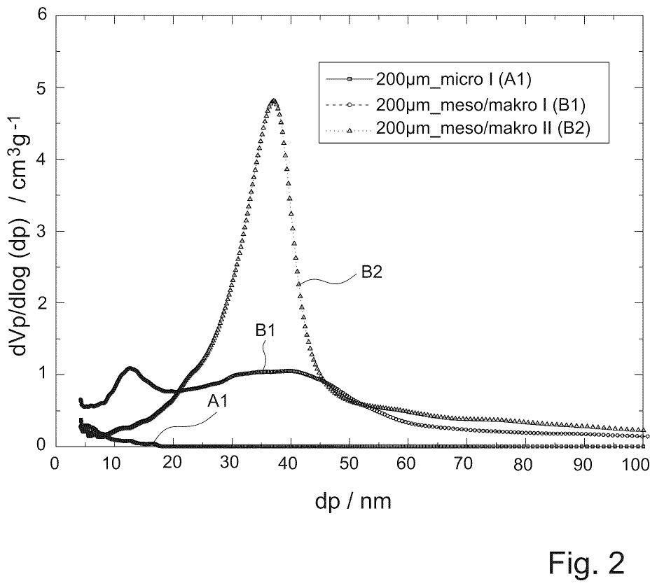

FIG. 2 a diagram of the mercury intrusion curves of various catalyst supports or activated carbons used in this connection for further determination of the porosity;

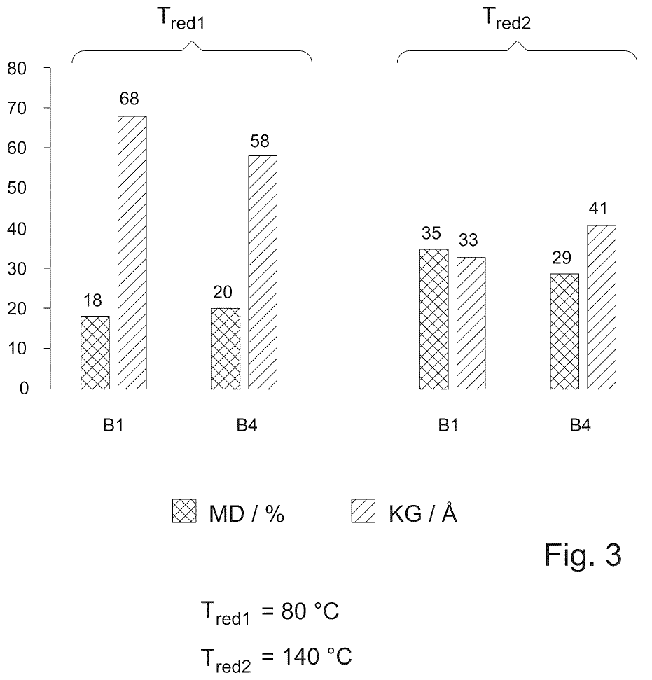

FIG. 3 a diagrammatic representation of the values determined for different catalyst systems for the dispersion as well as the crystallite size of the catalytically active component or the metal in question (5 wt. % palladium catalyst);

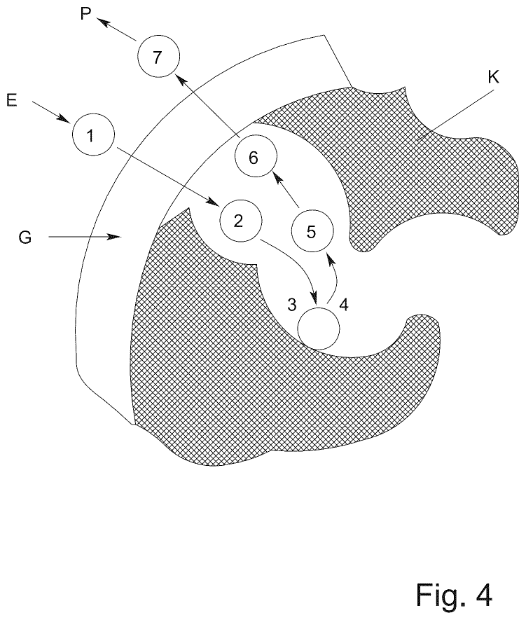

FIG. 4 a schematic representation of the kinetics underlying heterogeneous catalysis based on substeps comprising the first step (1) of diffusion of reactants (E) to the surface of the catalyst (K) through the stationary boundary layer (G); the second step (2) of diffusion of reactants (E) into the pores of the catalyst (K) to the catalytically active center or to the catalytically active component; with the third step (3) of adsorption of the reactants (E) on the active center; with the fourth step (4) of reaction of the reactants (E) on the active center to obtain products (P) thereof; with the fifth step (5) of desorption of the products (P) from the active center; with the sixth step (6) of diffusion of the products (P) through the pore system of the catalyst (K) and with the seventh step (7) of diffusion of the products (P) through the boundary layer (G) to the external region and removal of the products (P);

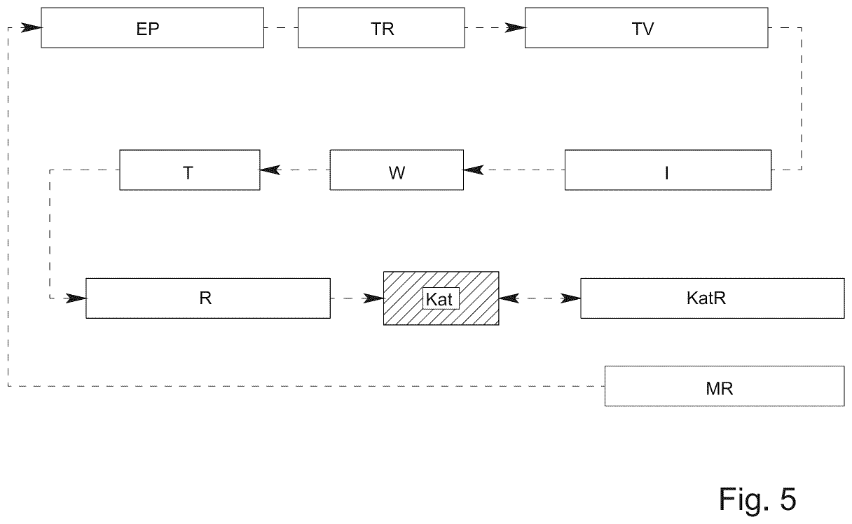

FIG. 5 a schematic representation of a method sequence according to one embodiment of the present invention [with EP=precious metal precursor, TR=PBSAC carrier, TV=carrier pretreatment (e.g., oxidation with mineral acids or air oxidation), I=impregnation (e.g., dip impregnation or spray impregnation), W=washing, T=drying, R=reduction (e.g., gas phase or liquid phase reduction), Cat=catalyst, CatR=catalyst reactivation, MR=metal recovery];

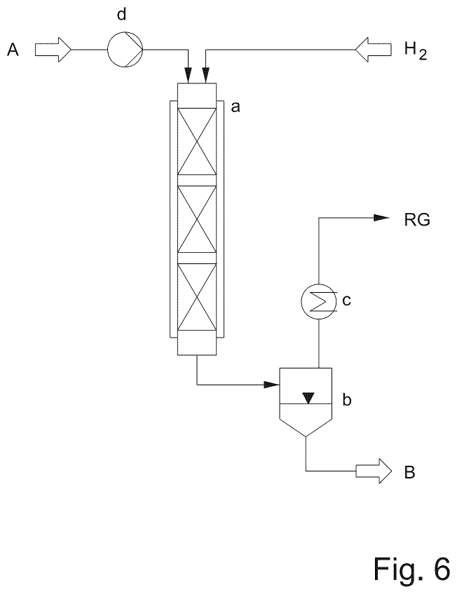

FIG. 6 a schematic representation of a device based on a fixed-bed reactor used for heterogeneous catalysis, in particular hydrogenation;

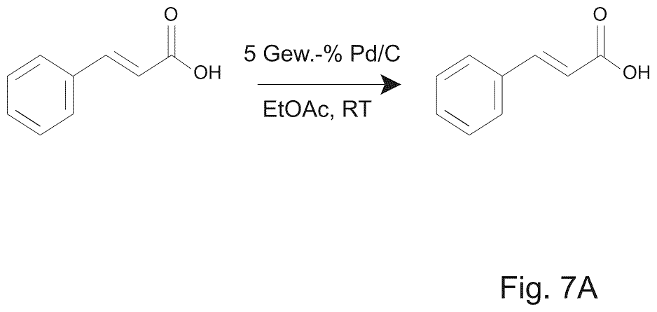

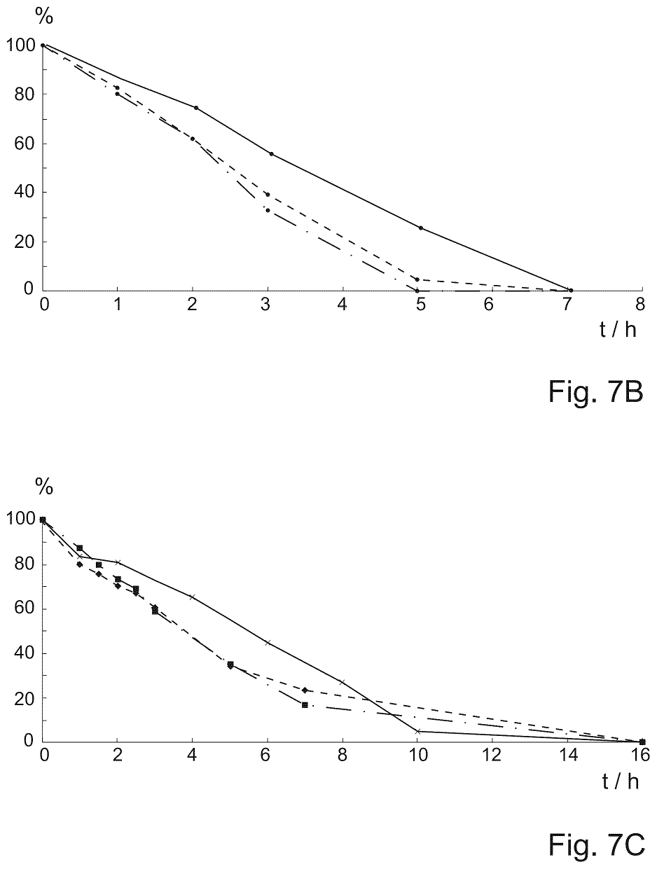

FIG. 7A a reaction underlying the hydrogenation of cinnamic acid using the catalyst system according to the invention;

FIG. 7B a diagram showing the time course of the catalytic conversion (hydrogenation) of cinnamic acid as a reactant by means of various catalyst systems according to the invention using activated carbon as a catalyst support with a high proportion of mesopores and macropores in the total pore volume of the activated carbon (mesoporous and macroporous activated carbon);

FIG. 7C a diagram showing the time course of the catalytic conversion (hydrogenation) of cinnamic acid by means of various catalyst systems using activated carbon as the catalyst support with a high proportion of micropores in the total pore volume of the relevant activated carbon (microporous activated carbon).

Further embodiments, modifications and variations as well as advantages of the present invention are readily apparent and realizable to those skilled in the art upon reading the description without departing from the scope of the present invention.

The following embodiments are merely illustrative of the present invention, but without limiting the present invention thereto.

### EXAMPLES

### 1. Introduction

The use of special polymer-based spherical activated carbons (spherical or spherical PBSAC) with defined porosity, in particular with regard to a high meso- or The use of special polymer-based spherical activated carbons (spherical or spherical PBSAC) with defined porosity, in particular with regard to high meso- or macroporosity and simultaneously defined micropore content, as catalyst support material, offers the advantage in the context of the conception according to the invention that, on the one hand, optimum transport methods for reactants/products and, on the other hand, optimum equipment of the activated carbon with catalytically active components are made possible, so that overall a high catalytic activity, in particular accompanied by high conversions and high space/time yields, is available for the catalyst systems according to the invention. In addition, the lowest pressure losses can be realized due to the preferred spherical shape compared to adsorbents of the same size but different shape. In addition, due to the low dust content and high mechanical loading capacity of the PBSAC, the likelihood of metal-laden dust or fragments being discharged in the product flow during application in the fixed-bed bulk is minimized.

### 2. Production of the Catalyst Supports

### a) Highly Microporous Catalyst Supports (not According to the Invention)

The polymer-based spherical activated carbons (PBSAC) are produced in a three-step batch method. The method includes a sulfonation step for thermal stabilization of the polymeric raw material used, a carbonization step for removal of volatile components and an activation step for formation of the inner pore system using water as oxidant. A rotary tube reactor is used for the necessary method steps. The reactor is indirectly electrically heated in a rotary kiln.
A crosslinked styrene-divinylbenzene polymer (gel type in the H⁺ form) from Lanxess is used as the raw material or starting material for the production of the highly microporous PBSAC (Lewapol D60). It is polystyrene with 4 wt % divinylbenzene as crosslinker. The polymer raw material already has a spherical morphology, which is transferred to the resulting PBSAC. The raw material shows a particle diameter distribution in the range of 0.08 mm to 0.7 mm.
Sulfonation represents the step of stabilizing the polymer for subsequent carbonization. For this purpose, a mixture of oleum (sulfuric acid fuming, 25% free SO₃) and sulfuric acid (96 vol. %) is added to the polystyrene in a mass ratio of 2:1 at room temperature and heated to the sulfonation temperature of 423 K. The mixture is then reacted with the sulfuric acid.
In the second step of the production of activated carbon, namely carbonization, volatile components are expelled in a temperature range from 423 K to 1223 K. The carbonization method can be divided into two steps. Carbonization can be divided into two steps. In the temperature range up to 823 K, in addition to other volatile components, in particular water and sulfur compounds are expelled. In the temperature range up to 1223 K, mainly hydrocarbons and hydrogen are expelled (390 min activation time). Particle shape and particle diameter do not change after carbonization and correspond to those of the resulting PBSAC.
In the third step of the production of activated carbon, namely activation, the carbonizate is activated at about 1223 K in a water vapor atmosphere (120 kg of liquid water and two standard cubic meters of nitrogen per hour).

### b) Meso- and Macroporous Catalyst Support (According to the Invention)

For the production of the meso- and macroporous PBSAC, the method steps described in section 2.a) are followed. Similarly, Lewapol D60 from Lanxess is used as the raw material or starting material for the production of the meso/macroporous PBSAC. However, the sulfonation of the crosslinked styrene-divinylbenzene polymer is carried out exclusively with sulfuric acid (96 vol. %). The ratio of polymer to sulfonating agent is kept constant. The catalyst support is activated for 450 min. The resulting PBSACs exhibit an increased mesopore content of greater than 25%. The textural data can be taken from Table 1.
   c) Meso- and Macroporous Catalyst Support Based on Macroporous Sulfonated Ion Exchange Resins with High Macroporosity (According to the Invention)
For the production of PBSACs based on macroporous ion exchange resins, the method steps described in section 2.a) are followed. A sulfonated cross-linked styrene-divinylbenzene polymer (H⁺ form) from Finex Oy is used as the raw material or starting material for the production of the PBSAC based on the macroporous ion exchangers (Finex CS16GC). Since the acidic macroporous ion exchangers are already protected, the sulfonation step can be omitted (150 min activation time). The resulting PBSAC exhibit a high mesopore content, as well as a defined proportion of macropores. The textural data can be taken from Table 1. Alternatively, corresponding unsulfonated raw materials or starting materials can be assumed. In this case, for example, a crosslinked styrene-divinylbenzene polymer from Finex Oy can be used (Finex PS08G). Sulfonation can be carried out as described in section 2.a).

### 3. Characterization of the Catalyst Supports or Catalyst Systems

### a) Nitrogen Isotherms for the Determination of the Textural Data in the Micropore Area.

To determine the textural data of the catalyst supports, nitrogen isotherms are recorded on the various catalyst supports. This is done with a Quadrasorb from Quantachrome. The specific internal surface area is determined using a Brunauer-Emmett-Teller (BET) mathematical model. The total pore volume or total pore volume is calculated using the Gurvich rule and the micropore volume is determined using the carbon black method.
For measurement production, the catalyst supports are pretreated at 200° C. in a vacuum, in particular for the purpose of removing any adsorbed molecules.

### b) Mercury Intrusion to Determine the Textural Data in the Mesopore and Macropore Region.

The samples are dried for 2 h at 150° C. in a drying oven and then measured on a Poremaster-60GT from Quantachrome. To convert the pressure into the pore size, the literature value for the contact angle of mercury on carbon is calculated (155°).

### c) Determination of the Elemental Composition of the Catalyst Supports by Photoelectron Spectroscopy (XPS).

The samples are analyzed without pretreatment by photoelectron spectroscopy (ESCA/XPS). For XPS analysis, the measurement is performed using a Thermo VG Scientific type K-Alpha instrument. Monochromatic AlKα X-rays are used for excitation (typically ˜75 W, 400 μm spot size). The transmission function as well as the energy position is determined following ISO 15472:2001 and ISO 21270:2004 on copper, silver and gold reference samples. The following settings are used for the measurement of the spectra: Survey spectra with a pass energy of 80 eV, high resolution spectra with 30 eV. Quantitative information about the surface composition is calculated using Scofield factors on survey measurements assuming that the analyzed volume is homogeneous. The error can be estimated to be about 10%.

### d) Determination of the Degree of Dispersion and Size of the Active Sites by Means of CO Chemisorption (Determination of the Specific Metal Surface or Dispersion and the Crystallite Size of the Catalytically Active Component)

Determination of monolayer capacity, degree of dispersion, active surface according to DIN 66136-1, DIN 66136-3: flow method (dynamic), measuring gases e.g. H₂, CO, CO₂; planned experimental program: H₂-treatment 10 K/min to 80° C., 4 h isothermal; CO titration at 50° C., then TPR 5 Kmin-1 to 250° C. with 5% H₂/Ar; finally CO titration at 50° C.
In particular, you can proceed as follows:
Normative basis: DIN 66136-1 (basics) and DIN 66136-2 (volumetric method)
The following steps are recommended or performed for sample production and reduction of the sample surface:
(i) Evacuate at 100° C. for 30 min;
(ii) Oxygen flow at 100° C. for 5 min
(iii) Oxygen flow and temperature increase at 10° C./min to 350° C.;
(iv) Oxygen flow at 350° C. for 30 min;
(v) Evacuate at 350° C. for 15 min;
(vi) Evacuate at 100° C. for 15 min;
(vii) Hydrogen flow at 100° C. for 5 min;
(viii) Hydrogen flow and temperature increase at 10° C./min to 350° C.;
(ix) Hydrogen flow at 350° C. for 120 min;
(x) Evacuate at 350° C. for 30 min;
(xi) Evacuate at 100° C. for 15 min
This is followed by the measurement of a CO isotherm at 40° C. using a static-volumetric method to determine the active metal surface or metal dispersion.
The first isotherm measured after step (xi) may represent a superposition of both strongly and weakly chemisorbed gas fractions (combined chemisorption). If it is necessary to distinguish between the two fractions, the following procedure is recommended or followed: After the last isotherm point has been measured, the measuring cell can be evacuated at the analysis temperature (40° C.) for 60 minutes. This removes the weakly bound portion, whereas the strongly chemisorbed portion remains on the sample surface. A subsequent repetition of the isotherm measurement allows the weakly chemisorbed fraction to be determined (weak chemisorption). The difference between the two isotherms gives the amount of strongly chemisorbed CO.
Assuming that a CO molecule chemisorbs at exactly one surface-exposed metal atom (palladium atom) of the catalytically active component (stoichiometry=1), the number of surface-exposed palladium atoms or metal atoms can be inferred from the amount of chemisorbed CO.
This provides an indication of the size of the active metal surface area in m² per g (m²/g) (sample mass).
Using the metal loading of the sample, known as the mass of palladium in g/g sample, further characteristics or properties can be calculated:
   Active metal surface in m²/g (metal);
   Dispersity of the metal in %; and
   Mean crystallite diameter of the metal clusters.
The same procedure can be followed for other metals.

### 4. Properties of the Catalyst Supports

The properties of the respective catalyst supports differ to the greatest possible extent with regard to their textural characteristics. To determine the textural data, nitrogen isotherms of the respective PBSAC are recorded. The results obtained in this respect are shown in FIG. 1, where in the legend the respective figure “200 μm” refers to the mean particle diameter of the activated carbon investigated in each case. The diagram according to FIG. 1 shows the nitrogen adsorption V_{ads} as a function of the relative pressure p/p₀ for the activated carbons investigated.
Characteristic of highly microporous materials is a sharp rise in the isotherm, associated with a high volume uptake of nitrogen, at low relative pressures. As shown in FIG. 1, the isotherm runs almost flat in the further relative pressure range and shows no pronounced hysteresis loop. The isotherm of the material “200 μm_micro I” (catalyst support or activated carbon A1, not according to the invention) shows such a course, so that the material in question can be described as strongly microporous. In addition, the proportion of the microporous volume to the total volume is very high at 89%.
The isotherm of the material “200 μm_meso/makro I” (catalyst support or activated carbon B1, according to the invention) shows a strong increase at a relative pressure of 0.75 as shown in FIG. 1. Furthermore, the isotherm exhibits a pronounced hysteresis loop. These two properties and the micropore content of only 61% prove the high mesopore or macropore content.
When using macroporous ion exchange resins for the production of PBSAC, part of the macroporosity of the polymer is transferred to the resulting activated carbon. This can be seen from the nitrogen isotherm of the material “200 μm_meso/makro II” (catalyst support or activated carbon B2, according to the invention); only at a relative pressure of 0.85 does the isotherm and thus the nitrogen uptake increase sharply (FIG. 1). A pronounced hysteresis loop and the proportion of micropore volume of only 25% prove the presence of pores larger than 2 nm and thus of mesopores and macropores.
The characterization of pores larger than 2 nm can be realized by mercury intrusion. FIG. 2 shows the mercury intrusion curves of the catalyst supports. The diagram representation according to FIG. 2 shows the mercury intrusion dVp/dlog (dp) for the underlying pore diameter dp of the investigated activated carbons.
Here it is clear that the microporous catalyst support or activated carbon A1 (“200 μm_micro I”) has no pore volume above 2 nm. The meso/macroporous catalyst support or activated carbon B1 (“200 μm_meso/makro l”) shows a significant pore volume in the range of 10 nm to 20 nm. The further meso/macroporous catalyst support or activated carbon B2 (“200 μm_meso/macro II”) also exhibits a very large proportion of mesopores and a significant proportion of macropores. The textural data can be taken from Table 2.
The chemical composition and the high purity of the activated carbons in the form of PBSAC are retained and are comparable in all cases. Likewise, the high mechanical stability of the activated carbons in the form of PBSAC is maintained, and this even with high porosity and a high proportion of pores larger than 2 nm (cf. “200 μm_meso/macro l” (B1) and “200 μm_meso/macro II” (B2)). The high mechanical stability is illustrated by the high abrasion hardness of the materials of over 98% (cf. Table 1).
Table 1 below illustrates the corresponding properties of the activated carbons or catalyst supports investigated.

TABLE 1
Properties of the catalyst supports.

| | | B1 | B2 | C1 | C2 |
|---|---|---|---|---|---|
| | A1 | 200 μm | 200 μm | Active- | Active- |
| | 200 μm | meso/ | meso/ | carbon | carbon |
| | micro I* | macro I | macro II | 1 ** | 2 ** |
| Ratio (quotient Q) | 0.44- | 0.85- | 1.24- | 0.45- | 0.57- |
| Vₜₒₜₐₗ/S_{BET} | 10⁻⁹ | 10⁻⁹ | 10⁻⁹ | 10⁻⁹ | 10⁻⁹ |
| Specific surface | 1.747 | 1.881 | 1.478 | 1.162 | 1.074 |
| area (BET)/m² g⁻¹ | | | | | |
| Pores volume | 0.76 | 1.59 | 1.84 | 0.52 | 0.61 |
| (Gurvich)/cm³ g⁻¹ | | | | | |
| Micropore volume/% | 89 | 38 | 25 | 90 | 69 |
| Iodine value | 1.650 | 1.652 | 1.441 | — | — |
| (CEFIC)/mg g⁻¹ | | | | | |
| Vibration density/ | 562 | 319 | 282 | — | — |
| gL⁻¹ | | | | | |
| Abrasion hardness/% | 99.8 | 99.9 | 98.8 | — | — |
| Pores volume per | 0.43 | 0.85 | 1.24 | 0.48 | 0.57 |
| 1000 m² surface/ | | | | | |
| cm³ | | | | | |

* A1: not according to the invention
** C1, C2: commercially available coconut shell-based activated carbons; (not according to the invention).

TABLE 2
Textural properties (Hg intrusion, evaluation range 0.01 μm to 20 μm)

| | | B1 | B2 |
|---|---|---|---|
| | A1 | 200 μm | 200 μm |
| | 200 μm | meso/ | meso/ |
| | micro I* | macro I | macro II |
| Specific pore | 0.005 | 0.81 | 1.17 |
| volume/cm³ g⁻¹ | | | |
| Mean pore diameter/nm | 1.8 | 29 | 36 |

In a corresponding manner, further catalyst supports or activated carbons are provided, namely the catalyst supports or activated carbons A2 (200 μm micro II; mean particle diameter 200 μm) and A3 (370 μm micro III; mean particle diameter 370 μm) not according to the invention, which are essentially comparable to catalyst support A1 with regard to their respective properties in the form of the parameters listed in Tables 1 and 2. In addition, further catalyst supports or activated carbons are provided, namely the catalyst supports B3 (“370 μm meso/macro III”; mean particle permeability 370 μm) and B4 (“470 μm meso/macro III”; mean particle permeability 470 μm) used in accordance with the invention, which are essentially comparable to the catalyst support B1 and B2 in terms of their other properties in the form of the parameters listed in Tables 1 and 2.

### 5. Oxidative Pretreatment of the Catalyst Supports

The oxidative pretreatment of the materials in the form of the catalyst supports or activated carbons serves to create oxygen centers on the surface of the respective PBSAC. These subsequently interact with the metal ions of the salt solution. Due to the electrostatic interaction of the surface oxides with the metal ions, these are immobilized on the surface and preferentially migrate into the pores of the PBSAC instead of remaining in the supernatant solution.
   a) Oxidation with Oxygen
For oxidation of the PBSAC, synthetic air is passed through a heatable, gas-tight fused silica reactor. For surface modification, typically 250 g of PBSAC is placed in the fused silica tube, the tube is installed in the furnace and all gas connections are attached. Typically, the furnace is heated to the reaction temperature with a ramp of 10 K min⁻¹. The reaction temperature is within a window of 350° C. to 550° C. The reaction time varies in a range from 120 min to 600 min.
   b) Oxidation with Mineral Acids and Hydrogen Peroxide
Oxidation with mineral acids is carried out by wet chemical means. The mineral acids are mainly hydrochloric acid (HCl), nitric acid (HNO₃) and sulfuric acid (H₂ SO₄). Perchloric acid (HClO₄), phosphoric acid (H₃ PO₄) and hydrogen peroxide (H₂O₂) are also used. These acids are used in the entire concentration range at temperatures from 20° C. to 100° C. Typically, 500 g of a polymer-based spherical adsorbent is stirred with 1000 g of mineral acid for 30 min to 240 min. Subsequently, excess mineral acid is decanted and the oxidized base adsorbent is washed with distilled water and dried.

### c) Properties of the Oxidized Catalyst Supports

The structural properties do not change, or at most only to a very small extent, as a result of the surface modification. The properties of the oxidized catalyst supports used or analyzed according to the invention can be taken from Table 3. The mechanical stability of the oxidized catalyst supports is maintained with very high abrasion hardnesses. The determination of the volatile components can be used to characterize the surface oxides. In this case, the materials are left at 900° C. for 7 min in accordance with ISO 562-1981 and the weight loss is then determined gravimetrically.
However, this method still says nothing about the nature of the oxygen species on the surface of the PBSAC. To determine these, photoelectron spectra of the respective catalyst supports are recorded. From these spectra, the elemental compositions can be determined. These can be taken from Table 4. It can be seen that the values from the determination of the volatile components correlate with the atomic composition determined by photoelectron spectroscopy. The lowest oxygen content of 4.0 atomic % is found in the sample oxidized with hydrochloric acid (90 min). Oxidation of the catalyst support with 50 vol % nitric acid leads to the highest oxygen content on the surface, 11.8 atom %.

TABLE 3
Properties of the oxidized catalyst supports or activated carbons

| | Acid | | | volatile | QS | QS | HS | | | Vibration |
|---|---|---|---|---|---|---|---|---|---|---|
| | Quantity/ | Salary/ | | Components/ | Vₜₒₜ/ | Meso/ | Vol. ads./ | Break | Abrasion/ | density/ |
| Description | mL | Vol. % | T/° C. | % | cm³ g⁻¹ | Macro/% | cm³ g⁻¹ | % | % | gL⁻¹ |
| Oxidation | 688 | 37 | 70 | 2.8 | 0.79 | 14.6 | 784 | 1.1 | 100.0 | 545 |
| with 37% | | | | | | | | | | |
| salt acid [70° C.] | | | | | | | | | | |
| Oxidation | 688 | 37 | 70 | 3.1 | 0.78 | 14.9 | 794 | 1.5 | 99.8 | 546 |
| with 37% | | | | | | | | | | |
| hydrochloric | | | | | | | | | | |
| acid [70° C.]. | | | | | | | | | | |
| Oxidation | 600 | 25 | 70 | 11.4 | 0.73 | 14.5 | 723 | 0.3 | 100.0 | 583 |
| with 25% | | | | | | | | | | |
| nitric acid | | | | | | | | | | |
| [70° C.] | | | | | | | | | | |
| Oxidation | 600 | 50 | 70 | 13.3 | 0.72 | 14.9 | 736 | 1.3 | 99.9 | 583 |
| with 50% | | | | | | | | | | |
| nitric acid | | | | | | | | | | |
| [70° C.] | | | | | | | | | | |
| Air | | | 450 | 7.1 | 0.87 | 15.8 | 839 | 4.1 | 100.0 | 533 |
| oxidation | | | | | | | | | | |
| 450° C./ | | | | | | | | | | |
| 240 min | | | | | | | | | | |
| Air | | | 500 | 7.0 | 0.85 | 17.5 | 865 | 0.6 | 100.0 | 535 |
| oxidation | | | | | | | | | | |
| 500° C./ | | | | | | | | | | |
| 240 min | | | | | | | | | | |

TABLE 4
Element compositions from overview spectra
(data in atomic %)

| Sample | C | O | N | S | Cl |
|---|---|---|---|---|---|
| Oxidation | 94.9 | 4.2 | 0.0 | 0.7 | 0.2 |
| with 37 vol % hydrochloric acid, 180 min | | | | | |
| Oxidation with | 87.9 | 10.4 | 1.2 | 0.5 | 0.0 |
| 25 vol % nitric acid | | | | | |
| Oxidation with | 86.7 | 11.8 | 1.1 | 0.5 | 0.0 |
| 50 vol % nitric acid | | | | | |
| Oxidation | 95.1 | 4.0 | 0.0 | 0.7 | 0.2 |
| with 37 vol % hydrochloric acid, 90 min | | | | | |
| Air oxidation | 92.0 | 7.9 | 0.0 | 0.2 | 0.0 |
| 450° C. | | | | | |
| Air oxidation | 91.5 | 8.4 | 0.0 | 0.1 | 0.0 |
| 500° C. | | | | | |

In order to characterize the oxygen species, the binding fractions are also determined from the high-resolution oxygen spectra. These can be taken from Table 5. It can be seen that over half of the oxygen species are in the form of alcohol oxygen on the surface. About 35% to 40% of the oxygen atoms are bound on the surface in the form of carbonyl oxygen. The differently oxidized catalyst supports differ only slightly from one another in terms of the proportions of oxygen species.

TABLE 5
Binding fractions from high-resolution oxygen spectra

| Sample | O1 | O2 | O3 | O total |
|---|---|---|---|---|
| Oxidation | 38 | 53 | 10 | 4.2 |
| with 37 vol % hydrochloric acid, 180 min | | | | |
| Oxidation | 40 | 52 | 8 | 10.4 |
| with 25 % nitric acid by volume | | | | |
| Oxidation | 40 | 52 | 8 | 11.8 |
| with 25 % nitric acid by volume | | | | |
| Oxidation | 39 | 52 | 10 | 4.0 |
| with 37 vol % hydrochloric acid, 90 min | | | | |
| Air oxidation | 35 | 51 | 13 | 7.9 |
| 450° C. | | | | |
| Air oxidation | 38 | 51 | 11 | 8.4 |
| 500° C. | | | | |

O1: carbonyl oxygen (RC═O / R—CO═O*); O2: alcohol oxygen (R—OH/R—O—R/R—CO—O*); O3: pi-pi*

### 6. Impregnation of the Catalyst Supports

The oxidized catalyst supports or activated carbons are provided with a catalytically active component or a relevant precursor to obtain corresponding impregnated catalyst systems, as follows.

### a) Palladium Loading of the PBSAC

Water and an acid solution (HCl, HNO₃) are placed in a round bottom flask. This is followed by the addition of a palladium precursor (typically H₂ PdCl₄, Pd(NO)₃₂). The turbid suspension is vigorously stirred with a magnetic stirring fish for at least 30 min until a clear, brownish solution is obtained. With vigorous stirring, the oxidized catalyst support is added rapidly as previously indicated. The system is stirred at a low speed (50 rpm) for 24 h. The solution is then removed. The solid is then separated using a Büchner funnel and suction flask. The catalyst is then rinsed extensively with ultrapure water. For drying, the material is transferred to a drying oven and dried at 80° C. for 12 h. The material is then dried in the oven.

### b) Platinum Loading of Spherical Adsorbents

Water and an acid solution (HCl, HNO₃) are placed in a round bottom flask. This is followed by the addition of a platinum precursor (typically H₂ [PtCl₆], (NH₃)₄Pt(OH)₂, Pt(NO₃)₂). The turbid suspension is vigorously stirred with a magnetic stirring fish for at least 30 min until a clear, brownish solution is obtained. With vigorous stirring, the oxidized catalyst support is added rapidly. The system is allowed to stir at a low speed (50 rpm) for 24 h. The solution is then removed. The solid is then separated using a Büchner funnel and suction flask. The catalyst is then rinsed extensively with ultrapure water. For drying, the material is transferred to a drying oven and dried at 80° C. for 12 h. The material is then dried in the oven.

### 7. Reduction of the Catalysts or to Obtain the Catalyst Systems

The above impregnated catalyst systems are treated by reduction to obtain corresponding catalyst systems as follows.

### a) Gas Phase Reduction

Gas phase reduction of the catalyst material is carried out in a horizontal, heatable flow tube containing 5% hydrogen by volume in nitrogen at a temperature of 50° C. to 300° C. for 1 h to 10 h. The catalyst material is then heated to a temperature of 1° C.

### b) Liquid Phase Reduction

Liquid phase reduction is preceded by fixation of the active component with potassium hydroxide (KOH). The base is added stoichiometrically to the impregnating solution at room temperature. Subsequently, potassium formate (KHCOO) is added in a 10-fold stoichiometric excess and the solution is left at 50° C. to 120° C. for 1 h to 5 h. The solution is then fixed with potassium hydroxide (KOH).

### 8. Properties of the Palladium Catalysts

Depending on the selected reduction method and the reaction parameters, the expression of the metallic active centers can be controlled in terms of size and distribution. The degree of dispersion can be set in the range from 15% to 35%. The cluster sizes of the metal centers vary in a range from 33 Å to 76 Å. In this regard, reference can also be made to FIG. 3, which shows the values determined for the metal dispersion (MD) and metal crystallite size (KG) of 5 wt. % palladium catalysts (based on catalyst supports B1 and B4, respectively). FIG. 3 also shows that at the reduction temperature T_{red2} (here 140° C.) optimized according to the invention, further improved properties result with respect to the metal dispersion and the average crystallite size compared with the reduction temperature T_{red1} (here 80° C.) designated as the so-called standard temperature according to the invention (and thus expressly belonging to the invention) in FIG. 3, which accordingly also leads to further improved catalytic performance of the catalyst systems according to the invention. The same applies to platinum and ruthenium catalysts.

### 9. General Remarks on Hydrogenation in the Fixed-Bed Reactor

The catalyst systems according to the invention can be used in particular on a large scale, for example for the catalysis of hydrogenation reactions. Hydrogenations are among the standard reactions in technical chemistry and are used both in large-scale methods, such as petrochemicals, e.g. for desulfurization of petroleum fractions, and as synthesis steps for fine chemicals. Besides unsaturated compounds, other groups of substances are also hydrogenated, such as aldehydes and ketones to alcohols and nitro compounds and nitriles to amines. In most hydrogenations, the reactant is in the liquid phase; only low-boiling substances such as the butyraldehydes from hydroformylation are hydrogenated in the gas phase.
Nickel and certain precious metals such as platinum, ruthenium and palladium serve as hydrogenation catalysts, for example, mostly in the form of supported catalysts. They are either suspended as fine-grained material in the reaction liquid or used as a fixed bed. In the latter case, trickle bed reactors are used for the three-phase reaction (reaction liquid, gaseous hydrogen, solid catalyst), i.e. fixed bed reactors whose catalyst packing is sprinkled with the reaction liquid. The size of the catalyst packing (spheres, cylinders, extrudates, etc.) can be, for example, between 1 and 7 mm.
A corresponding hydrogenation apparatus is shown in FIG. 6, which can also be used as an example to describe method control: The reactant A is fed to the tubular reactor (a) from above and flows through the reactor with the catalyst bed in co-current or countercurrent with the hydrogen H₂. In terms of volume, the gaseous phase represents the main phase compared with the liquid phase and flows around the catalyst bed wetted with the liquid phase. However, only reactors operating in co-current find wide technical application. The flow is driven by gravity or external pressure. For temperature control, the reactor is equipped with a double jacket. At its lower end, the hydrogenated product B is removed and finally degassed in the separator (b). Residual gas RG can be discharged via the device (c).
In a trickle bed reactor, the conversion and selectivity depend not only on the reaction kinetics, pressure and temperature, but also on the hydrodynamics of the reactor. The hydrodynamics have a great influence on the liquid distribution within the reactor and directly affect the catalyst utilization rate. Uneven fluid distribution can result in incomplete wetting of the catalyst bed. This can have a negative effect on the catalyst utilization factor.
Furthermore, the wetting of the catalyst bed can be disturbed by non-optimized technical sizes, such as the ratio of height to diameter of the reactor and of reactor inner to catalyst particle diameter. In order to prevent these effects of non-wetted reactor inner and/or catalyst areas, the design of the liquid distributor as well as the maintenance of the corresponding size ratios is of corresponding importance.
Therefore, the design of trickle bed reactors is based on parameters such as liquid holdup (a measure of the liquid present in the entire catalyst bed), the pressure drop across the bed, the distribution of the gas and liquid phases, or the mass and heat transfer coefficients. The industrial reactors used are between 5 and 30 m high; in these, the catalyst bed is present either in several beds or in a single bed. The diameter of the reactor is limited by the uniform distribution of the liquid over the cross-section of the reactor and usually does not exceed a value of 4 to 5 m. The diameter of the reactor is limited by the uniform distribution of the liquid over the cross-section of the reactor. Thus, the ratio of the height to the diameter of the reactor (Hr/Di) is generally between 5 and 25. Trickle-bed reactors used at laboratory scale have a diameter of 0.03 to 0.2 m and can reach a length of several meters. At these scales, the ratio of reactor inner diameter to catalyst diameter (Di/dk) cannot be neglected and should be above a value of Di/dk=10 (usually Di/dk>15). If this is not the case, the difference in the structure of the packing near the reactor wall compared to the core of the packing may result in marginal fluid flow, which is then reflected in lower conversions. In industrially used reactors, the ratio of the reactor inner diameter to the catalyst diameter is usually between 100 and 1000, in order to be able to reliably exclude the effects of the liquid moving at the edges here.
Conventional trickle bed reactors with a diameter of 0.2 m or more are generally less suitable for the production of fine chemicals because of the minimum throughput required. With the development of miniplant technology, however, it has become possible to operate continuous methods even at very low throughputs (1 kg/h and below). Miniplants have so far been used mainly in method development. However, they are also suitable for production and, in particular, for the manufacture of small product volumes of constant quality, such as fine chemicals and pharmaceutical and crop protection active ingredients.
For further explanations, reference can be made in particular to the following literature: Technical Chemistry, Manfred Baerns, et al, 2nd edition, Wiley-VCH Verlag & Co. KGaA, 2013; chapter “Three-Phase Trickle-Bed Reactors”, Ullmann's Encyclopedia of Industrial Chemistry, Vol. 7 Online Ed., 2008; and chapter “Reactor Types and Their Industrial Application”, Ullmann's Encyclopedia of Industrial Chemistry, Vol. 7 Online Ed., 2008.

### 10. Catalytic Testing (Hydrogenation of Cinnamic Acid)

The catalytic performance of the catalyst systems according to the invention, also in comparison with systems not according to the invention, can be investigated by means of hydrogenations or catalytically controlled hydrogenation reactions, such as the hydrogenation of cinnamic acid as reactant to hydrocinnamic acid as product. For this purpose, reference can also be made to FIG. 7A.
A 100 ml three-neck flask equipped with a stir bar, an N₂ inlet and an H₂ inlet is charged with cinnamic acid (1) (2 g, 13.5 mmol) and 144 mg catalyst. The three-neck flask is sealed with a rubber septum, evacuated, and refilled with nitrogen (three times). Ethyl acetate (14 ml) is added, and the mixture is stirred (700 rpm) until the reactant is completely dissolved. The flask is evacuated and refilled with hydrogen (three times). Samples are taken periodically at 1 h, 2 h, 3 h, 5 h, 7 h, 10 h, and 16 h and analyzed by gas chromatography coupled to a mass spectrometer. Catalyst systems based on catalyst supports A1, A2 and A3 (not according to the invention) and catalyst systems based on catalyst supports B1, B2 and B3 (according to the invention) are investigated.
The results are shown in FIGS. 7B and 7C. The figures show the catalytic conversion (hydrogenation) of cinnamic acid as reactant and starting material, respectively, with the amount of cinnamic acid over time (determined by GC-MS; % area), where 100% of the unreacted cinnamic acid is present as starting material at time t=0.
FIG. 7B shows the results for the catalyst systems according to the invention based on catalyst supports B1, B2 and B3 (where for t=4 h the upper line shows catalyst system B3, the middle line shows catalyst system B1 and the lower line shows catalyst system B2). FIG. 7C shows the results for the catalyst systems not according to the invention based on catalyst supports A1, A2 and A3 (where for t=7 h the upper line shows catalyst system A3, and the lower lines show catalyst systems A1 and A2, respectively).
A comparison of the line curves shown in FIGS. 7B and 7C shows the significantly higher catalytic performance of the catalyst systems according to the invention based on catalyst supports B1, B2 and B3 compared with the systems not according to the invention based on catalyst supports A1, A2 and A3. Thus, the conversion or hydrogenation of the starting material in the form of the cinnamic acid is completed significantly faster for the systems according to the invention than for the systems not according to the invention, so that higher conversion rates are available for the systems according to the invention.
The catalyst systems based on catalyst supports B1, B2 and B3 according to the invention thus exhibit a higher overall catalytic performance, in particular accompanied by higher conversions and an improved space/time yield. The same applies to corresponding platinum and ruthenium catalyst systems.

As mentioned above, the special pore system with the high meso- and macroporosity of the activated carbon used as catalyst support is of great importance in this context, especially with regard to improving the transport methods for reactants and products.

In addition, in the catalyst systems according to the invention, the equipment with the catalytically active component is improved overall, and this is also due to the special method management for the production of the catalyst systems according to the invention with the target and purpose-oriented oxidation of the activated carbon before loading with the catalytically active component or the relevant precursor, followed by a reduction to obtain the catalyst system. In particular, the special pore structure of the activated carbon, as described in particular also in the form of the special ratio (quotient Q) of total pore volume to specific BET surface area, leads to the improved properties with respect to the catalytic activity of the catalyst systems according to the invention.

In this context, in particular, the totality of the measures according to the invention in their special combination, as previously indicated, in their target- and purpose-oriented combination, leads to the advantages and properties of the catalyst systems according to the invention.

As a result, the underlying investigations thus show overall that the catalyst systems according to the invention obtained by the method of the invention have significantly improved properties compared to systems of the prior art.

1. A catalyst system in the form of a supported catalyst,
wherein the catalyst system comprises at least one catalytically active component fixed to a catalyst support, wherein the catalytically active component comprises at least one metal, wherein said metal is selected from the group consisting of Cu, Ag, Au, Zn, Hg, Sn, Ce, Ti, Zr, V, Nb, Cr, Mo, W, Mn, Fe, Bi, Ru, Os, Co, Rh, Re, Ir, Ni, Pd and Pt, and
wherein the catalyst support is in the form of spherical activated carbon,
wherein the activated carbon forming the catalyst support
(i) has a total pore volume Vₜₒₜₐₗ according to Gurvich in the range from 0.8 cm³/g to 3.9 cm³/g, wherein from 50% to 90% of the total pore volume according to Gurvich of the initial activated carbon is formed by pores having pore diameters in the range of from 2 nm to 500 nm, and
(ii) has a specific BET surface area S_{BET} in the range of from 1,000 m²/g to 3,000 m²/g, however, with the proviso that the ratio Q of the total pore volume Vₜₒₜₐₗ according to Gurvich to the specific BET surface area S_{BET} according to the equation
Q=Vₜₒₜₐₗ/S_{BET} is in the range of from 0.5×10⁻⁹ m to 1.9×10⁻⁹ m;
and
wherein the catalyst system obtained has an activity, determined as the percentage dispersion degree of the catalytically active component on the catalyst support and measured by chemisorption using a dynamic flow method according to DIN 66136-3:2007-01, in the range of from 15% to 90%; and
wherein the catalyst system comprises the at least one catalytically active component with an average crystallite size, determined according to DIN 66136, in the range of from 5 Ångstrøm to 80 Ångstrøm.

2. A method of catalyzing a chemical reaction via heterogeneous catalysis, wherein the method comprises using the catalyst system according to claim 1.

3. The method according to claim 2,
wherein the chemical reaction is selected among hydrogenation reactions, oligomerization reactions and polymerization reactions.

4. A protective piece of clothing comprising a catalyst system according to claim 1.

5. The protective piece of clothing according to claim 4,
wherein the protective piece of clothing is selected from the group consisting of protective apparel for the civilian sector, protective apparel for the military sector, protective suits, protective gloves, protective footwear, protective socks, protective headwear and protective covers.

6. A filter for removing pollutants, odors and toxic substances, wherein the filter comprises a catalyst system according to claim 1.

7. The filter according to claim 6,
wherein the filter is selected from the group consisting of NBC protective mask filters, odor filters, surface filters, air-filters, filters for room air purification, adsorption-capable support structures, chemisorption-capable support structures and filters for the medical field.

8. A catalyst system in the form of a supported catalyst, wherein the catalyst system is obtained according to a method for the production of a catalyst system comprising at least one catalytically active component in the form of a supported catalyst,
wherein at least one catalytically active component is fixed to a catalyst support, said catalytically active component comprising at least one metal, said metal being selected from the group consisting of Cu, Ag, Au, Zn, Hg, Sn, Ce, Ti, Zr, V, Nb, Cr, Mo, W, Mn, Fe, Bi, Ru, Os, Co, Rh, Re, Ir, Ni, Pd and Pt, wherein the method comprises the following steps in the sequence (a) to (d) specified below:
(a) providing an initial spherical activated carbon used as catalyst support,
wherein the initial activated carbon
(i) has a total pore volume Vₜₒₜₐₗ according to Gurvich in the range from 0.8 cm³/g to 3.9 cm³/g, wherein from 50% to 90% of the total pore volume according to Gurvich of the initial activated carbon is formed by pores having pore diameters in the range of from 2 nm to 500 nm, and
(ii) has a specific BET surface area S_{BET} in the range of from 1,000 m²/g to 3,000 m²/g, however, with the proviso that the ratio Q of the total pore volume Vₜₒₜₐₗ according to Gurvich to the specific BET surface area S_{BET} according to the equation
Q=Vₜₒₜₐₗ/S_{BET} is in the range of from 0.5×10⁻⁹ m to 1.9×10⁻⁹ m;
then
(b) oxidation of the initial activated carbon provided in method step (a), however, with the at least one of the two following provisos (i) and (ii):
(i) a first proviso according to which first proviso the oxidized activated carbon has an oxygen content, as determined by X-ray photoelectron spectroscopy, in the range of from 4 atomic % to 20 atomic % based on the total element composition of the oxidized activated carbon, and
(ii) a second proviso according to which second proviso the oxidized activated carbon has a hydrophilicity, determined as water-vapor adsorption behavior, such that from 30% to 100% of the maximum water-vapor saturation loading of the oxidized activated carbon is reached at a partial pressure p/p₀ of 0.6;
then
(c) providing the oxidized activated carbon obtained in method step (b) with the at least one catalytically active component;
then
(d) reducing the oxidized activated carbon provided with the at least one catalytically active component, obtained in method step (c), wherein method step (d) of reducing is carried out as a gas phase reduction at a temperature in the range of from 115° C. to 160° C., so that a catalyst system comprising at least one catalytically active component is obtained;
wherein the catalyst system obtained has an activity, determined as the percentage dispersion degree of the catalytically active component on the catalyst support and measured by chemisorption using a dynamic flow method according to DIN 66136-3:2007-01, in the range of from 15% to 90%; and
wherein the catalyst system comprises the at least one catalytically active component with an average crystallite size, determined according to DIN 66136, in the range of from 5 Ångstrøm to 80 Ångstrøm.
